(19) United States
(12) Patent Application Publication
(10) Pub. No.: US 2019/0006695 A1
(43) Pub. Date: Jan. 3, 2019

(54) METHOD AND SYSTEM FOR EFFICIENTLY OPERATING ELECTROCHEMICAL CELLS

(71) Applicant: AquaHydrex Pty Ltd, North Wollongong (AU)

(72) Inventors: Gerhard Frederick SWIEGERS, North Wollongong (AU); Eric Austin SEYMOUR, Fort Collins, CO (US); Prerna TIWARI, Wollongong (AU); George TSEKOURAS, Wollongong (AU)

(21) Appl. No.: 16/062,019

(22) PCT Filed: Dec. 14, 2016
(86) PCT No.: PCT/AU2016/051231

§ 371 Date: Jun. 13, 2018

(30) Foreign Application Priority Data
Dec. 14, 2015 (AU) 2015905154
Dec. 14, 2015 (AU) 2015905155
Dec. 14, 2015 (AU) 2015905156
Dec. 14, 2015 (AU) 2015905158
Dec. 14, 2015 (AU) 2015905160

(51) Int. Cl. H01M 8/18; C25B 1/04; C25B 11/04; C25B 15/02; H01M 2/20; H01M 4/94; H01M 4/90

(52) U.S. Cl. CPC H01M 8/186; C25B 1/04; C25B 11/0478; H01M 4/9016; H01M 2/202; H01M 4/94; C25B 15/02

(57) ABSTRACT

Disclosed are electrochemical cells and methods of use or operation. In one aspect there is disclosed a method for management of an electrochemical cell, the method comprising operating the electrochemical cell at an operational voltage that is below or about the thermoneutral voltage for an electrochemical reaction. In another aspect there is disclosed an electrochemical cell comprising electrodes, an electrolyte between the electrodes, and a catalyst applied to at least one of the electrodes to facilitate an electrochemical reaction at an operational voltage of the electrochemical cell that is below or about the thermoneutral voltage for the electrochemical reaction. Also disclosed are various catalysts for the electrochemical cell comprising mixtures of various catalytic materials and polytetrafluoroethylene (PTFE).

### TECHNICAL FIELD

The present invention relates to the efficient or improved operation of electrochemical cells that involve a gas-liquid interface, particularly, but not exclusively, to the efficient or improved operation of gas-liquid electrochemical cells that facilitate an overall reaction at one or more gas-liquid interfaces.

### BACKGROUND

Numerous electrochemical cells facilitate liquid-to-gas or gas-to-liquid transformations. Because of the involvement of a gas-liquid interface, such transformations are typically energy inefficient. That is, they are typically intrinsically wasteful of energy. The energy inefficiency most often derives from the fundamental processes that occur at the catalysts, conductors and electrolyte.

For example, many electrochemical liquid-to-gas transformations involve the formation of, or presence of gas bubbles in liquid electrolyte solutions. Thus, electrochemical cells used in the chlor-alkali process typically generate chlorine gas and hydrogen gas in the form of bubbles at the anode and cathode, respectively. Bubbles in an electrochemical cell generally have the effect of increasing the electrical energy required to undertake the chemical transformation in the cell. This arises from effects that include the following:
(1) Bubble formation: In order to create a bubble, supersaturated gas in the liquid electrolyte immediately adjacent to an electrode surface must combine to form a small bubble. The bubble is initially created by and held up by a large internal pressure (known as the ‘Laplace’ pressure). Such bubbles are typically very small and, since the Laplace pressure is inversely proportional to the internal pressure needed, they must necessarily contain high internal pressures of gas. For example, according to a thesis by Yannick De Strycker entitled “A bubble curtain model applied in chlorate electrolysis” (published by the Chalmers University of Technology, Goteborg, Sweden, in 2012), the hydrogen bubbles formed at the cathode in electrochemical chlorate manufacture at atmospheric pressure are estimated to initially be ca. 3.2 nm in diameter, so that their internal (‘Laplace’) pressures must be ca. 824 bar. The additional energy required to produce such bubbles is known in the art as the bubble overpotential. The bubble overpotential can be substantial. In the above-mentioned case, bubble formation by hydrogen at the cathode alone, was estimated to add ca. 0.1 V to the cell voltage. Once formed, the very small initial bubbles spontaneously expand as a result of their large internal pressure. In the above-mentioned case of hydrogen generation in chlorate manufacture at atmospheric pressure, the initial bubbles were found to expand to a diameter of ca. 0.1 mm, at which stage the pressure inside the bubble was equal to the pressure outside the bubble.
(2) “Bubble coverage”/“Bubble curtain”: Studies have shown that bubbles are typically formed in crevasses, clefts, or other micrometer- or nanometer-sized irregularities on electrode surfaces. This effect is driven by the fact that, according to the Laplace equation, the smaller the radius of a bubble, the higher the pressure inside the bubble must be to push the bubble up and to hold the bubble up. There is therefore a fundamental thermodynamic (energy) advantage to forming bubbles having small volumes but large radii. This can only occur within tiny crevasses, clefts or similar irregularities that may be present on many electrode surfaces. Bubbles formed within such features are not spherical but instead fill a portion—usually the deepest portion—of the feature. Such bubbles have very small volumes. However, the bubbles formed in such features have large radii that extend along the length of the cleft or irregularity. The larger radii mean that the internal pressure of such bubbles may be very much lower than a spherical bubble of the same volume. Such ‘cleft’-based bubbles will therefore form at a lower level of electrolyte supersaturation with the gas in question, than will spherical bubbles. That is, the bubbles formed in such features, i.e. ‘cleft’-based bubbles, are favoured to form before spherical bubbles are formed on the electrode surface.
   ‘Cleft’-based bubbles of this type typically start within the ‘cleft’ feature on an electrode surface and then expand out of the cleft into a largely spherical shape. The resulting bubble is then held on the surface of the electrode by its attachment to the ‘cleft’ in which the bubble initially formed. The effect of having many such attached bubbles at the electrode surface is to create a bubble “curtain” between the liquid electrolyte and the active surface of the electrode. This “bubble curtain” (or “bubble coverage”) typically impedes movement of the electrolyte to the electrode surface, slowing or even halting the reaction. To overcome this effect, many electrochemical cells employ continuous mechanical pumping to sweep the electrolyte over the surface of the electrodes to dislodge surface bubbles. The resulting current drawn by the pump diminishes the overall electrical efficiency of the electrochemical cell.
(3) Bubbles in conduction pathway (“Voidage”): Even after bubbles are released from an electrode surface into the electrolyte they still impede electrical efficiency in a cell. In electrical terms, a bubble is a non-conducting void within the conduction pathway that comprises of the liquid electrolyte between the two electrodes. The greater the number of, and relative volume of such non-conducting voids present, the greater the overall electrical resistance of the cell. This effect, which is known in the art as “voidage”, becomes particularly pronounced as the current density increases, when larger volumes of bubbles are produced. In the above-mentioned example of chlorate manufacture, it has been estimated that, at high current densities, up to 60% of the space between the electrodes may be occupied by bubbles, increasing the cell voltage by ca. 0.6 V.

Other sources of intrinsic inefficiency within gas-liquid cells involve the ohmic resistance of the electrolyte between the electrodes. In order to close an electrical circuit, the electrolyte forms a conduction pathway, whose resistance needs to be minimised. There are several other sources of intrinsic inefficiency, not discussed here, which may be specific to the particular reaction involved.

A key issue in operating liquid-to-gas or gas-to-liquid electrochemical cells more efficiently is finding ways to diminish or minimise intrinsic inefficiencies such as those described above.

A potential mitigating factor exists in the case of liquid-to-gas or gas-to-liquid transformations that involve endothermic reactions. Endothermic reactions consume heat, meaning that, in addition to the electrical currents involved, such reactions must be supplied with heat. That heat may (and often does) come from electrical and energy inefficiencies like those described above. That is, the heat that is generated by intrinsic electrical and energy inefficiencies of the type noted above, may be used, in part, to supply the heat required by the reaction, so that it is not wasted.

In theory it is, in fact, possible to balance the excess heat generated by intrinsic inefficiencies within the cell with the heat required by the reaction. This situation exists at the so-called “thermoneutral” voltage (i.e. thermoneutral potential). The thermoneutral voltage is defined as that voltage in an electrochemical cell, where the heat arising from intrinsic inefficiencies at the catalysts, conductors, and electrolyte, is equal to the heat consumed by the reaction itself. If an endothermic reaction is carried out using an operational voltage for an electrochemical cell that is at the thermoneutral voltage, then the reactants are, in theory at least, converted into products with 100% energy efficiency, since all of the energy that is put into the system is necessarily converted into energy within the products of the reaction. That is, the electrical and heat energy input is matched with the electrical and heat energy required for the reaction (and captured in the products of the reaction) with no excess energy exchanged with the surroundings. By contrast, if the reaction is carried out at an operational voltage for the electrochemical cell that is below the thermoneutral voltage, then heat needs to be supplied to the cell in order to avoid self-cooling of the system that would otherwise see the cell becoming increasingly cold. If the reaction is carried out at an operational voltage for the electrochemical cell that is above the thermoneutral voltage, then excess heat is generated and the cell radiates nett heat to the surroundings—that is, it becomes hot.

The situation in practice, of course, is that beyond the heat deriving from “intrinsic” inefficiencies of the type described above, most electrochemical cells also generate additional heat arising from electrical resistance in the electrical components of the cell. Moreover, for most reactions, particularly those involving gas-liquid interfaces in a liquid electrolyte at near-to-ambient temperatures (e.g. below 100° C.), the available catalysts are typically not sufficiently efficient to allow for viable operation at the thermoneutral voltage.

Conventional electrochemical cells therefore operate at an operational voltage well above the thermoneutral voltage, where they generate large quantities of excess heat, which derives from both the ‘intrinsic’ inefficiencies at the catalyst, conductors, and electrolyte, as well as resistive heating in the electric circuitry.

The generation of large quantities of excess heat typically constitutes a significant and intractable practical problem from the point of view of maximising the energy efficiency of the electrochemical cell. Firstly, the excess heat typically has to be removed by a suitable cooling system in order to maintain a constant temperature in the cell and avoid a “thermal runaway”. Cooling systems, such as electrically-driven chillers, are, however, often themselves highly energy inefficient. They are also expensive. Thus, not only does such an electrochemical cell create and waste excess heat, but further energy must then be expended to remove that excess heat. The resulting multiplier effect dramatically diminishes the energy efficiency of the electrochemical cell during routine operation, causing low overall energy conversion efficiencies.

These constraints may be illustrated by the example of water electrolyzers. Water electrolysis (also called “water-splitting”) is an electrochemical process by which water is converted into its constituent gases, hydrogen and oxygen, by the application of a suitable electrical voltage (operational voltage) within an electrochemical cell. The thermoneutral voltage for the process at ambient temperature is 1.482 V. A cell operated at this voltage (without substantive resistive heating by its electrical components) will, in theory, exchange no heat with its surroundings, and consume 39 kWh of electrical energy to manufacture 1 kg of hydrogen.

In practice, water electrolyzers are less efficient than that. For example, known small-scale commercial water electrolyzers that generate 0.5-10 kg hydrogen/day during routine operation, typically operate at 1.8-2.2 V and consume 75-90 kWh per 1 kg of hydrogen produced. The overall energy efficiency of such electrolyzers is therefore in the range 43-52%. That is, a mere 43-53% of the electrical energy that is input into such cells is converted into energy contained with the hydrogen that is produced. The additional energy consumed above 39 kWh per 1 kg of hydrogen produced, is largely due to the excess waste heat that is generated and the need for an energy hungry chiller to remove the excess waste heat.

Given the critical importance of hydrogen to the proposed future hydrogen economy, improving the energy efficiency of water electrolyzers is considered a key technical challenge by the US Department of Energy, which has published formal targets in this respect in order to encourage improvements.

For the sake of clarity, it should be noted that water electrolyzers, and other types of electrochemical cells, exhibit other forms of intrinsic inefficiency that have not been discussed above. One example is the phenomenon of gas ‘crossover’, where hydrogen formed at the cathode passes through the electrolyte and any separator between the electrodes, to contaminate the oxygen formed at the anode; and oxygen formed at the anode passes through the electrolyte and any separator to contaminate the hydrogen formed at the cathode. If these contaminants approach the lower or higher explosion limits of hydrogen in oxygen, then a safety issue will have been created. Extensive crossover typically has the effect of diminishing the Faradaic efficiency of the anode and/or cathode. In such a case, electrons consumed at, for example, the cathode to make hydrogen, are wasted when the hydrogen migrates to the anode and is there converted back to water. Crossover may occur by two mechanisms in water electrolyzers: (i) a process whereby microbubbles of one or both of the gases lodge in the pores of the separator, thereby creating a gaseous pathway between the catholyte and anolyte chambers, and (ii) the migration of dissolved gases in the liquid electrolyte between the electrodes (through the separator).

In summary, important challenges exist in respect of improving the energy efficiency of electrochemical cells that facilitate liquid-to-gas or gas-to-liquid transformations. As a result of these and other issues, new or improved cells, devices and/or methods of facilitating electrochemical transformations involving gases and liquids, or gels, and that avoid, ameliorate or diminish energy and electrical penalties are of interest.

The reference in this specification to any prior publication (or information derived from it), or to any matter which is known, is not, and should not be taken as an acknowledgment or admission or any form of suggestion that the prior publication (or information derived from it) or known matter forms part of the common general knowledge in the field of endeavour to which this specification relates.

### SUMMARY

This Summary is provided to introduce a selection of concepts in a simplified form that are further described below in the Examples. This Summary is not intended to identify all of the key features or essential features of the claimed subject matter, nor is it intended to be used to limit the scope of the claimed subject matter.

In one aspect there is provided a method for management of an electrochemical cell, the method comprising operating the electrochemical cell at an operational voltage that is below or about the thermoneutral voltage for an electrochemical reaction. In another aspect there is provided an electrochemical cell comprising electrodes, an electrolyte between the electrodes, and a catalyst applied to at least one of the electrodes to facilitate an electrochemical reaction at an operational voltage of the electrochemical cell that is below or about the thermoneutral voltage for an electrochemical reaction. Preferably, the electrochemical reaction is an endothermic electrochemical reaction.

In another aspect there is provided a method for management of an electrochemical cell comprising electrodes and an electrolyte between the electrodes. The method comprising creating, setting, selecting or applying an operational voltage for the electrochemical cell that is below or about the thermoneutral voltage. The operational voltage for the electrochemical cell can be created, set, selected or applied for an operating temperature of the electrochemical cell. A catalyst is preferably applied to at least one of the electrodes to facilitate the electrochemical reaction at the operational voltage and at the operating temperature. In an example, the operational voltage can be created indirectly or applied indirectly, for example, by applying a particular current density that creates or consequently applies the operational voltage for the electrochemical cell, which can be dependent on the operating temperature.

When the operational voltage is below the thermoneutral voltage, then an endothermic electrochemical reaction arises. However, if the operational voltage is above, or even slightly above, the thermoneutral voltage, then a weakly exothermic electrochemical reaction arises.

In another aspect there is provided a method for management of an electrochemical cell comprising electrodes and an electrolyte between the electrodes, the method comprising utilizing, selecting or applying an operational current density and an operating temperature (or operational temperature) such that the operational cell voltage is below or about the thermoneutral voltage for an electrochemical reaction. A catalyst is applied to at least one of the electrodes to facilitate the electrochemical reaction at the operational voltage and the cell is able to withstand the operating temperature without damage or impairment. Optionally the cell may be wrapped or partially wrapped in thermal insulation materials.

In another aspect there is provided a method for management of an electrochemical cell comprising electrodes and an electrolyte between the electrodes, the method comprising applying an operational current density and allowing the operating temperature of the cell to change to a new operating temperature at which the operational cell voltage is below or about the thermoneutral voltage for an electrochemical reaction. A catalyst is applied to at least one of the electrodes to facilitate the electrochemical reaction at the operational voltage and the cell is able to withstand the operating temperature without damage or impairment. Optionally the cell may be wrapped or partially wrapped in thermal insulation materials. In this aspect the method of management is known as “thermal self-regulation”.

In another non-limiting example aspect there is provided a catalyst for an electrochemical cell comprising electrodes and an electrolyte between the electrodes, the catalyst comprising a mixture of:

one or more catalytic materials selected from the group of:
Precious metals, Pt black, Pt supported on carbon materials, Pt on carbon black, Pt/Pd on carbon materials, Pt/Pd on carbon black, IrO₂, RuO₂, Nickel, nanoparticulate nickels, sponge nickels, Raney nickel, nickel foams, Nickel alloys, NiMo, NiFe, NiAl, NiCo, NiCoMo, Nickel oxides, oxyhydroxides, hydroxides, Spinels, NiCo₂O₄, Co₃O₄, LiCo₂O₄, Perovskites, La_{0.8}Sr_{0.2}MnO₃, La_{0.6}Sr_{0.4}Co_{0.2}Fe_{0.8}O₃, Ba_{0.5}Sr_{0.5}Co_{0.2}Fe_{0.8}O₃, Iron, iron compounds, nanoparticulate iron powders, Molybdenum compounds, MoS₂, Cobalt, cobalt compounds, nanoparticulate cobalt powders, Manganese, manganese compounds, and nanoparticulate manganese powders; and, polytetrafluoroethylene (PTFE).

Preferably, the catalyst is able to be applied to at least one of the electrodes to facilitate an electrochemical reaction at an operational voltage of the electrochemical cell that is below or about the thermoneutral voltage, preferably though not necessarily for an endothermic electrochemical reaction.

In another aspect there is provided a method for management of an electrochemical cell comprising electrodes and an electrolyte between the electrodes, the method comprising: operating the electrochemical cell at an operational voltage that is below or about the thermoneutral voltage; wherein, a catalyst applied to at least one of the electrodes facilitates the electrochemical reaction at the operational voltage.

In another aspect there is provided an electrochemical cell comprising: electrodes; an electrolyte between the electrodes; and a catalyst applied to at least one of the electrodes to facilitate an electrochemical reaction at an operational voltage of the electrochemical cell; wherein the operational voltage is below or about the thermoneutral voltage for the electrochemical reaction.

In one example, the operational voltage is below the thermoneutral voltage. In another example, the operational voltage is at or about the thermoneutral voltage. In another example, the electrochemical reaction is an endothermic electrochemical reaction and heat is applied to the endothermic electrochemical reaction from a heater or a heating element, which may include the electrochemical cell itself or the components therein acting as a heating element. In another example, the electrochemical reaction is an endothermic electrochemical reaction and heat is applied to the endothermic electrochemical reaction from electrical resistive heating, which may include electrical resistive heating from the electrochemical cell itself or the components therein. In another example, there is no active cooling of the electrochemical cell, for example by a cooling system. In another example, thermal insulation encases, partially or fully, the electrochemical cell.

In another example, the electrochemical cell is a water electrolyzer and the electrochemical reaction is water electrolysis. In another example, the catalyst facilitates electrocatalytic water electrolysis. In another example, the catalyst is applied to both of the electrodes. In another example, the catalyst facilitates water electrolysis at an operational voltage that is below, at or about the thermoneutral voltage for water electrolysis.

In another example, there is no ion exchange membrane positioned between the electrodes. In another example, there is no diaphragm (e.g. separator) positioned between the electrodes. In another example, the electrolyte is a liquid electrolyte or a gel electrolyte. In another example, at least one gas is produced from the electrochemical reaction.

In other examples, there are no bubbles of the at least one gas formed or produced, or there are substantially no bubbles of the at least one gas formed or produced, at one or both of the electrodes. In example embodiments, “substantially free of bubble formation” or “substantially bubble-free” or “substantially no bubbles” means that less than 15% of the gas produced takes the form of bubbles in the electrolyte. In another example embodiment, less than 10% of the gas produced takes the form of bubbles in the electrolyte. In other example embodiments, less than 8%, less than 5%, less than 3%, less than 2%, less than 1%, less than 0.5%, or less than 0.25%, of the gas produced takes the form of bubbles in the electrolyte.

Preferably, the catalyst contains one or more of the following catalytic materials, or combinations thereof: (i) Precious metals, either free or supported, including but not limited to Pt black, Pt supported on carbon materials (e.g. Pt on carbon black), Pt/Pd on carbon materials (e.g. Pt/Pd on carbon black), IrO₂, and RuO₂; (ii) Nickel, including but not limited to: (a) nanoparticulate nickels, (b) sponge nickels (e.g. Raney nickel), and (c) nickel foams; (iii) Nickel alloys, including but not limited to, NiMo, NiFe, NiAl, NiCo, NiCoMo; (iv) Nickel oxides, oxyhydroxides, hydroxides, and combinations thereof, without limitation; (v) Spinels, including but not limited to NiCo₂O₄, Co₃O₄, and LiCo₂O₄; (vi) Perovskites, including but not limited to La_{0.8}Sr_{0.2}MnO₃, La_{0.6}Sr_{0.4}Co_{0.2}Fe_{0.8}O₃, and Ba_{0.5}Sr_{0.5}Co_{0.2}Fe_{0.8}O₃; (vii) Iron, as well as iron compounds, including but not limited to nanoparticulate iron powders and the like; (viii) Molybdenum compounds, including but not limited to MoS₂; (ix) Cobalt, as well as cobalt compounds, including but not limited to nanoparticulate cobalt powders and the like; and (x) Manganese, as well as manganese compounds, including but not limited to nanoparticulate manganese powders and the like. Also preferably, the catalyst, when dry, comprises: about 5% to about 95% by weight of PTFE, and about 5% to about 95% by weight of catalytic materials. In another non-limiting example, the catalyst, when dry, comprises about 5% to about 90% by weight of PTFE, about 5% to about 90% by weight of uncoated carbon black, and about 5% to about 90% by weight of catalytic materials.

In another example, the catalyst produces heat at an applied current density. In another example, a current density is varied to maintain the electrochemical cell at or about a constant operating temperature. In another example, the current density is supplied in a waveform. In another example, the catalyst facilitates the electrochemical reaction at a low current density less than or equal to 50 mA/cm². In another example, the operating temperature of the electrochemical cell is greater than or equal to 20° C. In another example, the electrical efficiency of the electrochemical cell is more than 70%.

### BRIEF DESCRIPTION OF THE FIGURES

Illustrative embodiments will now be described solely by way of non-limiting examples and with reference to the accompanying figures. Various example embodiments will be apparent from the following description, given by way of example only, of at least one preferred but non-limiting embodiment, described in connection with the accompanying figures.

FIG. 1 schematically depicts an example liquid-gas electrochemical cell that can be utilised in present embodiments (not to scale).

FIG. 2 schematically depicts the options available to gas formed at or near to the liquid-gas interface in an electrochemical cell.

FIG. 3 illustrates an example method for management of an electrochemical cell.

FIG. 4 schematically depicts a first example arrangement for voids in a liquid-gas electrochemical cell.

FIG. 5 schematically depicts a second example arrangement for voids in a liquid-gas electrochemical cell.

FIG. 6 depicts the (theoretical) cell potential and energy requirement for water electrolysis as a function of temperature.

FIG. 7 schematically depicts an example electrolyzer, including two gas diffusion electrodes and whose standard operating current density is 10 mA/cm².

FIG. 8 depicts various voltage and current profiles measured for cells containing example catalysts at a current density of 10 mA/cm² at a temperature of 80° C.

FIG. 9 depicts various voltage profiles measured for a cell containing example catalysts at a current density of 10 mA/cm² under the following conditions: (a) at ambient temperature (25° C.) with no temperature control, (b) at a temperature of 80° C., with temperature control, without efficient thermal insulation, and (c) at temperature of 80° C., with temperature control, with efficient thermal insulation.

FIG. 10 depicts example cells of the present embodiments.

FIG. 11 depicts a busbar connection for an example series electrochemical cell.

FIG. 12 depicts example modelling data for the heat generated by the busbar in FIG. 11.

FIG. 13 depicts example modelling data for the heat generated at a current density of 10 mA/cm² by all of the various electrical elements in FIG. 11 (neglecting the heat generated by the catalyst and by non-functional electrical components).

FIG. 14 depicts example modelling data for the heat generated at a current density of 10.85 mA/cm² by all of the various electrical elements in FIG. 11 (neglecting the heat generated by the catalyst and by non-functional electrical components).

### DETAILED DESCRIPTION AND EXAMPLES

The following modes, features or aspects, given by way of example only, are described in order to provide a more precise understanding of the subject matter of a preferred embodiment or embodiments.

### Example Electrochemical Cells and Methods of Operation

International Patent Publication No. WO2013/185170 for “Gas Permeable Electrodes and Electrochemical Cells” filed 11 Jun. 2013, is incorporated herein by reference, and describes gas diffusion electrodes, including various alkaline and acidic electrolyzers and including gas-producing electrodes, and aspects thereof, which can be spiral-wound or kept in “flat-sheet” format, and utilised in the present examples.

Further aspects and details of example cells, modules, structures and electrodes, including gas-producing electrodes, and methods of operation, that are incorporated herein by reference, and that can be utilised in the present examples are described in the Applicant's previously filed International Patent Publication No. WO2015/013766 for “Modular Electrochemical Cells” filed 30 Jul. 2014; the Applicant's previously filed International Patent Publication No. WO2015/013765 for “Composite Three-Dimensional Electrodes and Methods of Fabrication” filed 30 Jul. 2014; the Applicant's previously filed International Patent Publication No. WO2015/013767 for “Electro-Synthetic or Electro-Energy Cell With Gas Diffusion Electrode(s)” filed on 30 Jul. 2014; the Applicant's previously filed International Patent Publication No. WO2015/013764 for “Method and Electrochemical Cell for Managing Electrochemical Reactions” filed on 30 Jul. 2014; the Applicant's previously filed International Patent Publication No. WO2015/085369 for “Electrochemical Cells and Components Thereof” filed on 10 Dec. 2014; and in the Applicant's concurrent International Patent Applications entitled “Electrochemical cell and components thereof capable of operating at high current density” and “Electrochemical cell and components thereof capable of operating at high voltage”, filed on 14 Dec. 2016, which are all incorporated herein by reference.

The electrodes, electrochemical cells and/or methods of operation described in the above patent applications can be used in present embodiments.

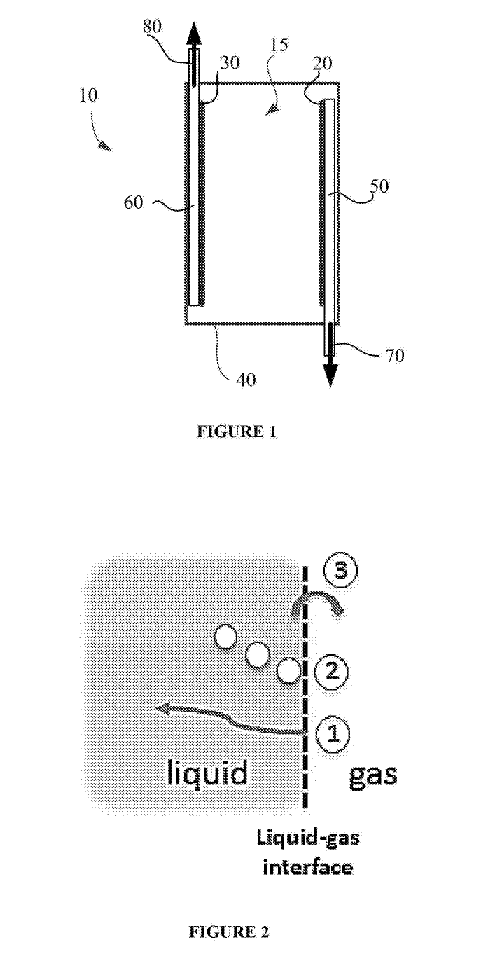

Referring to FIG. 1 there is illustrated a non-limiting example of an electrochemical cell 10. The electrochemical cell 10 includes an electrolyte 15, preferably a liquid electrolyte or a gel electrolyte that can be subjected to an electrolyte pressure, existing between and/or about anode 20 and cathode 30, i.e. electrodes 20, 30. The anode 20 can be a gas-producing electrode and/or the cathode 30 can be a gas-producing electrode. Either of the anode 20 or the cathode 30 can be termed a counter electrode respective to the other electrode. For example, there can be provided an electrode 20 and a counter electrode 30, or an electrode 30 and a counter electrode 20. Optionally, on, embedded in, or close to the surface of the electrodes 20, 30 is a conductive layer or region containing a suitable catalyst(s). Preferably, the electrode and catalyst layers at the anode 20 and cathode 30 are permeable to gases. The electrochemical cell 10 includes a housing or container 40 for containing electrolyte 15. First gas region, channel or conduit 50 is formed as part of, adjacent or next to anode 20, for collecting and/or transporting a first gas 70, if any, produced at anode 20. Second gas region, channel or conduit 60 is formed as part of, adjacent or next to cathode 30, for collecting and/or transporting a second gas 80, if any, produced at cathode 30. First gas region, channel or conduit 50 and second gas region, channel or conduit 60 can be provided separately or together in electrochemical cell 10. Depending on the particular reaction, first gas 70 and/or second gas 80 can be produced, and optionally transported out of electrochemical cell 10. The direction of gas exit is for illustration only and can be varied.

First gas region, channel or conduit 50 provides one example form of one or more void volumes, positioned at or adjacent to electrode 20. Second gas region, channel or conduit 60 also provides one example form of a separate one or more void volumes, positioned at or adjacent to electrode 30.

An electrical current, having an associated current density, is applied to the electrodes 20, 30 or a voltage (the operational voltage) can be applied across electrodes 20, 30 using an electrical power source. No bubbles, or substantially no bubbles, of first gas 70 and/or second gas 80 are formed at either the anode 20 or cathode 30 surfaces. That is, the electrochemical cell is substantially free of bubble formation, i.e. substantially bubble-free, at the anode and/or the cathode. This means that less than 15% of the gas formed or produced at the anode and/or the cathode takes the form of bubbles in the electrolyte. In a particular example, the anode 20 and/or cathode 30 can include a porous conductive material, which can be flexible. Preferably, the porous conductive material is gas permeable and liquid permeable (i.e. electrolyte permeable). The anode 20 and/or cathode 30 can include, or be next to, fixed to, or adjacent, a gas permeable material, which also can be flexible. Preferably, the gas permeable material is gas permeable and liquid impermeable (i.e. electrolyte impermeable), and thus the anode 20 and/or cathode 30 composite structure can be gas permeable and liquid impermeable (i.e. electrolyte impermeable), and optionally flexible. Preferably, the gas permeable material is non-conductive. The anode 20 and/or cathode 30 can be Gas Diffusion Electrodes (GDEs). In an optional example, electrolyte 15 can be pumped past the electrodes 20, 30 using a pump. In other example embodiments, less than 10% of the gas produced takes the form of bubbles in the electrolyte. In other example embodiments, less than 8%, less than 5%, less than 3%, less than 2%, less than 1%, less than 0.5%, or less than 0.25%, of the gas produced takes the form of bubbles in the electrolyte.

Reference to a gas permeable material should be read as a general reference including any form or type of gas permeable medium, article, layer, membrane, barrier, matrix, element or structure, or combination thereof.

Reference to a gas permeable material should also be read as including any medium, article, layer, membrane, barrier, matrix, element or structure that is penetrable to allow movement, transfer, penetration or transport of one or more gases through or across at least part of the material, medium, article, layer, membrane, barrier, matrix, element or structure (i.e. the gas permeable material). That is, a substance of which the gas permeable material is made may or may not be gas permeable itself, but the material, medium, article, layer, membrane, barrier, matrix, element or structure formed or made of, or at least partially formed or made of, the substance is gas permeable. The gas permeable material may be porous, may be a composite of at least one non-porous material and one porous material, or may be completely non-porous. The gas permeable material can also be referred to as a “breathable” material. By way of clarifying example only, without imposing any limitation, an example of a gas permeable material is a porous matrix, and an example of a substance from which the gas permeable material is made or formed is PTFE.

An electrode can be provided by or include a porous conductive material. Preferably, the porous conductive material is gas permeable and liquid permeable.

Reference to a porous conductive material should be read as including any medium, article, layer, membrane, barrier, matrix, element or structure that is penetrable to allow movement, transfer, penetration or transport of one or more gases and/or liquids through or across at least part of the material, medium, article, layer, membrane, barrier, matrix, element or structure (i.e. the porous conductive material). That is, a substance of which the porous conductive material is made may or may not be gas and/or liquid permeable itself, but the material, medium, article, layer, membrane, barrier, matrix, element or structure formed or made of, or at least partially formed or made of, the substance is gas and/or liquid permeable. The porous conductive material may be a composite material, for example composed of more than one type of conductive material, metallic material, or of a conductive or metallic material(s) and non-metallic material(s).

By way of clarifying examples only, without imposing any limitation, examples of porous conductive materials include porous or permeable metals, conductors, meshes, grids, lattices, cloths, woven or non-woven structures, webs or perforated sheets. The porous conductive material may also be a material that has “metal-like” properties of conduction. For example, a porous carbon cloth may be considered a porous conductive material since its conductive properties are similar to those of a metal.

The porous conductive material may be a composite material, for example composed of more than one type of conductive material, metallic material, or of a conductive or metallic material(s) and non-metallic material(s). Furthermore, the porous conductive material may be one or more metallic materials coated onto at least part of the gas permeable material, for example sputter coated, or coated or deposited onto at least part of a separate gas permeable material that is used in association with the gas permeable material. By way of clarifying examples only, without imposing any limitation, examples of porous conductive materials include porous or permeable metals, conductors, meshes, grids, lattices, cloths, woven or non-woven structures, webs or perforated sheets. The porous conductive material may be a separate material/layer attached to the gas permeable material, or may be formed on and/or as part of the gas permeable material (e.g. by coating or deposition).

The electrochemical cell can be provided in a “flat-sheet” (i.e. stacked) or a “spiral-wound” format. Flat-sheet means the electrodes (e.g. cathodes and/or anodes) are formed of planar layers or substantially planar layers, so that a flat-sheet electrochemical cell is comprised of a plurality of planar electrodes or substantially planar electrodes. A flat-sheet electrochemical cell can be stacked together with other flat-sheet electrochemical cells (one on top of another in a series or array of electrochemical cells) to form a layered stack of multiple electrochemical cells (i.e. a stacked electrochemical cell). The “flat-sheet” and “spiral-wound” cells, modules or reactors typically involve gas permeable, liquid impermeable gas diffusion electrode sheets or layers stacked in two or more layers, where the electrodes, including gas-producing electrodes, are separated from one another by spacers or spacer layers, for example distinct electrolyte channel spacers (which are permeable to, and intended to guide the permeation of liquid electrolyte through the cell) and/or gas channel spacers (which are permeable to, and intended to guide the permeation of gases through the cell). There may be more than one type of gas channel. For example, there may be two distinct gas channels, one for a first gas (e.g. hydrogen in a water electrolysis cell) and another for a second gas (e.g. oxygen in a water electrolysis cell). There may, similarly, be separate channels for more than one electrolyte. For example, in a modified chlor-alkali cell suitable for manufacturing chlorine-hypochlorite disinfection chemistries, there may be separate channels for the feed electrolyte (NaCl solution, 25%, pH 2-4) and the product electrolyte.

In the “spiral-wound” arrangement, the resulting multi-electrode stack is tightly wound about a core element, to thereby create the spiral-wound cell or module. The core element may contain some or all of the gas-liquid and electrical conduits with which to plumb and/or electrically connect the various components of the cell or module. For example, the core element may combine all of the channels for one or another particular gas in the stack into a single pipe, which is then conveniently valved for attachment to an external gas tank. The core element may similarly contain an electrical arrangement which connects the anodes and cathodes of the module into only two external electrical connections on the module—a positive pole and a negative pole.

One key advantage of spiral-wound cells or modules over other module arrangements is that they provide a high overall electrochemical surface area within a relatively small overall geometric footprint. A spiral-wound electrochemical module is believed to provide for the highest possible active surface area within the smallest reasonable footprint. Another advantage of spiral-wound arrangements is that round objects are easier to pressurize than other geometries which involve corners. So, the spiral design has been found to be beneficial for electrochemical cells in which the electrochemical reaction is favourably impacted by the application of a high pressure.

Regardless of whether the reactor or cell arrangement is spiral wound or flat sheet the modular reactor units may be so engineered as to be readily attached to other identical modular units, to thereby seamlessly enlarge the overall reactor to the extent required. The combined modular units may themselves be housed within a second, robust housing that contains within it all of the liquid that is passed through the modular units and which serves as a second containment chamber for the gases that are present within the interconnected modules. The individual modular units within the second, outer robust housing may be readily and easily removed and exchanged for other, identical modules, allowing easy replacement of defective or poorly operational modules.

### Minimising Gas Solubility and Bubble Formation

In example embodiments, methods and cells for facilitating the operation of electrochemical cells by minimising gas solubility and bubble formation are described in the Applicant's concurrent International Patent Application for “Methods of improving the efficiency of gas-liquid electrochemical cells”, filed on 14 Dec. 2016, which is incorporated herein by reference.

The inventors have realised that in electrochemical cells involving a liquid or gel electrolyte between the electrodes, which are preferably one or more gas-producing electrodes, gas that may be formed or built up within the liquid electrolyte in the cell (for example, at the surface of an electrode in the cell) can do one of three things:
(1) The gas can dissolve in the liquid electrolyte and migrate away;
(2) The gas can form a new, independent bubble;
(3) The gas can join an existing bubble (or gas region), either natural or man-made. That is, the gas can pass across an existing gas-liquid interface into an existing gaseous phase or region.

FIG. 2 illustrates, in schematic form, the three different pathways 1, 2, 3, following the above numbering, available to gas formed within a liquid electrolyte in a gas-liquid cell.

Pathway (1) above is generally deleterious to energy efficiency, since the presence of dissolved gases in the liquid electrolyte between the electrodes of an electrochemical cell leads to higher electrical resistance, as taught in US 20080160357. It also promotes crossover between the electrodes.

For the reasons given in the Background section, pathway (2) above is generally also deleterious to the efficient operation of a cell having liquid or gel electrolyte between its electrodes.

The inventors have, contrary to known expectations, realised that pathway (3) above need not be deleterious to the efficient operation of a cell having liquid or gel electrolyte between the electrodes, if the “existing bubble” (i.e. “gas region” or “one or more void volumes”), either natural or man-made, lies outside of, or substantially outside of, the conduction pathway between the electrodes.

One or more “void volumes” can be provided by one or more porous structures, which can be provided by one or more gas permeable materials. The one or more porous structures, or gas permeable materials, providing one or more void volumes, are preferably gas permeable and liquid impermeable, or substantially liquid impermeable. The one or more porous structures, or gas permeable materials, providing one or more void volumes, are also preferably non-conducting.

The inventors have realised that, in fact, pathway (3) provides a potentially useful means of controlling and handling gas formation in a manner that ensures gas formation is not deleterious to the operation and efficiency of the cell. That is, the inventors have unexpectedly realised that instead of seeking to suppress or block bubble formation, it may be more efficacious to direct gas formation to a pre-existing bubble or gas region (i.e. one or more void volumes), either natural or man-made, that has been designed to accept and accommodate gas formation in a way that does not impinge or substantially impinge on the operation and efficiency of the cell.

Moreover, the inventors have realised that, as a consequence of the Laplace equation, it is, in fact, energetically more favourable for newly formed or dissolved gas within a liquid to join a large, pre-existing bubble or gas region, either natural or man-made, than it is for the gas to form an independent, new bubble on a surface (either within a ‘cleft’ or as a stand-alone spherical bubble). This is because a large, pre-existing bubble (which could also be considered as a gas region or a void volume) will necessarily have a larger radius and therefore a lower internal (‘Laplace’) pressure than either a newly-formed spherical bubble or a newly-formed bubble in a surface ‘cleft’.

Furthermore, the concentration of dissolved gas within a liquid electrolyte is also necessarily minimised about a pre-existing bubble, gas region or void volume, either natural or man-made, since the bubble, region or volume provides an additional interface through which excess gaseous molecules are favoured to escape the liquid phase. In particular, it is, effectively, impossible for a liquid electrolyte to become supersaturated near to such a bubble, since the bubble interface provides a ready route for the excess gas to escape the liquid phase. This is important because the lower the quantity of dissolved gases in the liquid electrolyte, the lower its electrical resistance and the greater the energy/electrical efficiency of the cell, whilst crossover is also suppressed.

Thus, in particular example embodiments, the inventors have realised that providing one or more void volumes, e.g. a pre-existing bubble, gas region or gas pathway, either naturally occurring or man-made, that is preferably positioned outside of the electrical conduction pathway between a gas-producing electrode and its counter electrode, substantially outside of the electrical conduction pathway between a gas-producing electrode and its counter electrode, partially outside of the electrical conduction pathway between a gas-producing electrode and its counter electrode, peripheral to or adjacent to the electrical conduction pathway between a gas-producing electrode and its counter electrode, and/or having a small cross-sectional area relative to the electrical conduction pathway between a gas-producing electrode and its counter electrode, and which can be within, partially within, adjacent to or near to a liquid electrolyte, or gel electrolyte, between the gas-producing electrode and its counter electrode of a cell, has the effect of not only disfavouring pathway (2) above but also minimising pathway (1) above. In another example, the counter electrode is a gas-producing counter electrode, so that both of the electrodes are gas-producing electrodes.

In particular example embodiments, the inventors have, further, discovered that pathway (1) above may be further lessened by selecting physical conditions for the cell that diminish, reduce, or minimise the dissolution of gases and/or their diffusion in the liquid electrolyte under conditions of high, higher, or maximal electrolyte conductivity. Stated differently: in particular example embodiments the inventors have discovered that the deleterious effect of pathway (1) on the cell may be further lessened by configuring or selecting physical conditions for the cell that diminish, reduce, or minimise the effect that dissolved gases may have on the operation of the cell under conditions of high, higher, or maximal energy efficiency. The physical conditions include but are not limited to, one or more of the following:
a. The temperature of operation;
b. The type and concentration of the electrolyte in the liquid phase (including the surface tension of the electrolyte);
c. The pressure applied to the liquid electrolyte (including the pressure differential across a gas diffusion electrode that may be used);
d. The nature of any spacer that may be used to separate the electrodes;
e. The mode of operation;
f. The flow-rate of the liquid electrolyte; and
g. The flow-type of the liquid electrolyte (i.e. laminar or turbulent flow).

In particular example embodiments, the inventors have found that it may be beneficial to use physical laws such as Ficks' law, Henry's law, Raoults' law, the Senechov equation, the Stokes-Einstein (-Sutherland) equation, and similar expressions, to guide the setting of the above physical conditions. It may be useful to thereafter further refine the settings for the physical conditions using empirical measurement.

In particular example embodiments, the inventors have found that, in general and without limitation, the physical conditions within the cell should be configured or selected so as to:
(I) increase or maximise the electrical conductance of the electrolyte (typically, but not exclusively in units of S/cm) to the greatest reasonable extent,
(II) whilst simultaneously reducing or minimising the dissolution of gases in the electrolyte (typically, but not exclusively in units of mol/L) to the greatest reasonable extent, and
(III) reducing or minimising the rate of diffusion of the dissolved gas or gases in the electrolyte (typically, but not exclusively in units of cm²/s) to the greatest reasonable extent.

For convenience, (I) above is referred to as the “Conduction Factor” and given the symbol CF. In general, the physical conditions employed within the cell should be such that CF (typically, but not exclusively in units of S/cm) is increased or maximised to the greatest reasonable extent. The conductance, or conductivity of the electrolyte, is the reciprocal of electrical resistivity (in Ωcm-ohm centimeters). Therefore the Conduction Factor, or conductivity, is used as a measure the ionic conductance of the electrolyte. The unit of measurement used is typically, but not exclusively a Siemen per centimetre (S/cm).

For convenience, the product of (II) multiplied by (III) above is referred to as the “Gas Dissolution and Diffusion Factor” and given the symbol GDDF. In particular example embodiments, the inventors have found that, in general and without limitation, the physical conditions employed within the cell should be such that GDDF (typically, but not exclusively in units of: cm²·mol/L·s) is reduced or minimised to the greatest reasonable extent. Where multiple gases are involved, the sum of their GDDF's should be minimised to the greatest reasonable extent.

The expression for GDDF derives from Ficks' law for diffusion of dissolved gases in a liquid phase, and reflects the influence that diffusing, dissolved gases may have on the chemical processes present in an electrochemical cell of the present embodiments. The lower GDDF is, the less influence dissolved gases may have. That is, the lower GDDF is, the smaller is the effect of pathway (1) above, or the smaller is the influence of pathway (1) above on the chemical reactions in an electrochemical cell of the present embodiments.

For convenience, the ratio of CF divided by GDDF is referred to as the “Electrolyte Factor” and given the symbol EF. In general and without limitation, in particular example embodiments, the inventors have found that the physical conditions employed within the cell should be such that EF (typically, but not exclusively in units of: Ls/Ωcm³ mol) is increased or maximised to the greatest extent reasonable.

The expression EF=CF/GDDF reflects the ratio of the electrically conductive capacity of the liquid electrolyte to the extent of gas dissolution and diffusion in the liquid electrolyte. As noted above, in particular example embodiments, the inventors have found that certain electrochemical cells operate most efficiently if the electrical conductance of the liquid electrolyte is increased or maximised whilst simultaneously the extent of gas dissolution and diffusion in the liquid electrolyte is reduced or minimised.

Once the above combination of factors have been realised by setting the physical conditions in the most suitable, or least compromised manner, then features of the electrochemical cell design may be altered, set, created, or implemented to realise additional energy efficiencies. The electrochemical cell design features include but are not limited to, one or more of the following:
a. The inter-electrode distance employed;
b. The current density employed.

For convenience, the Inter-electrode Distance (typically, but not exclusively in units of: cm) is given the symbol ID, while the Current Density (typically, but not exclusively in units of: mA/cm²) is given the symbol CD.

In particular example embodiments, the inventors have found that, in general and without limitation, the features of design within the cell, namely: the Inter-electrode Distance (ID; typically, but not exclusively in units of: cm) and the Current Density (CD; typically, but not exclusively in units of: mA/cm²) should be set such that the product of the square of CD multiplied by ID and divided by CF, is reduced or minimized to the greatest reasonable extent. For convenience, this expression, ((CD)²×ID)/CF), is referred to as the “Power Density Factor” and given the symbol PF (typically, but not exclusively in units of mA²·/cm²). In general and without limitation, the physical conditions employed within the cell should be such that PF is reduced or minimized to the greatest reasonable extent.

Thus, the Power Density Factor (PF) is given by:

PF=((CD)²×ID)/CF.

The Power Density Factor (PF) is related to the rate at which work must be done to push an electrical current between the electrodes in the electrochemical cell—i.e. the electrical power consumed per unit area of gas-producing electrode. An increased energy and electrical efficiency in the cell must necessarily be accompanied by a reduction or minimization in the rate of work that must be done to drive an electric current between the electrodes in the cell. The quantity PF is therefore a proxy for, and inversely related to the energy efficiency of the cell.

In particular example embodiments, the inventors have found that it is also useful to quantify the percentage of the gases generated in an electro-synthetic cell of the present embodiments, that crossover from one electrode to the other due to gas migration in the liquid electrolyte. This Crossover quantity, CO, as a percentage, is provided by the expression for Crossover (CO):

CO=(n·F·GDDF)/(ID·CD)×100 (in units of: %)

where,
n=the number of electrons exchanged in the balanced, electrochemical half-reaction occurring at the gas-producing electrode in question (i.e. the number of electrons in the balanced redox half-reaction),
F=the Faraday constant=96,485 Coulombs/mol,
GDDF=Gas Dissolution and Diffusion Factor, which equates to:
   =(concentration of dissolved gas [in units of: mol/L])×(rate of diffusion of the dissolved gas [in units of: cm²/s])
   (in overall units of: cm²·mol/L·s,
   which can also be expressed as: mol/(1000 cm s),
ID=the inter-electrode distance (in units of: cm),
CD=the current density (in units of: mA/cm²), and
   where the individual factors in the above equation have the following units:
      (n·F·GDDF) has units: C·cm²/L·s,
         which can also be expressed as: C/(1000 cm s),
         which can also be expressed as: mA/cm
      (n·F·GDDF)/ID has units: mA cm²
      CD has units: mA/cm²
      (n·F·GDDF)/(ID·CD)×100 has units: %

In particular example embodiments, the inventors have found that, in general and without limitation, substantial energy efficiencies which may be greater than those achievable using other approaches, can be realised in electrochemical cells if the physical conditions in the cell and the features of cell design within the cell are set so that:
The Electrolyte Factor, EF (in units of: Ls/Ωcm³ mol), is increased or maximised to the greatest reasonable extent;
The Power Density Factor, PF (in units of: mA²Ω/cm²), is reduced or minimized to the greatest reasonable extent; and
The Crossover, CO (in %), is reduced or minimized to the greatest reasonable extent.

Taking all of the above into account, in particular example embodiments, the inventors further realised that when the effect of a careful selection of the physical conditions and the cell design features as described above, are combined with the effect of providing an existing bubble or gas region, i.e. one or more void volumes, either natural or man-made, that lies outside of, or substantially outside of the electrical conduction pathway, or positioned to have only a small or minimal effect between the electrical conduction pathway, then significant improvements in energy efficiencies are achieved in the electrochemical cell. These energy efficiencies may be greater than those achievable using other approaches, such as the use of solid-state ion-exchange membranes between the electrodes.

Thus, for example, as noted in Table 1: an electrochemical cell in which gas is produced in the form of bubbles, such as a conventional alkaline electrolyser, may experience a typical voltage drop of up to 0.6 V between the electrodes under operational conditions due to the effect of bubbles in the liquid electrolyte.

By contrast, a conventional PEM electrolyzer utilizing a solid-state Nafion 117 PEM membrane (185 μm thickness; immersed in water) between the electrodes and operating at a typical current density of 1.8 A/cm² at 80° C. will experience a much smaller 0.229 V ohmic drop between the electrodes.

Best of all, however, is an alkaline electrolyzer of the current embodiments having a 3 mm inter-electrode gap and operating at a typical current density of 50 mA/cm² at 80° C. using aqueous 6 M KOH as a liquid electrolyte. Such an electrolyzer will experience a mere 0.011 V ohmic drop between the electrodes. A low voltage drop is consistent with high, or higher fundamental energy and electrical efficiency.

| | | Voltage drop | |
|---|---|---|---|
| | | between the | |
| | | electrodes under | |
| Type of liquid-gas electrochemical | | typical operating | |
| cell | Example | conditions* | |
| Cell with liquid electrolyte where gas | Conventional | up to 0.600 | V |
| is generated in the form of bubbles | alkaline | | |
| | electrolyzer | | |
| Cell with a solid-state, ion-exchange | PEM | 0.229 | V |
| membrane electrolyte, where gas is | electrolyzer | | |
| generated in the form of vapour | | | |
| Cell with liquid electrolyte where gas | Alkaline | 0.011 | V |
| joins a pre-existing bubble/gas region | electrolyzer of | | |
| outside of the conduction pathway | present | | |
| | embodiments | | |

*data from Example 4 in the Applicant's concurrent International Patent Application entitled “Methods of improving the efficiency of gas-liquid electrochemical cells”, filed on 14 Dec. 2016, and Example 2 in the Applicant's concurrent International Patent Application entitled “High pressure electrochemical cell”, filed on 14 Dec. 2016, both of which are incorporated herein by reference

Table 1 compares the ohmic voltage drop that occurs during typical operation of a conventional alkaline electrolyzer, a PEM electrolyzer and an electrolyzer of present embodiments.

It should be noted that, even if the PEM electrolyzer of the above example were to be operated at one-twentieth of its normal, operational current density (i.e. at 90 mA/cm²), which would likely be economically unviable, it would still experience a higher voltage drop than that experienced by the above alkaline electrolyzer.

Summarising these concepts, embodiments involve electrochemical cells and methods of use or operation in which one or more gas-producing electrodes operate in a manner that is bubble-free or substantially bubble-free. The electrochemical cell does not have a diaphragm present between the gas-producing electrodes. Preferably, the electrochemical cell makes use of a particular catalyst-electrolyte system. The electrochemical cell is optimised to determine the best settings for different variables of the electrochemical cell, including:
(i) the electrolyte concentration (e.g. KOH concentration in one example);
(ii) the temperature of the electrolyte;
(iii) the pressure applied to the electrolyte;
(iv) the inter-electrode distance (e.g. the distance between the anode and the cathode); and
(v) the current density.
   For optimisation of the electrochemical cell, it is required to determine what settings for these variables yield the optimum performance by a gas-producing electrode of the electrochemical cell.

There are three main relationships between these variables that are believed to be critical to optimising electrode performance; these are, as described above: the Electrolyte Factor (EF), the Power Density Factor (PF) and the Crossover (CO). The maximum or optimal electrode performance occurs when the following conditions are simultaneously met:
EF is maximised,
PF is minimised and
CO is minimised.

Not only may the energy efficiencies realised by this approach be more substantial than those achievable using other approaches, such as the use of solid-state ion-exchange membranes between the electrodes, but they may also be most amplified under circumstances where energy losses are normally at their greatest in conventional cells; that is, at higher pressures and/or current densities.

Of the five different variables (i)-(v) listed above, three are physical reaction aspects—namely, (i) the electrolyte concentration, (ii) the temperature, and (iii) the pressure. However, the other two variables are, effectively, engineering quantities and can be set from wide ranges for satisfying or improving optimisation, namely: (iv) the inter-electrode distance, and (v) the current density.

That is important because the Electrolyte Factor (EF) is determined only by variables (i)-(iii) above, i.e. (i) the electrolyte concentration, (ii) the temperature, and (iii) the pressure. By contrast, the Power Density Factor (PF) and the Crossover (CO) are determined mainly by the engineering variables, being (iv) the inter-electrode distance, and (v) the current density.

In fact, the Power Density Factor (PF) is influenced in a minor way by one component of the Electrolyte Factor (EF), namely the Electrolyte Conduction Factor (CF), whereas the Crossover (CO) is influenced in a minor way by the other component of the Electrolyte factor (EF), namely the Gas Diffusion and Dissolution Factor (GDDF).

Thus, generally one is limited by nature and the laws of physics in where the Electrolyte Factor (EF) will peak. However, the Power Density Factor (PF) and the Crossover (CO) can be, effectively, determined or set for optimisation. In other words, one can find out where the Electrolyte Factor (EF) will peak, and then use the available control or freedom of the engineering quantities to cause the Power Density Factor (PF) and the Crossover (CO) to be simultaneously at minima (zeroed in the case of CO), or simultaneously as close to minima as possible.

In particular example embodiments, the inventors have therefore discovered that energy savings can be realised in a liquid-gas electrochemical cell having a liquid- or gel-electrolyte between the gas-producing electrodes by:
(1) providing a large, pre-formed or pre-existing bubble or bubbles (i.e. void volume(s), or gas region, or gas pathway, or bubble region), either natural or man-made, within, at, adjacent to or near to the source of gas in the cell in order to:
   i. reduce or minimise gas dissolution in the liquid electrolyte, and
   ii. reduce or minimise independent bubble formation;
(2) locating the pre-formed or pre-existing gas bubble(s) or region(s), either natural or man-made, outside of or on the periphery of the conduction pathway of the electrochemical cell, or to occupy only a small cross-sectional area within the conduction pathway of the electrochemical cell, so that its presence does not substantially increase the electrical resistance of the cell;
   and/or under circumstances where:
(3) the physical conditions within the cell and the cell design are set so that:
   i. the Electrolyte Factor (EF; for example in units of: Ls/Ωcm³ mol) is increased or maximised to the greatest reasonable extent; and
   ii. the Power Density Factor (PF; for example in units of: mA²Ω/cm²) and the Crossover (CO; for example %), are reduced or minimized to the greatest reasonable extent.

In particular example embodiments, the inventors have further realised that not only can the energy efficiencies realised by this approach be more substantial than those achievable using other approaches, such as the use of solid-state ion-exchange membranes between the electrodes, but the energy efficiencies can also be most amplified under circumstances where energy losses are normally at their greatest in conventional cells; that is, at higher pressures and/or current densities.

In one example aspect, there is provided a liquid-gas electrochemical cell having a liquid- or gel-electrolyte between the gas-producing electrodes where:
(I) one or more void volumes, that lie outside of or on the periphery of the conduction pathway or occupy only a small cross-sectional area within the conduction pathway of the electrochemical cell, are located within, partially within, adjacent to, or near to the electrolyte; and where,
(II) the physical conditions in the cell and the cell design are set so that:
   i. the Electrolyte Factor (EF; in units of: L·s/Ωcm³·mol) is increased or maximised to the greatest reasonable extent; and
   ii. the Power Density Factor (PF; in units of: mA²·Ω/cm²) and the Crossover (CO; %), are reduced or minimized to the greatest reasonable extent.

Preferably but not exclusively, the one or more void volumes are directly adjacent to, next to, or positioned within the source of gas formation, in order to facilitate the migration of gas to the one or more void volumes. One or more “void volumes” can be provided by one or more porous structures, which can be gas permeable materials. The one or more porous structures, or gas permeable materials, providing one or more void volumes, are preferably gas permeable and liquid impermeable, or substantially liquid impermeable.

Preferably but not exclusively, the one or more void volumes are provided by a gas permeable material (i.e. a porous structure) that is not permeable to the electrolyte (i.e. liquid impermeable) but accommodates or allows passage of gas (i.e. gas permeable). Thus, in one preferred form, a void volume is provided by a gas permeable and liquid impermeable porous structure(s) or material(s). The one or more void volumes are preferably non-conductive.

In the case of an aqueous liquid electrolyte, the one or more void volumes are preferably but not exclusively provided by a porous hydrophobic structure, such as a porous hydrophobic assembly, membrane or hollow fibre, or a collection of such structures, which remains unfilled with liquid electrolyte or gel electrolyte during the operation of the cell.

The void volume, or the one or more void volumes, may be considered to be a “pre-existing bubble”, a “pre-formed bubble”, a “gas region”, a “gas pathway”, a “gas void”, an “artificial bubble” or a “man-made bubble”. Preferably the void volume, or the one or more void volumes, lies outside of or on the periphery of the electrical conduction pathway of the cell, or occupies only a small cross-sectional area within the electrical conduction pathway. In another example, the cross-sectional area of the void volume is less than the cross-sectional area of the electrical conduction pathway, relative to a perpendicular direction extending from the surface of an electrode.

In alternative preferred embodiments, a void volume may be provided by a natural bubble or bubbles that are statically or near-statically positioned outside of, or within a small cross-sectional area in the conduction pathway of the cell. For example, the static or near-static, natural bubble or bubbles may be contained, or mechanically trapped within an accommodating structure that is located outside of, or within a small cross-sectional area within the conduction pathway of the cell. In another example, the natural, static or near-static bubble or bubbles may simply be formed or located outside of, or within a small cross-sectional area in the conduction pathway of the cell.

In one preferred embodiment, an electrochemical cell contains one or more void volumes configured to accept and accommodate migrating gas so as to thereby improve the efficiency of the cell. For example, a cell with an aqueous liquid or gel electrolyte may contain portions of a thin, highly hydrophobic sheet membrane or hollow fibre membrane that is isolated and not in gaseous contact with the environment about it. Such isolated portions of a thin, highly hydrophobic sheet membrane or hollow fibre membrane, may be placed so as to accept and accommodate gas that is slowly but inopportunely generated within the cell during operation. In addition to being isolated from the surroundings, the void volumes within the hydrophobic membranes may also be isolated from each other and, or they may be in gaseous contact with each other.

The hydrophobic membranes may be located at the edges of the cell outside of the electrical pathway of the cell, or they may be placed in, for example, a lengthwise location, along the electrical pathway, to thereby minimise their footprint for electrical resistance.

For example, the void volume(s) may accommodate gas that is slowly but inopportunely created within a battery during overcharging, including but not limited to a Ni metal hydride, lead acid, or lithium ion battery, where the uncontrolled formation of independent gas bubbles has the potential to damage the battery or degrade its performance. In such an application, the void volumes may, in effect, replace or partially replace the sacrificial materials that are routinely incorporated to suppress gas formation. The void volume(s) may further act as a “buffer tank” to hold amounts of gases that are formed prior to the reverse, recombination reaction that removes them during discharging.

In another example, the void volume(s) may accommodate gas formed during the operation of an electrophoretic or electroosmotic cell to thereby improve the operation of the cell. In further non-limiting examples, the void volume(s) may act to halt or minimise the incidence of bubble formation in electrochemical cells with solid-state or gel electrolytes.

It is to be understood that, even in cases where a void volume is in gaseous isolation from its environment within a liquid media, it may still be capable of accepting substantial quantities of gas. This may arise because a void volume will necessarily and competitively accommodate migrating gas up to the point that the internal gas pressure within the void volume exceeds the so-called “bubble point” of the void volume. At that stage one or more bubbles will form in an uncontrolled manner at the interface between the void volume and the surrounding liquid media. Thus, the fact that a void volume may be in gaseous isolation within a liquid or gel media does not prevent it from accepting and accommodating even substantial quantities of gas. The term “bubble point” is used herein in the context described in the Applicant's International Patent Publication No. WO2015013764, entitled “Method and Electrochemical Cell for Managing Electrochemical Reactions”, which is herein incorporated by reference.

In another preferred embodiment, the void volume does not merely accept and accommodate migrating gas, but instead, or additionally, forms a gaseous conduit that transports the migrated gas from/to another part of the cell, or into/out of the cell entirely, for example to a holding tank. For example, the void volume may act to allow unwanted gases formed within the electrolyte of the cell to escape from the cell.

For example, the void volume(s) may transport gas from the electrolyte present between the electrodes, including gas-producing electrodes, to another portion of the cell that lies outside of, or substantially outside of the conduction pathway of the cell, or to the outside of the cell. In other examples, the void volume may act to continuously remove dissolved gases within the liquid- or gel-electrolyte of the cell between the electrodes, to thereby improve the electrical conductivity and hence the electrical efficiency of the cell. That is, the void volume may be used to continuously “de-gas” the electrolyte and vent dissolved gases to the air, so as to thereby improve the electrical conductivity of the electrolyte.

In other examples, the void volume(s) may act to competitively suppress dissolution of gas within an electrolyte, so as to thereby maximise the electrical conductivity of the electrolyte. In additional examples, the void volume(s) may act to carry a particular inert gas into the cell, so as to thereby saturate the electrolyte with a gas that is reactively inert and to thereby improve the overall efficiency of the cell.

In another preferred embodiment, the void volume may be associated with an electrode. That is, the void volume may form the gaseous side of a gas diffusion electrode, where the gaseous side of the electrode lies outside of, or substantially outside of the conduction pathway of the cell between the electrodes, and where the gaseous side of the gas diffusion electrode facilitates the movement of gas into or out of the cell. The gas diffusion electrode may act to transport a gas generated at the electrode out of the cell; alternatively, the gas diffusion electrode may act to transport gas into the cell, from the outside of the cell. Examples of such cells include an ‘electrosynthetic’ or an ‘electro-energy’ cell.

In an embodiment where the electrochemical cell contains at least one gas diffusion electrode, the cell preferably but not exclusively has one or more of the following advantages:
(1) an ability to conveniently and economically manage a variety of industrial electrochemical processes by deployment of gas diffusion electrodes where only solid-state electrodes had previously been viable or economical;
(2) an ability to apply higher gas or liquid pressures in electrochemical cells utilizing gas diffusion electrodes than had previously been possible;
(3) elimination of the need for complex and expensive pressure-equalising equipment in industrial electrochemical cells that currently employ gas diffusion electrodes. The pressure equalising equipment was needed to avoid substantive pressure differentials over the gas and the liquid sides of the gas diffusion electrodes, which would result in leaking of the liquid electrolyte;
(4) an ability to conveniently and economically facilitate energetically-favourable gas depolarization reactions at electrodes (for example at the counter electrode) in industrial electrochemical cells and/or devices, where this was attractive from an energy efficiency point of view but had not been previously feasible; and/or
(5) the possibility of adding a barrier layer or film to a gas diffusion electrode such that it permits transport of the reactant/product gas but excludes water vapour.

Preferably but not exclusively, the cell is operated under conditions where the “Electrolyte Factor” (EF; for example in units of: mA·mol/L·s) is increased or maximised to the greatest reasonable extent. The “Electrolyte Factor” (EF; in units of: mA·mol/L·s) reflects the ratio of the conductive capacity of the liquid electrolyte to the extent of gas dissolution and diffusion in the liquid electrolyte. Where multiple gases are involved, the “Electrolyte Factor” (EF; in units of: mA·mol/L·s) reflects the ratio of the conductive capacity of the liquid electrolyte to the sum for all of the gases of the extent of gas dissolution and diffusion in the liquid electrolyte.

Accordingly, and preferably but not exclusively, the physical conditions described above are set so as to increase or maximise the conductance of the liquid- or gel-electrolyte between the electrodes in the cell. Furthermore, preferably but not exclusively, the physical conditions described above are set so as to reduce or minimise the dissolution of gas in the liquid- or gel-electrolyte between the electrodes, so as to thereby increase or maximise the electrical conductance of the electrolyte. In the alternative, the physical conditions described above are, preferably but not exclusively, set to reduce or minimise the rate of diffusion of the gases that are dissolved in the liquid- or gel-electrolyte between the electrodes. In a third alternative, the physical conditions described above are, preferably but not exclusively, set to reduce or minimise either the dissolution of gases in the electrolyte, or the rate of diffusion of the gases in the electrolyte, or a suitable combination thereof, so as to increase or maximise the efficiency of the cell in operation and/or from an energy or electrical efficiency viewpoint.

Thus the one or more void volumes, e.g. a pre-existing bubble, gas region or gas pathway, either naturally occurring or man-made, in different examples, can be positioned:
(i) outside of the electrical conduction pathway between electrodes,
(ii) substantially outside of the electrical conduction pathway between electrodes,
(iii) partially outside of the electrical conduction pathway between electrodes,
(iv) peripheral to or adjacent to the electrical conduction pathway between electrodes,
(v) between the electrodes and within the electrical conduction pathway, but having a small cross-sectional area relative to the electrical conduction pathway between electrodes,
(vi) between the electrodes and parallel to the electrical conduction pathway, so as to have a small cross-sectional area relative to the electrical conduction pathway between electrodes,
(vii) between the electrodes and perpendicular to one or both of the electrodes, so as to have a small cross-sectional area relative to the electrical conduction pathway between electrodes, and/or
(viii) within, partially within, adjacent to or next to a liquid electrolyte, or gel electrolyte of the cell.

Preferably but not exclusively, the cell can be operated under conditions where the Crossover (CO; for example in %), is reduced or minimized to the greatest reasonable extent. The Crossover (CO; in %) is the percentage of gases that cross from one electrode to the other due to gas migration in the liquid electrolyte.

In example embodiments, the Crossover (CO) is preferably less than or equal to 40%. In example embodiments, the Crossover (CO) is less than or equal to 30%, less than or equal to 20%, less than or equal to 15%, less than or equal to 12%, less than or equal to 10%, less than or equal to 8%, less than or equal to 5%, less than or equal to 4%, less than or equal to 3%, less than or equal to 2%, less than or equal to 1%, or less than or equal to 0.5%. In each case, the Crossover (CO) is greater than or equal to 0%. In another example, the Crossover (CO) is equal to or about 0%.

### High Pressure Operation

In example embodiments, methods for facilitating the operation of electrochemical cells at high pressures are described in the Applicant's concurrent International Patent Application for “High pressure electrochemical cell”, filed on 14 Dec. 2016, which is incorporated herein by reference.

In particular example embodiments, the inventors have discovered that the operation of an electrochemical cell, under the conditions described herein, can allow for cells that are capable of operating at higher pressures than are viable in many conventional systems. Additionally, the higher pressures are accompanied by greater energy efficiency and/or higher current densities. That is, in particular example embodiments, the inventors have discovered that the advantages of modes of operating the example electrochemical cells described herein, relative to comparable, conventional cells, are so unexpectedly amplified as to allow for economically-viable operation under hitherto unavailable or unviable conditions of pressure.

Increases in the applied pressure in electrochemical cells of example embodiments should not degrade the purity of the one or more gases collected at the anode and/or cathode, at least not to near the extent observed in conventional cells. Moreover, when operated in the described way, such cells are substantially more electrically and energy efficient than comparable conventional cells. Increases in applied current density at high pressure can also have the effect of progressively improving, and not degrading, the gas purity as is the case for conventional cells. This can be accompanied by high energy efficiency and/or high current densities. This realisation has important practical utility since it can yield new industrial electro-synthetic and electro-energy processes that operate under hitherto unavailable or unviable conditions of pressure and/or current density.

It should be noted that “pressure” as used herein (including reference to “high pressure”), unless otherwise stated, refers to the “gas pressure” (e.g. a gaseous product(s) pressure), which is necessarily similar or close to, but somewhat below the “electrolyte pressure” (e.g. a liquid electrolyte pressure). The “electrolyte pressure” should not be more than the “gas pressure” plus the “wetting pressure of a membrane” (otherwise the membrane will leak/flood). In general, by way of example, the “gas pressure” is typically set to about 0.5 bar to about 1.5 bar below the “electrolyte pressure”.

In example embodiments, high pressure (i.e. the pressure) is preferably greater than or equal to 10 bar. In alternative example embodiments, high pressure is preferably greater than or equal to 20 bar, greater than or equal to 30 bar, greater than or equal to 40 bar, greater than or equal to 50 bar, greater than or equal to 60 bar, greater than or equal to 70 bar, greater than or equal to 80 bar, greater than or equal to 90 bar, greater than or equal to 100 bar, greater than or equal to 200 bar, greater than or equal to 300 bar, greater than or equal to 400 bar, or greater than or equal to 500 bar.

For example, the inventors have remarkably discovered that the problem of (i) gas crossover through the separator and the problem of (ii) gas pressure equalisation across the separator in an alkaline electrolyzer under high pressure conditions, as described in WO2013/066331 and on pages 160-161 in the book “Hydrogen Production by Electrolysis”, by A. Godula-Jopek (Wiley-VCH, 2015), can be eliminated or drastically curtailed by using appropriate gas diffusion electrodes at the anode and cathode and then removing the separator entirely.

Provided that the gas diffusion electrodes, have a suitably high wetting pressure and the pressure differential of the liquid over the gas side of the electrodes is never allowed to exceed that wetting pressure, then it is possible to find physical conditions under which gas crossover is minimal and certainly far less than in a conventional electrochemical cell. As a result, it becomes possible to produce gases of high purity at high pressures.

Removing the diaphragm, separator or ion exchange membrane also avoids the difficulties involved in equalising the pressure of the catholyte and anolyte chambers as observed in, for example, the electrolyzer developed by Avalence LLC described in WO2013/066331 and on pages 160-161 in the book “Hydrogen Production by Electrolysis”, by A. Godula-Jopek (Wiley-VCH, 2015). When the separator is removed, the catholyte and anolyte chambers become one, so that no pressure differential can then exist between the cathode and anode, at least from the pressure applied to the electrolyte. In concert with avoiding bubble formation, removal of the separator further eliminates crossover deriving from gas bubbles occupying the pores of the separator as observed in, for example, the aforementioned electrolyzer developed by Avalence LLC as described in WO2013/066331 and on pages 160-161 in the book “Hydrogen Production by Electrolysis”, by A. Godula-Jopek (Wiley-VCH, 2015).

The absence or substantial absence of bubbles in the liquid electrolyte further means that increasing current densities do not create an increasing electrical resistance and diminished energy efficiency arising from the “bubble overpotential”, “bubble-curtain” and “voidage” effects. For this reason, there is also a reduced requirement to rapidly pump electrolyte around the cell. Instead, higher current densities (at high pressure) have a beneficial effect, which involves mitigating and diminishing the relative amount of the gas crossover that occurs due to the migration of dissolved gases in the liquid electrolyte between the electrodes. The rate of such migration may be much smaller than that of bubble migration through a separator. It is also fixed by the physical conditions employed, including temperature, the concentration of salts in the liquid electrolyte, the extent of separation of the electrodes, the pressure applied on the liquid electrolyte and so forth. Since its rate is fixed, increasing the rate of overall gas generation by increasing the current density (under conditions of high pressure), acts to decrease the relative contribution of such gas crossover to the overall rate of gas production. In so doing, the impurities in the product gases created by gas crossover of this type become smaller, including vanishingly small, as the overall current density increases. That is, increases in current density at high pressure increase the purity of the gases generated and this occurs with high overall electrical efficiency.

These properties stand in stark contrast to the statement in the presentation for project PD117 in the 2015 Annual Merit Review Proceedings (Hydrogen Production and Delivery) of the US Department of Energy, to the effect that it is at present “Not possible to have high efficiency at high pressures”. Moreover, these unexpected properties overcome the fundamental impediments in high pressure alkaline electrolyzers, as illustrated in the electrolyzer developed by Avalence LLC described in WO2013/066331 and on pages 160-161 in the book “Hydrogen Production by Electrolysis”, by A. Godula-Jopek (Wiley-VCH, 2015), operation of which is limited both in the current density (at high pressure) that can be efficiently applied and the fact that increases in pressure lead to increasingly impure gases (thereby, ultimately, limiting the maximum applied pressure).

As a result of these properties, the example electrochemical cells as described herein and in the Applicant's concurrent International Patent Applications entitled “Electrochemical cell and components thereof capable of operating at high current density” and “Electrochemical cell and components thereof capable of operating at high voltage”, filed on 14 Dec. 2016, which are incorporated herein by reference, can, unexpectedly, be used to generate high pressure gases of high purity at, optionally, a high current density and with, optionally, high electrical and energy efficiency without the need for a gas compressor. Similar principles apply to the reverse situation, namely fuel cells of the abovementioned type, which may utilize high pressure gases of high purity, at a high current density, to achieve high electrical and energy efficiency.

Accordingly, in one aspect, embodiments provide for an electrochemical cell that generates one or more high purity gases at high pressure from a liquid electrolyte, without a gas compressor. Preferably, the cell operates with high electrical and energy efficiency.

Preferably, bubbles of the gas are not formed or produced, or are substantially not formed or produced at the gas-producing electrode. Also preferably, there is no diaphragm, separator or ion exchange membrane positioned between the gas-producing electrode and the counter electrode, i.e. between the anode and the cathode. In another example, the method includes selecting an Inter-electrode Distance (ID) between the electrodes and/or selecting a Current Density (CD) so that a Crossover (CO) for the electrochemical cell is less than or equal to 40%. Optionally, the Crossover (CO) is equal to or about 0%. In one example, one or more void volumes are located at or adjacent to the gas-producing electrode. An example method comprises operating the electrochemical cell at a current density greater than or equal to 50 mA/cm² and at a pressure greater than or equal to 10 bar.

In example embodiments, high purity of a gas is preferably greater than or equal to 90%. In alternative example embodiments, high purity of a gas is preferably greater than or equal to 95%, greater than or equal to 97%, greater than or equal to 99%, greater than or equal to 99.5%, greater than or equal to 99.9%, greater than or equal to 99.99%, greater than or equal to 99.999%, greater than or equal to 99.9999%, or greater than or equal to 99.99999%. In another example, a produced gas has a purity equal to or about 100%.

In example embodiments, high pressure is preferably greater than or equal to 10 bar. In alternative example embodiments, high pressure is preferably greater than or equal to 20 bar, greater than or equal to 30 bar, greater than or equal to 40 bar, greater than or equal to 50 bar, greater than or equal to 60 bar, greater than or equal to 70 bar, greater than or equal to 80 bar, greater than or equal to 90 bar, greater than or equal to 100 bar, greater than or equal to 200 bar, greater than or equal to 300 bar, greater than or equal to 400 bar, or greater than or equal to 500 bar.

In another aspect, the electrochemical cell generates high purity gases at high pressure from a liquid electrolyte at high current density and without a gas compressor.

In another example, the electrochemical cell generates high purity gases at high pressure from a liquid electrolyte without a gas compressor, where the electrochemical cell combines at least one or both of a gas diffusion anode and a gas diffusion cathode, both of which have relatively high wetting pressures.

In example embodiments, high wetting pressure is preferably greater than or equal to 0.2 bar. In alternative example embodiments, high wetting pressure is preferably greater than or equal to 0.4 bar, greater than or equal to 0.6 bar, greater than or equal to 0.8 bar, greater than or equal to 1 bar, greater than or equal to 1.5 bar, greater than or equal to 2 bar, greater than or equal to 2.5 bar, greater than or equal to 3 bar, greater than or equal to 4 bar, or greater than or equal to 5 bar.

In example embodiments, only a lessened or minor requirement to pump electrolyte around the cell is necessary, the electrolyte replacement rate is preferably less than 1 replacement of the electrolyte in the cell volume every 1 hour. In alternative example embodiments, the electrolyte replacement rate is preferably less than 1 replacement of the electrolyte in the cell volume every 45 minutes, less than 1 replacement of the electrolyte in the cell volume every 30 minutes, less than 1 replacement of the electrolyte in the cell volume every 15 minutes, less than 1 replacement of the electrolyte in the cell volume every 10 minutes, less than 1 replacement of the electrolyte in the cell volume every 5 minutes, less than 1 replacement of the electrolyte in the cell volume every 1 minute, less than 1 replacement of the electrolyte in the cell volume every 30 seconds, less than 1 replacement of the electrolyte in the cell volume every 5 seconds, or less than 1 replacement of the electrolyte in the cell volume every 1 second.

In a further example aspect, there is provided electro-synthetic or electro-energy cells, such as an electrochemical cell or a fuel cell, with one or more gas diffusion electrodes that are bubble-free or substantially bubble-free in operation, wherein the cell is operated at high pressure and/or high current density. Similar principles apply to the reverse situation, namely: cells of the abovementioned type can utilize high purity gases at high pressure (obtained with or without use of a compressor), at, optionally, a high current density, to thereby, optionally, achieve high electrical and energy efficiency.

These examples provide for:
(1) An electrochemical cell that does not contain an ion-permeable diaphragm between the anode and the cathode of the cell, and that generates high purity gases, or one or more pure gases, at high pressure from a liquid or gel electrolyte, without need for a gas compressor.
(2) An electrochemical cell that does not contain an ion-permeable diaphragm between the anode and the cathode of the cell, and that operates in a bubble-free manner or substantially bubble-free manner, to generate high purity gases, or one or more pure gases, at high pressure from a liquid or gel electrolyte, without need for a gas compressor.
(3) An electrochemical cell that does not contain an ion-permeable diaphragm between the anode and the cathode of the cell, and that operates in a bubble-free or substantially bubble-free manner, to generate high purity gases, or one or more pure gases, at high pressure from a liquid or gel electrolyte, without need for a gas compressor, where the cell operates:
   i. with high current density and/or high energy efficiency; and/or
   ii. where increases in the current density yield increases in the purity of the gases produced.
      Operation Involving Sudden and Large, Intermittent and/or Fluctuating Currents

In example embodiments, methods for facilitating the operation of electrochemical cells at intermittent and/or fluctuating current supply, are described in the Applicant's concurrent International Patent Application for “Electrochemical cell that operates efficiently with fluctuating currents”, filed on 14 Dec. 2016, which is incorporated herein by reference.

Many known gas generating liquid-filled electrochemical cells, like conventional alkaline electrolyzers, cannot handle sudden and large increases in current as may occur when they are directly connected to highly intermittent current supplies, such as may be afforded by renewable energy sources like wind generators, solar panels or ocean wave/tidal generators. In the case of a very rapid rise in current, a large amount of gas may be produced very quickly in such cells, creating a potential pressure burst hazard and also potentially forcing the liquid electrolyte out of the cell, thereby damaging the cell either mechanically, or electrochemically, or both.

Where porous electrodes have been used, it may also be imperative to avoid sudden, large-scale gas evolution in the pores since the formation of bubbles in this way can mechanically damage the catalyst, causing crumbling or erosion of the catalyst particles. There are various other ways in which a cell may be damaged by a sudden current surge.

Various patents teach methods and procedures by which to instantly or progressively cut liquid-filled cells off from an electrical supply when its current surges too strongly. For example, US20140120388 teaches of a cut-off switch for a battery during recharging where the activation of the cut-off switch is linked to the pressure of any gas that may be produced. US20120181992 teaches of a cut-off switch that is linked to the voltage of a battery connected to an intermittent source of energy. US20110156633 teaches of a solar power system that modulates the voltage of the incoming, intermittent current, in order to avoid damage. Conventional alkaline electrolyzers must typically be operated at current densities of around 300 mA/cm² with surges in current or current density limited to no more than ca. 20-30% of that value.

By contrast, in particular examples the inventors have discovered that the example electrochemical cells as described herein, which operate most economically at low current densities, are unexpectedly able to be operated under conditions of remarkably large and sudden surges or variations in current, with no or little noticeable degradation in subsequent performance.

Experiments have shown that the example electrochemical cells as described herein can be operated under unexpected conditions or ranges to routinely handle current surges of at least 25-fold over their normal operating currents, for example delivered over several milliseconds. Moreover, testing has revealed that the electrochemical cells can handle surges of such scale repeatedly, without noticeable degradation in electrochemical performance, at intervals of a few seconds, applied continuously and without break, over periods exceeding six months. To the best of the inventors' knowledge, no other cell types and most especially no other liquid-containing cells, are capable of such performance.

The origin of this truly remarkable capability appears to lie in it being energetically more favourable for newly formed or dissolved gas within a liquid to join a large, pre-existing bubble than it is for the gas to form a new bubble. Moreover, the concentration of dissolved gas within a liquid electrolyte is also minimised and held below super-saturation levels, about a pre-formed bubble since the bubble provides an additional interface through which excess gaseous molecules may quickly and easily escape the liquid phase. Thus, it is, effectively, impossible for a liquid electrolyte to become supersaturated near to an existing bubble, since the bubble interface provides a ready and favourable route for the excess gas to escape the liquid phase.

Accordingly, if an “artificial bubble”, such as the gas side or region of a gas diffusion electrode is present near to the point of formation of a gas in a liquid-containing cell, then the newly formed gas is strongly favoured to join that “artificial bubble” rather than to form a new bubble or dissolve in a supersaturated way within the liquid. Moreover, if that “artificial bubble” has a substantial volume and a large gas-liquid interface, then it can accommodate and absorb even very large quantities of a gas that may be formed extremely suddenly in the liquid phase. In other words, the “artificial bubble”, represented by the gas side of a gas diffusion electrode, may act as a buffer that rapidly assimilates and removes even substantial quantities of gas formed very quickly within the liquid phase. In this way, the damage that may be caused by sudden, large-scale bubble formation may be eliminated in its entirety, or, at least, mitigated to a substantial extent.

Furthermore, because the “artificial bubble”, represented by the gas side of a gas diffusion electrode, lies outside of the electrical conduction pathway through the liquid electrolyte, the sudden formation of large quantities of gas need not affect in any substantial way, the electrical resistance of the liquid electrolyte. That is, not only is the potentially damaging effect of sudden bubble formation mitigated, but the electrical resistance and hence the electrical and energy efficiency of the cell, may also be substantially unaffected. In other words, the cell remains capable of operating with amplified energy efficiency relative to conventional cells, during sudden and large-scale surges in current.

These realisations provide for:
(1) A liquid- or gel-containing electrochemical cell that is capable of accommodating or receiving large and sudden increases and/or fluctuations in an applied current without experiencing substantive damage, the cell including:
   i. one or more void volumes positioned or located outside of, or substantially outside of, or partially outside of, or on the periphery of, or within but only providing a small cross-section of, the electrical conduction pathway through the liquid or gel electrolyte; and
   ii. current collectors and/or electrodes;
   where
   iii. the one or more void volumes are capable of accommodating the gases generated during large and sudden increases and/or fluctuations in an applied or supplied current; and
   iv. the current collectors and/or electrodes in the cell are capable of accommodating or receiving large and sudden increases and/or fluctuations in an applied or supplied current.
(2) A method for fabricating a liquid- or gel-containing cell that is capable of accommodating or receiving large and sudden increases and/or fluctuations in an applied or supplied current without experiencing substantive damage, the method involving
   i. positioning or locating one or more void volumes within, adjacent to or near to the liquid or gel electrolyte, but outside of, or substantially outside of, or partially outside of, or on the periphery of, or within but only providing a small cross-section of, the electrical conduction pathway through the liquid or gel electrolyte; and
   ii. locating current collectors and/or electrodes within the cell;
   where
   iii. the one or more void volumes are capable of accommodating the gases generated during such surges; and
   iv. the current collectors and/or electrodes in the cell are capable of accommodating the currents involved in such surges.

In an example embodiment, the one or more void volumes, as previously discussed herein, do not merely accept and accommodate migrating gas, but instead, or additionally, form a gaseous conduit that transports the migrated gas from/to another part of the cell, or into/out of the cell entirely, for example to a holding tank. For example, the void volume(s) may act to allow unwanted gases formed within the electrolyte of the cell to escape from the cell.

For example, the one or more void volumes can act to allow gases formed rapidly within the electrolyte of the electrochemical cell to escape from the cell into an external holding tank, or to be vented to the atmosphere. In example embodiments, the one or more void volumes can transport gas that is formed rapidly and suddenly, from the electrolyte present between the electrodes to another portion of the cell that lies outside of, or substantially outside of the conduction pathway of the cell, or to the outside of the cell.

In such embodiments, preferably but not exclusively, the total void volume, including the conduit and the holding tank, or the outside atmosphere, is large or very large relative to the gas volumes that may be created by rapid and sudden surges in the electrical current. That is, preferably, but not exclusively, the total void volume is such as to provide a capacity to readily absorb large quantities of gas or gases that may be formed rapidly and suddenly within the electrochemical cell.

In another aspect, there is provided a gas-liquid electrochemical cell capable of directly harnessing an intermittent, fluctuating or renewable energy source, such as a solar-powered or a wind-powered or an ocean wave/tidal-powered renewable energy source, without notable modulation or conditioning of the current (which can be direct current, e.g. from a solar panel, or alternating current, e.g. from a wind turbine). For example, instead of converting the electrical current output of a solar-generator or a wind-generator or an ocean wave/tidal-powered into alternating current of near-uniform intensity, the raw output of intermittent current produced by such a generator can be directly harnessed by an example electrochemical cell as described herein. This eliminates a number of energy losses, allowing for more efficient use of renewable energy sources, such as solar-generators, wind-generators and ocean wave/tidal generators.

High Electrical and/or Energy Efficiency Operation

The inventors have identified a new method and/or system for operating electrochemical cells, for example as described herein and in the Applicant's concurrent International Patent Applications entitled “Electrochemical cell and components thereof capable of operating at high current density” and “Electrochemical cell and components thereof capable of operating at high voltage”, filed on 14 Dec. 2016, which are incorporated herein by reference, at high electrical and energy efficiencies when facilitating an electrochemical reaction. In such applications, the electrochemical cells can act to minimise or, at least, noticeably decrease the intrinsic energy inefficiencies involved in electrochemical cells that facilitate liquid-gas reactions. For example, the energy sapping influence that bubbles may have in such cases, may be substantially mitigated.

In particular example embodiments, the inventors have further recognised that, for such electrochemical reactions, a catalyst can be developed that is capable of sustainably catalyzing the reaction at cell voltages below, at, about or near to the so-called “thermoneutral voltage”, which represents the maximum possible energy efficiency with which the cell can operate. In order to properly realise the potential energy efficiencies, it may be necessary to employ cells of the present embodiments, which provide a minimisation or, at least, a noticeable reduction in the intrinsic inefficiencies that may otherwise have been present. Preferably, the electrochemical reaction is an endothermic electrochemical reaction.

New methods of operation of the example electrochemical cells at or near ambient (e.g. room) temperature as described herein, are predicated on the fact that the cells may be operated economically-viably at low current densities. They may also be utilized to facilitate reactions which are endothermic in nature; that is, reactions which absorb heat. This is significant since, for reactions of that type, there may be many catalysts available that catalyze the reaction at cell voltages below the “thermoneutral” voltage at or near ambient (e.g. room) temperature but they can only do so at low current densities.

Thus, the inventors have understood that operating a suitable catalyst at operational voltages below, at, about or near to the thermoneutral voltage, at or near to ambient temperatures, where they produce only low current densities, within cells that operate viably at low current densities, offers a useful approach to the development of energy efficient liquid-gas electrochemical cells.

The inventors have further realised that at a fixed current density, the operational voltage of such a cell may decline with an increase in temperature. That is, higher current densities at, about or near to the thermoneutral voltage may be achieved for a suitable catalyst by increasing the temperature of the cell. Provided the cell is capable of withstanding the higher temperatures without damage or impairment, it is possible to operate cells at, about, or near to the thermoneutral voltage with higher current densities at higher temperatures.

Thus, the inventors have understood that operating a suitable catalyst at operational voltages below, at, about or near to the thermoneutral voltage at higher temperatures, where they produce higher current densities, within cells that capable of withstanding the higher temperatures without damage or impairment, offers a useful approach to the development of energy efficient liquid-gas electrochemical cells.

The inventors have, additionally, understood that another useful approach to thermal management in such cells, known as “thermal self-regulation”, involves allowing the operating temperature of the cell to vary in accordance with the thermal parameters and not be fixed. That is, a useful approach to thermal management involves allowing the cell to find its own optimum operating temperature in a process of “thermal self-regulation”. Optionally, this may be done with the cell wrapped in thermal insulation. This approach involves applying a particular current density as required (in the presence of suitable catalysts). If, at the temperature of the cell, the applied current density creates a higher voltage in the cell than the thermoneutral voltage, then the cell will progressively heat itself up. As the cell heats itself up, the cell voltage will typically decline. At the applied, fixed, current density, the cell will continue heating itself up until such time as the cell voltage has declined to be at, about, or near to the thermoneutral voltage (depending on the quality of the thermal insulation). At that point, the temperature of the cell will stabilize and cease increasing. During the entire process the cell would be operating at as close to 100% energy efficiency as the thermal insulation will allow. The reverse of the above will occur (causing a decrease in the operating temperature of the cell) if the current density that is applied causes the cell voltage to decline below the thermoneutral voltage.

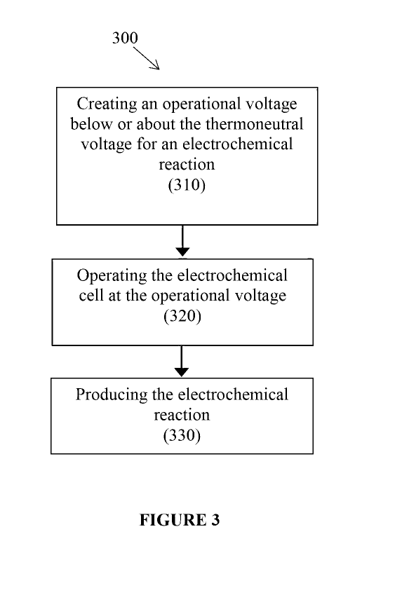

Referring to FIG. 3, there is illustrated a method 300 for management of an electrochemical cell comprising electrodes and an electrolyte between the electrodes. The method 300 comprising creating, at step 310, an operational voltage for the electrochemical cell that is at, below or about the thermoneutral voltage for an electrochemical reaction. The operational voltage may be applied indirectly, for example, by applying a particular current density that creates the operational voltage at an operational temperature. At step 320, the electrochemical cell is operated at the operational voltage and at the operating temperature to produce, at step 330, the electrochemical reaction. The electrochemical reaction is preferably an endothermic electrochemical reaction or otherwise a weakly exothermic electrochemical reaction. A catalyst is applied to at least one of the electrodes to facilitate the electrochemical reaction at the operational voltage.

Thus, there is provided a method for management of an electrochemical cell comprising electrodes and an electrolyte between the electrodes. The method includes creating, setting, selecting or applying an operational voltage for the electrochemical cell that is below or about the thermoneutral voltage. The operational voltage for the electrochemical cell can be created, set, selected or applied for an operating temperature of the electrochemical cell. A catalyst is preferably applied to at least one of, and optionally both, the electrodes to facilitate the electrochemical reaction at the operational voltage and at the operating temperature. In an example, the operational voltage can be created indirectly or applied indirectly, for example, by applying a particular current density that creates or consequently results in or applies the operational voltage to the electrochemical cell, which can be dependent on the operating temperature.

In particular example embodiments, the inventors have realised that example electrochemical cells as described herein can be operated at, below, or near to the thermoneutral potential in an economically-viable way, for example so as to avoid the need for extensive and energy-sapping electrical cooling systems. This realisation has important and far-reaching implications for the heat management and energy efficiency of such cells. With sufficiently powerful catalysts at sufficiently high temperature, example electrochemical cells of the type described in Applicant's concurrent International Patent Applications entitled “Electrochemical cell and components thereof capable of operating at high current density” and “Electrochemical cell and components thereof capable of operating at high voltage”, filed on 14 Dec. 2016, which are incorporated herein by reference, can be operated at, below, or near to the thermoneutral potential in an economically-viable way.

In particular example embodiments, the inventors have produced suitable example catalysts, which facilitate electrocatalytic water electrolysis. The catalyst(s) is applied to at least one of, or both of, the electrodes to facilitate the preferably endothermic electrochemical reaction at the operational voltage of the electrochemical cell. In preferred but non-limiting examples, the catalyst contains one or more of the following catalytic materials: (i) Precious metals, either free or supported, including but not limited to Pt black, Pt supported on carbon materials (e.g. Pt on carbon black), Pt/Pd on carbon materials (e.g. Pt/Pd on carbon black), IrO₂, and RuO₂; (ii) Nickel, including but not limited to: (a) nanoparticulate nickels, (b) sponge nickels (e.g. Raney nickel), and (c) nickel foams; (iii) Nickel alloys, including but not limited to, NiMo, NiFe, NiAl, NiCo, NiCoMo; (iv) Nickel oxides, oxyhydroxides, hydroxides, and combinations thereof, without limitation; (v) Spinels, including but not limited to NiCo₂O₄, Co₃O₄, and LiCo₂O₄; (vi) Perovskites, including but not limited to La_{0.8}Sr_{0.2}MnO₃, La_{0.6}Sr_{0.4}Co_{0.2}Fe_{0.8}O₃, and Ba_{0.5}Sr_{0.5}Co_{0.2}Fe_{0.8}O₃; (vii) Iron, as well as iron compounds, including but not limited to nanoparticulate iron powders and the like; (viii) Molybdenum compounds, including but not limited to MoS₂; (ix) Cobalt, as well as cobalt compounds, including but not limited to nanoparticulate cobalt powders and the like; and (x) Manganese, as well as manganese compounds, including but not limited to nanoparticulate manganese powders and the like.

In another example, the catalyst/s comprises one or more of the above catalytic materials mixed in with PTFE (e.g. in a 5% dispersion in alcohol from Sigma-Aldrich), creating a slurry. The slurry is preferably, but not exclusively, coated, for example knife-coated, onto the electrode(s) and conductor(s) in a layer or coating. In one particular example, after drying, the catalyst contains about 40% by weight PTFE, about 60% by weight of the catalytic materials.

The above percentages of component materials in the catalyst can be varied and the catalyst can remain functional. For example, suitable ranges for the catalyst, when dry, are:

about 30% to about 70% by weight of PTFE, and

about 30% to about 70% by weight of the catalytic materials.

In another example, suitable ranges for the catalyst, when dry, are:

about 5% to about 95% by weight of PTFE,

about 5% to about 95% by weight of the catalytic materials.

In another example, the catalyst's comprises one or more of the above catalytic materials mixed in with suitable carbon black (e.g. as supplied by Akzo-Nobel). These components are then further mixed with PTFE (e.g. in a 5% dispersion in alcohol from Sigma-Aldrich), creating a slurry. The slurry is preferably, but not exclusively, coated, for example knife-coated, onto the electrode(s) and conductor(s) in a layer or coating. In one particular example, after drying, the catalyst contains about 50% by weight PTFE, about 37.5% by weight of uncoated carbon black, and about 12.5% by weight of the catalytic materials.

The above percentages of component materials in the catalyst can be varied and the catalyst can remain functional. For example, suitable ranges for the catalyst, when dry, are:

about 30% to about 70% by weight of PTFE,

about 18% to about 58% by weight of uncoated carbon black, and

about 3% to about 23% by weight of the catalytic materials.

In another example, suitable ranges for the catalyst, when dry, are:

about 5% to about 90% by weight of PTFE,

about 5% to about 90% by weight of uncoated carbon black, and

about 5% to about 90% by weight of the catalytic materials.

In another example, there is no ion exchange membrane positioned between the electrodes. In another example, there is no diaphragm positioned between the electrodes. In another example, the electrolyte is a liquid electrolyte or a gel electrolyte. In another example, bubbles of the produced gas, or at least one gas, are not, or are substantially not produced or formed at either of the electrodes.

The thermoneutral voltage is defined as that cell voltage at which the heat generated by the catalyst and associated conductors is equal to the heat consumed by the reaction. The catalyst can be applied to at least one of the electrodes to facilitate an endothermic electrochemical reaction at an operational voltage. If an endothermic electrochemical reaction is carried out at the thermoneutral voltage, then the energy and electrical efficiency of the conversion of reactants into products is, by definition, 100%, since all of the energy that is put into the cell over a period of time is necessarily converted into energy within the products of the reaction. That is, the total electrical and heat energy input into the cell is matched with the total energy present in the products of the reaction with no excess input energy radiated to the surroundings. However, if the reaction is carried out above the thermoneutral voltage, then excess energy is generated, usually in the form of heat. If the reaction is carried out below the thermoneutral voltage, then energy, usually heat, needs to be added in order to avoid self-cooling by the system.

Conventional cells that can only operate economically above the thermoneutral voltage will necessarily develop excess heat which has to be removed by a suitable cooling system during operation. Cooling systems, such as chillers, are typically expensive and energy inefficient. Thus, not only does such a conventional cell operate at an operational voltage that creates and wastes excess heat, but further energy must then be expended to remove that excess heat. The resulting multiplier effect will typically have the effect of dramatically diminishing the overall energy efficiency of the cell during routine operation. For example, small-scale water electrolyzers that generate 0.5-10 kg/day of hydrogen during routine operation, typically consume 75-90 kWh per kilogram of hydrogen produced. However, one kilogram of hydrogen, in fact, only requires 39 kWh of energy to manufacture. The difference is largely due to the waste heat that is generated and the need for an energy inefficient chiller to remove the waste heat.

By contrast, an electrochemical cell that operates at, below, about or near to the thermoneutral potential does not create substantial excess heat that needs to be removed. If an electrochemical cell can be operated at, about or near the thermoneutral potential, then there may be so little excess heat generated that it is easily lost to the surroundings without any need for a formal or dedicated cooling system. Alternatively, the excess heat can be used to maintain a particular operating temperature that is higher than ambient temperature. If an electrochemical cell can be operated at the thermoneutral potential, there is no heat exchanged with the surroundings at all. If an electrochemical cell can be operated below the thermoneutral potential, then heat must be applied to the cell/system in order to maintain the cell/system temperature and prevent it from cooling.

However, in such an unexpected mode of operation, the inventors have realised that such required heat can be, relatively easily, efficiently and quickly, produced using electricity; for example, by resistive heating. Moreover, it becomes possible to apply only so much heat as is needed to maintain the cell operating temperature, thereby ensuring that the cell wastes no energy and operates at as close to 100% efficiency as is possible.

By these means, heat management of an electrochemical reaction in an electrochemical cell can become a drastically simpler and more efficient matter than is possible at present. In effect, the common and usually problematic phenomenon of heating in electrochemical cells can be turned into an advantage in cells that operate in an economically-viable way below the thermoneutral potential. That is, it may be utilized to ensure the cell is operating at the maximum possible efficiency. Such an option is not available to conventional cells that must operate at high current densities in order to be economically viable and/or that may be irretrievably damaged or impaired at high operating temperatures.

For example, water electrolysis is an endothermic process. Of the 39 kWh theoretically required to form 1 kg of hydrogen gas, 33 kWh must be supplied in the form of electrical energy and 6 kWh must be supplied in the form of heat energy.

Known catalysts only yield relatively low current densities at or below the thermoneutral potential at typical ambient temperatures. Accordingly, conventional water electrolyzers, which can only be operated in an economically-feasible way at high current densities cannot harness this effect with any sort of utility. They must necessarily operate at operational voltages well above the thermoneutral voltage, causing the formation of excess heat, which must then be removed at a further energy penalty.

Even in cases where the cell operates at somewhat above the thermoneutral voltage, the cell may be sufficiently close to the thermoneutral voltage that the excess heat generated, along with additionally applied electrical heat, is such as to warm the cell up to a more optimum operating temperature and maintain it there without need for a formal or dedicated cooling system.

Thus, the inventors have recognised that if such an electrochemical cell is designed so that the resistive heating produced by its electrical components were minimal or, more preferably, controllably low, then it becomes possible to use such resistive heating to apply only so much heat as is needed to maintain the electrochemical cell at its operating temperature. In this way, the need for active cooling may be eliminated, or, at least, diminished substantially. This is significant because the cost of electrical resistive heating is typically orders of magnitude less expensive than the cost of active cooling. That is, not only may it be possible to achieve higher overall energy efficiency in such an electrochemical cell, but this can also be accompanied by lower economic costs, which are always important in industrial applications.

In summary the inventors have discovered that combinations of the above elements makes it possible to ensure that an electrochemical gas-liquid cell for an endothermic reaction wastes the minimum of energy and operates as close to 100% efficiency as is reasonably possible, or, at least, closer to 100% efficiency than has hitherto proved viable. By these means, heat management of an endothermic electrochemical reaction in an electrochemical cell may become a simpler and more efficient matter than is possible at present. In effect, present embodiments provide means by which the common, phenomenon of electrically-induced heating in electrochemical cells is turned from an intractable, unwanted problem into a means of energy and cost saving. That is, electrically-induced heating may be utilized to ensure the electrochemical cell is operating at the maximum reasonable energy efficiency.

These teachings have potentially important and far-reaching implications for the heat management, energy efficiency, and capital cost of electrochemical liquid-gas cells. These options have not hitherto been available in conventional cells which only operate viably at high current densities. In particular, the new approaches teach that excess heat is a valuable resource that needs to be shepherded and conserved, not wasted.

The advantages of the present embodiments are particularly apparent in the case of water electrolysis, which is an endothermic process. Of the 39 kWh theoretically required to form 1 kg of hydrogen gas, 33 kWh must be supplied in the form of electrical energy and 6 kWh must be supplied in the form of heat energy. The inventors have, however, produced a cost-effective water electrolysis catalyst which facilitates a sustained electrochemical reaction at a mere 1.25 V at about 80° C. over many hours and more of testing. At this operational voltage, the catalyst generates only a relatively low current density of 10 mA/cm². At the thermoneutral voltage (1.47 V at 80° C.), this catalyst system generates a current density of ca. 48 mA/cm². Conventional water electrolyzers, which can only be operated viably at high current densities, cannot harness the effect created by this catalyst with any sort of utility. They must necessarily operate at operational voltages well above the thermoneutral voltage at 80° C., causing the formation of excess heat, which must then, additionally, be removed at a further energy penalty. By contrast, present electrochemical cells diminish the intrinsic inefficiencies and operate viably at low current densities and can employ the produced catalyst at 80° C. When further adapted so that the electrical circuitry generates controllably-low resistive heating, then the electrochemical cells can, additionally, be operated in a manner that avoids the need for energy-sapping electrical cooling systems. Even in cases where such cells operate at somewhat above the thermoneutral voltage, it may be sufficiently close to the thermoneutral voltage that the excess heat generated, along with additionally applied electrical heat, is such as to warm the electrochemical cell and maintain the electrochemical cells at its operating temperature without need for an active cooling system. For example, the present electrochemical cells may be fabricated so as to withstand higher temperatures (for example 150° C.), to thereby allow for operation at, about, or near to the thermoneutral voltage at much higher current densities. To the best of the inventors' knowledge, no existing or previously disclosed commercial water electrolyzer has ever avoided need for an active cooling system and relied only upon electrical heating for maintenance of its operating temperature.

Accordingly, in one aspect there is provided a heat management method or system for an electrochemical cell that facilitates an endothermic electrochemical reaction, the method or system involving:
i. Maintaining the cell at, about or near to the thermoneutral cell voltage for the reaction, and
ii. Maintaining the cell at, about or near to a suitable operating temperature, by:
iii. the application of electrical heating, including, without limitation, electrical resistive heating.

The electrochemical cell can be used as a water electrolyzer and the endothermic electrochemical reaction is water electrolysis. Preferably, but not exclusively, the cell utilizes a design and materials imparting it with the capability to minimise or, at least, diminish the intrinsic inefficiencies present and to operate viably at the current densities generated by the catalysts at, about or near the thermoneutral voltage of the endothermic electrochemical reaction. Preferably, but not exclusively, the cell utilizes one or more catalysts capable of facilitating the endothermic electrochemical reaction with at least a low current density and below, at, about or near the thermoneutral voltage of the endothermic electrochemical reaction.

In one example, there is a method for management of an electrochemical cell, the method comprising operating the electrochemical cell at an operational voltage that is below or about the thermoneutral voltage for an endothermic electrochemical reaction. In another example, there is provided an electrochemical cell comprising electrodes, an electrolyte between the electrodes, and a catalyst applied to at least one of the electrodes to facilitate an endothermic electrochemical reaction at an operational voltage of the electrochemical cell.

Preferably, the method for management of the electrochemical cell, comprising electrodes and an electrolyte between the electrodes, includes operating the electrochemical cell at an operational voltage that is below or about the thermoneutral voltage for an endothermic electrochemical reaction. At least one gas is produced from the endothermic electrochemical reaction. Also, a catalyst is applied to at least one of the electrodes to facilitate the endothermic electrochemical reaction at the operational voltage. Preferably, the electrochemical cell comprises electrodes, an electrolyte between the electrodes, and the catalyst applied to at least one of the electrodes to facilitate the endothermic electrochemical reaction at an operational voltage of the electrochemical cell. The operational voltage is below or about the thermoneutral voltage for the endothermic electrochemical reaction which produces at least one gas.

In one example, the operational voltage is below the thermoneutral voltage. In another example, the operational voltage is at or about the thermoneutral voltage. In another example, heat is applied to the endothermic electrochemical reaction from a heater or a heating element (e.g. an electrical resistive element that produces heat from a current), which may include the electrochemical cell or components thereof acting as a heater or heating element. In another example, heat is applied to the endothermic electrochemical reaction from electrical resistive heating.

In other examples, heat is applied to the endothermic electrochemical reaction, additionally or alternatively, by other heating means such as heat from another exothermic chemical reaction, heat from a liquid or fluid (which could be circulating past or through parts of the cell), heat from a gas, gases or air (which could be circulating past or through parts of the cell), and/or radiative heat directed or focused onto the cell.

In other examples, heat is applied to the endothermic electrochemical reaction, additionally or alternatively, from one or more of: electrical resistive heating, upstream or downstream waste heat, for example waste heat from operation of a Fisher-Tropsch reactor, non-related waste heat of a separate process, and/or ambient air, for example using a radiator.

The electrochemical cell can be a water electrolyzer and the endothermic electrochemical reaction in this case is water electrolysis. The catalyst in this case facilitates electrocatalytic water electrolysis. The catalyst can be applied to both of the electrodes. In one example, the catalyst facilitates water electrolysis at the operational voltage that is below the thermoneutral voltage for water electrolysis. In another example, the catalyst produces heat at an applied current density. In another example, the current density is varied to maintain the electrochemical cell at or about a constant operating temperature. In another example, the current density is supplied in a waveform.

In example embodiments, the low current density is preferably less than or equal to 50 mA/cm². In example embodiments, the low current density is preferably less than or equal to 40 mA/cm², less than or equal to 30 mA/cm², less than or equal to 25 mA/cm², less than or equal to 20 mA/cm², less than or equal to 18 mA/cm², less than or equal to 16 mA/cm², less than or equal to 14 mA/cm², less than or equal to 13 mA/cm², less than or equal to 10 mA/cm², or less than or equal to 5 mA/cm².

In example embodiments, the operating temperature of the electrochemical cell is preferably greater than or equal to 20° C. In example embodiments, the operating temperature of the electrochemical cell is preferably greater than or equal to 30° C., greater than or equal to 40° C., greater than or equal to 50° C., greater than or equal to 60 ° C., greater than or equal to 70° C., greater than or equal to 80° C., greater than or equal to 100° C., greater than or equal to 150° C., greater than or equal to 200° C., or greater than or equal to 400° C.

Preferably but not exclusively, the electrical heating is resistive heating, applied within the electrical components of the cell. Preferably but not exclusively, the resistive heating occurs at one or more electrical components within the electrochemical cell in contact with the electrolyte, so that the heating is utilized in the operation of the cell. Preferably but not exclusively, the resistive heating is generated and modulated by the inherent resistance of the components. In an alternative example, the resistive heating is generated and/or modulated by the application of a particular waveform in the input/output of the electrical current.

Optionally, the electrochemical cell can be thermally insulated from its surroundings by thermal insulation encasing the electrochemical cell, either partially or fully, that is encasing using one or more thermally insulating materials.

In another aspect, there is provided a heat management method or system for an electrochemical cell that facilitates an endothermic electrochemical reaction, the method or system:
i. Improving upon electrical efficiencies thus far achievable for the endothermic electrochemical reaction;
   ii. The method or system involving:
   1. Maintaining the cell at, about or near to the thermoneutral cell voltage for the reaction, and
   2. Maintaining the cell at, about or near to a suitable, operating temperature, by:
   3. The application of electrical heating, including, without limitation, electrical resistive heating.

In example embodiments, the electrical efficiency is defined as the ratio of the energy put into the cell relative to the energy incorporated in the products generated by the cell, over a particular period of time. In example embodiments, the electrical efficiency is preferably more than 70%. In other example embodiments, the electrical efficiency is preferably more than 75%, more than 80%, more than 85%, more than 87%, more than 90%, more than 93%, more than 95%, more than 97%, more than 99%, or more than 99.9%.

In another aspect, there is provided a heat management method or system for an electrochemical cell that facilitates an endothermic electrochemical reaction, the method or system involving:
i. The use of one or more catalysts capable of facilitating the reaction with at least low current densities at, about or near the thermoneutral voltage of the reaction at or about ambient operating temperatures;
ii. The method or system involving:
   1. Maintaining the cell at, about or near to the thermoneutral cell voltage for the reaction, and
   2. Maintaining the cell at, about or near to a suitable, operating temperature, by:
   3. The application of electrical heating, including, without limitation, electrical resistive heating.

Preferably, the catalysts are electrocatalysts that are applied to the anode and/or the cathode and that thereupon act to diminish the overpotential of the reaction.

In another aspect, there is provided a heat management method or system for an electrochemical cell that facilitates an endothermic electrochemical reaction, the method or system involving:
i. The use of one or more catalysts capable of facilitating the reaction with at least low current densities at, about or near the thermoneutral voltage of the reaction at or about ambient temperature, and
ii. The cell improving upon electrical efficiencies thus far achievable for the endothermic electrochemical reaction;
iii. The method or system involving:
   1. Maintaining the cell at, about or near to the thermoneutral cell voltage for the reaction, and
   2. Maintaining the cell at, about or near to a suitable operating temperature, by:
   3. The application of electrical heating, including, without limitation, electrical resistive heating.

In another aspect, there is provided a heat management method or system for an electrochemical cell that facilitates an endothermic electrochemical reaction, the method or system involving:
i. The use of one or more catalysts capable of facilitating the reaction with at least low current densities at, about or near the thermoneutral voltage of the reaction at or about ambient temperature, and
ii. The cell being capable of operating viably at low current densities and/or being capable of withstanding the operating temperature without damage or impairment;
iii. The method or system involving:
   1. Maintaining the cell at, about or near to the thermoneutral cell voltage for the reaction, and
   2. Maintaining the cell at, about or near to a suitable operating temperature, by:
   3. The application of electrical heating, including, without limitation, electrical resistive heating.

In another aspect, there is provided a heat management method or system for an electrochemical cell that facilitates an endothermic electrochemical reaction, the method or system involving:
i. The cell being thermally insulated from its surroundings by encasing it, either partially or fully, in thermal insulation;
ii. The method or system involving:
   1. Maintaining the cell at, about or near to the thermoneutral cell voltage for the reaction, and
   2. Maintaining the cell at, about or near to a suitable operating temperature, by:
   3. The application of electrical heating, including, without limitation, electrical resistive heating.

In another aspect, there is provided a heat management method or system for an electrochemical cell that facilitates an endothermic electrochemical reaction, the method or system involving:
i. The use of one or more catalysts capable of facilitating the reaction with at least low current densities at, about or near the thermoneutral voltage of the reaction at or about ambient temperature, and
ii. The cell being thermally insulated from its surroundings by encasing it, either partially or fully, in thermal insulation;
iii. The method or system involving:
   1. Maintaining the cell at, about or near to the thermoneutral cell voltage for the reaction, and
   2. Maintaining the cell at, about or near to a suitable temperature, by:
   3. The application of electrical heating, including, without limitation, electrical resistive heating.

In another aspect, there is provided a heat management method or system for an electrochemical cell that facilitates an endothermic electrochemical reaction, the method or system involving:
i. The use of one or more catalysts capable of facilitating the reaction with at least low current densities at, about or near the thermoneutral voltage of the reaction at or about ambient temperature, and
ii. The cell being capable of operating viably at low current densities and/or being capable of withstanding the operating temperature without damage or impairment, and
iii. The cell being thermally insulated from its surroundings by encasing it, either partially or fully, in thermal insulation;
iv. The method or system involving:
   1. Maintaining the cell at, about or near to the thermoneutral cell voltage for the reaction, and
   2. Maintaining the cell at, about or near to a suitable operating temperature, by:
   3. The application of electrical heating, including, without limitation, electrical resistive heating.

In another aspect, there is provided a heat management method or system for an electrochemical cell that facilitates an endothermic electrochemical reaction, the method or system involving:
i. The use of one or more catalysts capable of facilitating the reaction with at least low current densities at, about or near the thermoneutral voltage of the reaction at or about ambient temperature, and
ii. The cell being capable of operating viably at low current densities and/or being capable of withstanding the operating temperature without damage or impairment, and
iii. The cell improving upon electrical efficiencies thus far achievable for the endothermic electrochemical reaction, and
iv. The cell being thermally insulated from its surroundings by encasing it, either partially or fully, in thermal insulation;
iv. The method or system involving:
   1. Maintaining the cell at, about or near to the thermoneutral cell voltage for the reaction, and
   2. Maintaining the cell at, about or near to a suitable operating temperature, by:
   3. The application of electrical heating, including, without limitation, electrical resistive heating.

In another aspect, there is provided a heat management method or system for an electrochemical cell that facilitates water electrolysis, the method or system involving:
(1) Maintaining the cell at, about or near to the thermoneutral cell voltage for the reaction, and
(2) Maintaining the cell at, about or near to a suitable operating temperature, by the application of electrical heating, including, without limitation, electrical resistive heating;
(3) where, optionally:
   a) the cell improves upon the electrical efficiencies achievable;
   b) the cell contains catalysts capable of facilitating the reaction with at least low current densities at, about or near the thermoneutral voltage at or about ambient temperature; including, optionally the cell contains catalysts that include one or more of the following catalytic materials:
      (i) Precious metals, either free or supported, including but not limited to Pt black, Pt supported on carbon materials (e.g. Pt on carbon black), Pt/Pd on carbon materials (e.g. Pt/Pd on carbon black), IrO₂, and RuO₂;
      (ii) Nickel, including but not limited to: (a) nanoparticulate nickels, (b) sponge nickels (e.g. Raney nickel), and (c) nickel foams; (iii) Nickel alloys, including but not limited to, NiMo, NiFe, NiAl, NiCo, NiCoMo; (iv) Nickel oxides, oxyhydroxides, hydroxides, and combinations thereof, without limitation; (v) Spinels, including but not limited to NiCo₂O₄, Co₃O₄, and LiCo₂O₄; (vi) Perovskites, including but not limited to La_{0.8}Sr_{0.2}MnO₃, La_{0.6}Sr_{0.4}Co_{0.2}Fe_{0.8}O₃, and Ba_{0.5}Sr_{0.5}Co_{0.2}Fe_{0.8}O₃; (vii) Iron, as well as iron compounds, including but not limited to nanoparticulate iron powders and the like; (viii) Molybdenum compounds, including but not limited to MoS₂; (ix) Cobalt, as well as cobalt compounds, including but not limited to nanoparticulate cobalt powders and the like; and (x) Manganese, as well as manganese compounds, including but not limited to nanoparticulate manganese powders and the like.
   c) the cell is capable of operating viably at low current densities and/or is capable of withstanding the operating temperature without damage or impairment; and/or
   d) the cell is thermally insulated from its surroundings by encasing it, either partially or fully, in thermal insulation.

These realisations provide for:
A. heat management method or system for an electrochemical cell that facilitates an endothermic electrochemical reaction (such as water electrolysis), the method or system involving:
   1. Maintaining the cell at, about or near to the thermoneutral cell voltage for the reaction, and
   2. Maintaining the cell at, about or near to a suitable operating temperature, by the application of electrical heating, including, without limitation, electrical resistive heating;
   3. where, optionally:
      i. the cell improves upon the electrical efficiencies achievable;
      ii. the cell contains catalysts capable of facilitating the reaction with at least low current densities at, about or near the thermoneutral voltage at or about ambient temperature; the catalysts including, optionally one or more of the following catalytic materials:
         (i) Precious metals, either free or supported, including but not limited to Pt black, Pt supported on carbon materials (e.g. Pt on carbon black), Pt/Pd on carbon materials (e.g. Pt/Pd on carbon black), IrO₂, and RuO₂;
         (ii) Nickel, including but not limited to: (a) nanoparticulate nickels, (b) sponge nickels (e.g. Raney nickel), and (c) nickel foams; (iii) Nickel alloys, including but not limited to, NiMo, NiFe, NiAl, NiCo, NiCoMo; (iv) Nickel oxides, oxyhydroxides, hydroxides, and combinations thereof, without limitation; (v) Spinels, including but not limited to NiCo₂O₄, Co₃O₄, and LiCo₂O₄; (vi) Perovskites, including but not limited to La_{0.8}Sr_{0.2}MnO₃, La_{0.6}Sr_{0.4}Co_{0.2}Fe_{0.8}O₃, and Ba_{0.5}Sr_{0.5}Co_{0.2}Fe_{0.8}O₃; (vii) Iron, as well as iron compounds, including but not limited to nanoparticulate iron powders and the like; (viii) Molybdenum compounds, including but not limited to MoS₂; (ix) Cobalt, as well as cobalt compounds, including but not limited to nanoparticulate cobalt powders and the like; and (x) Manganese, as well as manganese compounds, including but not limited to nanoparticulate manganese powders and the like.
      iii. the cell is capable of operating viably at low current densities and/or is capable of withstanding the operating temperature without damage or impairment; and/or
      iv. the cell is thermally insulated from its surroundings by encasing the cell, either partially or fully, in a thermally insulating material(s).

### High Current Density Operation

In example embodiments, methods for facilitating the operation of cells at high current densities, are described in the Applicant's concurrent International Patent Application for “Electrochemical cell and components thereof capable of operating at high current density”, filed on 14 Dec. 2016, which is incorporated herein by reference.

In example embodiments, high current density is preferably greater than or equal to 50 mA/cm². In other example embodiments, high current density is preferably greater than or equal to 100 mA/cm², greater than or equal to 125 mA/cm², greater than or equal to 150 mA/cm², greater than or equal to 200 mA/cm², greater than or equal to 300 mA/cm², greater than or equal to 400 mA/cm², greater than or equal to 500 mA/cm², greater than or equal to 1000 mA/cm², greater than or equal to 2000 mA/cm², or greater than or equal to 3000 mA/cm².

In such high current density operation, after cell adaption to this purpose, the aforementioned cells may operate at substantially higher energy and electrical efficiencies than are available for comparable, conventional cells. That is, the advantages of example electrochemical cells as described herein, suitably adapted, may be most strongly amplified at high current densities relative to a comparable conventional cell. This discovery has important practical utility since many industrial electro-synthetic and electro-energy cells aim to operate at the highest reasonable current densities. Substantial energy and electrical savings may therefore be realised.

Moreover, for electrochemical reactions where high current densities and high energy efficiencies are necessary in order to achieve economic viability, this discovery can yield new industrial electro-synthetic and electro-energy processes that were hitherto unavailable or unviable.

Adaption of the example electrochemical cells as described herein, including, but not limited to cells of the types described in WO2013/185170, WO2015/013765, WO2015/013766, WO2015/013767, and WO2015/085369, may involve special designs for or modifications to the current collectors, busbars, electrical connections, power supplies/receivers, and other components. For example, selected components within the power supply of an electrosynthetic cell of the aforementioned types may be specially designed in order to handle the high current densities. In example embodiments, power supplies for facilitating the operation of cells of the above types, are described in the Applicant's concurrent United States Provisional Application for “DC power supply systems and methods”, filed on 14 Dec. 2016, which is incorporated herein by reference. Similarly, novel current collectors such as asymmetric conducting meshes may be used, if required, in order to effectively distribute current at high current densities. One particular adaption involves the use of series electrical connections as described in the Applicant's concurrent International Patent Application entitled “Electrochemical cell and components thereof capable of operating at high voltage”, filed on 14 Dec. 2016, which is incorporated herein by reference.

In one example aspect, there is provided a spiral-wound electrochemical cell, module or reactor capable of operating at high current density, having a core element, around which one or more electrodes (e.g. at least one electrode pair provided by an anode or a cathode) may be wound in a spiral fashion. The at least one electrode pair can form part of a multi-electrode array, which can be considered as being comprised of a series of flat flexible anodes and cathodes that can optionally be wound in a spiral fashion. A “leaf” is comprised of one or more electrodes, for example an electrode, a pair of electrodes, a plurality of electrodes, or some other form of electrode unit. A leaf may be flexible and can be repeated as a unit. Thus, in one example the electrode(s) is flexible, for example at least when being wound. After being wound, in some examples, the electrode(s) might be hardened using a hardening process.

For example, a leaf can include in part, or be formed by:

two electrodes, for example two cathodes or two anodes;

an electrode pair, for example an anode and cathode; or

a plurality of any of the above.

In another example, a leaf can include in part, or be formed by, two electrode material layers (with both layers together for use as an anode or a cathode) that are positioned on opposite sides of an electrode gas channel spacer (i.e. a spacer material, layer or sheet, which for example can be made of a porous polymeric material) which provides a gas or fluid channel between the two electrodes.

Repeated leafs provide a multi-electrode array being a series of flat-sheet or spiral-wound electrodes with intervening, electrically-insulating “flow-channel” spacers between electrodes of different polarity (e.g. between an anode and a cathode) providing separated liquid channels. The electrochemical cell, module or reactor may optionally also involve end caps, and one or more external elements.

In example embodiments there is provided a core element and end caps for a spiral-wound electrochemical cell capable of facilitating high current densities, the core element, end caps, and/or external elements comprising or containing an electrically conductive element, such as a (primary) busbar, provided as the end cap; and wherein, the conductive element is able to receive a conductive end from, or part of a conductive end from, or an electrode from, or a (secondary) busbar from an electrode, which may be a flexible electrode, where the electrode may be in a flat-sheet arrangement or may be spiral-wound about the core element. In another embodiment, the conductive element is able to provide a conductive lip to, or part of a conductive lip to, or an electrode to, or a (secondary) busbar to an electrode, which may be a flexible electrode, where the electrode is optionally able to be spiral-wound about the core element.

In example embodiments, the current collectors of all anode electrodes are placed so as to overhang their electrodes on one side of the assembly of electrodes, leafs or the like, while the current collectors of all the cathode electrodes are placed so as to overhang their electrodes on the opposite side to the anode electrodes. All of the overhanging anode electrodes are then combined into a single electrical connection, while all of the overhanging cathode electrodes are separately combined into a single electrical connection. If multiple leafs are connected by the approach, this method may result in a parallel electrical connection of the leafs.

In these example aspects there are provided methods for forming the electrical connections with the flexible electrode leaf so as to thereby appropriately bring together, group, or aggregate electrodes in the leaf into single electrical fittings capable of facilitating high current densities, for example, in a parallel electrical connection. These are preferably, but not exclusively, achieved by one of the means described below.

For example, one method involves interdigitating metallic wedges between spiral current collectors extending off one end of the spiral-wound cell and then bringing the interdigitated wedges into electrical contact via a primary busbar with an attached connecting bus (‘Wedge method’). In an alternative example, the current collector, interdigitated wedges and ring may be bolted together, in which case the method is known as the “Bolted Wedge Method”: Alternatively, the current collectors, wedges and ring may be welded together, in which case the method is known as the “Welded Wedge” Method. The wedges may be narrowly disposed in finger-like projections off of the central ring, in which case the method is known as the “narrow wedge method”. Alternatively, the wedges may be widely disposed, in which case the method is known as the “wide wedge method”.

Variations to the “Wedge Method”:
i. In these methods the overhanging current collectors from either the anode or cathode electrodes, leafs, or the like, are brought down into a collection of conductive powder (“Powder Method”) or small/microscopic spheres (“Sphere Method”), and a ring. Thereafter, the powder or spheres are placed in secure mechanical and electrical contact with the current collectors and the ring. For example, the powder or spheres may he welded to the current collectors and the ring, thereby creating a primary busbar as an end cap of the cell.
ii. “Solder method”: In this method the overhanging current collectors from either the anode or cathode electrodes, leafs, or the like, are brought down into a powdered solder encircling a conductive ring. Thereafter, the solder is placed in secure mechanical and electrical contact with the current collectors and the ring by heating the assembly.
iii. “Continuous Wedge Method”: In this variant, a wire, for example a square, rectangular, triangular or flat wire, of suitable thickness is wound around the ring. The wire replaces the discrete wedges used in the “Wedge Method”. In effect, the wire forms a continuous wedge. The overhanging current collectors are brought down over the continuous wedge such that the current collectors interdigitate the continuous wedge, which fills the space between the current collectors. Thereafter, the wire is placed in secure mechanical and electrical contact with the current collectors and the ring by, for example, welding the assembly.
iv. “Spiral Method”: In this approach a primary busbar is manufactured by forming a spiral ledge into a circular conductor located at, or itself being, an end cap. The overhanging current collectors on the anode or cathode are formed to match the spiral ledge such that when the cell is spirally-wound, the overhanging current collectors fall on the ledge and can be securely and continuously welded to the ledge during the winding process.

These realisations provide for:
(1) An electrochemical cell for an electrochemical reaction, comprising:
   a wound electrode; and,
   a busbar attached to a current collector of the electrode, where the current collector is spiral-wound, and
   wherein the busbar is of such size and such design as to provide for operation of the cell at high current density.
(2) A spiral-wound electrochemical cell for forming a chemical reaction product from an electrochemical reaction, the electrochemical cell comprising:
   an electrode spiral-wound about a central axis;
   an end cap; and,
   a busbar provided as part of the end cap;
   wherein the busbar is attached to a current collector of the electrode, and the current collector is spiral-wound, and
   wherein the busbar is of such size and such design as to provide for operation of the cell at high current density.

### High Voltage Operation

As described in the Applicant's concurrent International Patent Application entitled “Electrochemical cell and components thereof capable of operating at high voltage”, filed on 14 Dec. 2016 and incorporated herein by reference, example electrochemical cells are disclosed for operation at high voltages. One example adaption involves arraying example cells in electrical series.

In example embodiments, high voltage is preferably greater than or equal to 2 V. In other example embodiments, high voltage is preferably greater than or equal to 3 V, greater than or equal to 5 V, greater than or equal to 10 V, greater than or equal to 25 V, greater than or equal to 50 V, greater than or equal to 100 V, greater than or equal to 250 V, greater than or equal to 500 V, greater than or equal to 1000 V, or greater than or equal to 2000 V.

The series-connected cells are distinguished from spiral-wound and related, parallel-connected cells in that they allow for the use of substantially smaller and more readily connected primary busbars. Moreover, the cells allow for the use of a lower overall current but higher overall voltage than is generally utilized by related parallel-connected cells, including spiral-wound cells of the aforementioned type. This may be advantageous in that lower overall currents provide for lesser electrical resistance and therefore lesser (heat) losses, than higher overall currents. Moreover, power supplies which provide low overall current and high voltage are generally less expensive than power supplies which provide high overall current and low voltage. In example embodiments, power supplies for facilitating the operation of series-connected cells of these types, are described in the Applicant's concurrent United States Provisional Application entitled “DC power supply systems and methods”, filed on 14 Dec. 2016, which is incorporated herein by reference.

In other words, cells with series connections consume lower overall currents of higher overall voltage than cells with parallel connections that have the equivalent overall active electrochemical area and the same current density. In so doing, cells with series connections require smaller primary busbars than are necessary when large overall currents are required.

Other advantages of a series arrangement in a cell include:
(1) it is typically simpler and less complex to connected busbars to series-connected cells than to their equivalent parallel-connected counterparts,
(2) series-connected cells display an improved ability to handle large and sudden surges in current (since the system operates generally at lower overall currents), and
(3) series-connected cells better allow for the use of current collectors of higher intrinsic resistance, since the overall current affects the overall resistance, which is related to the efficiency of the cell. A lower current yields a lower overall resistance, even with current collectors having a higher intrinsic resistance, thereby avoiding substantial penalty to the efficiency of the cell.

The disadvantages of series-connected cells relative to parallel-connected cells include the presence of parasitic currents.

In an example embodiment there is provided a plurality of electrochemical cells for an electrochemical reaction. The plurality of electrochemical cells comprises a first electrochemical cell including a first cathode and a first anode, wherein at least one of the first cathode and the first anode is a gas diffusion electrode. The plurality of electrochemical cells also comprises a second electrochemical cell including a second cathode and a second anode, wherein at least one of the second cathode and the second anode is a gas diffusion electrode. Preferably, the first cathode is electrically connected in series to the second anode by an electron conduction pathway.

Preferably, chemical reduction occurs at the first cathode and the second cathode as part of the electrochemical reaction, and chemical oxidation occurs at the first anode and the second anode as part of the electrochemical reaction. In a particular example, the first cathode is a gas diffusion electrode. In another example, the first anode is a gas diffusion electrode. In another example, the second cathode is a gas diffusion electrode. In another example, the second anode is a gas diffusion electrode. In another example, an electrolyte is between the first cathode and the first anode. In another example, the electrolyte is also between the second cathode and the second anode.

Preferably, there is no diaphragm or ion exchange membrane positioned between the first cathode and the first anode. Also preferably, there is no diaphragm or ion exchange membrane positioned between the second cathode and the second anode. In another example, in operation there is no voltage difference between the first cathode and the second anode. In another example, in operation there is a voltage difference between the first cathode and the second cathode.

In example operation of the cell, a first gas is produced at the first cathode, and substantially no bubbles of the first gas are formed at the first cathode, or bubbles of the first gas are not formed at the first cathode. Also in example operation of the cell, a second gas is produced at the first anode, and substantially no bubbles of the second gas are formed at the first anode, or bubbles of the second gas are not formed at the first anode.

Advantageously in another example, in operation the first gas is produced at the second cathode, and substantially no bubbles of the first gas are formed at the second cathode, or bubbles of the first gas are not formed at the second cathode, and, the second gas is produced at the second anode, and substantially no bubbles of the second gas are formed at the second anode, or bubbles of the second gas are not formed at the second anode.

Preferably, the first cathode is gas permeable and liquid impermeable. In an example embodiment, the first cathode includes a first electrode at least partially provided by a gas-permeable and electrolyte-permeable conductive material, and, a first gas channel at least partially provided by a gas-permeable and electrolyte-impermeable material. In another example embodiment, the first gas can be transported in the first gas channel along the length of the first cathode. In another example embodiment, the second anode includes a second electrode at least partially provided by a gas-permeable and electrolyte-permeable conductive material, and, a second gas channel at least partially provided by a gas-permeable and electrolyte-impermeable material. The second gas can be transported in the second gas channel along the length of the second anode.

In an example, the first gas channel is positioned to be facing the second gas channel. In another example, the first gas channel and the second gas channel are positioned between the first electrode and the second electrode. The first cathode and the second anode can be planar. The second cathode and the first anode can also be planar. The first cathode can be flexible, and the second anode can also be flexible.

In example embodiments, there are also provided convenient and efficient configurations, arrangements, or designs for electrically connecting flexible leafs in series; i.e. a multi-electrode array, within a flat-sheet electrochemical cell, module or reactor, and where each flexible leaf comprises of a sealed gas channel or channels with its associated electrode or electrodes.

In one set of example embodiments, double-sided electrode leafs are used. The leafs comprise of two electrode material layers positioned on opposite sides of an electrode gas pocket, containing a gas channel spacer (i.e. a spacer material, layer or sheet, which, for example, can be made of a porous polymeric material) that provides a gas or fluid channel between the two electrodes. The resulting gas pocket within the leaf is typically equipped with a gas port. The current collectors on the top-side of the double-sided electrode leafs are placed so as to overhang their electrodes on one side of the leaf, while the current collectors on the bottom-side of the leafs are placed so as to overhang their electrodes on the opposite side of the leaf. When the resulting leafs are uniformly stacked into a flat-sheet, multi-leaf arrangement, separated by liquid-permeable ‘flow-channel’ spacers, then electrical connections are made by combining overhanging current collectors in pairs on either side of the stack. That is, the top electrode of one leaf is connected to the top electrode on the leaf above or below it, whilst the bottom electrodes of the two leafs are also separately connected to each other on the other side of the stack. This connection methodology is continued down the full length of the stack of leafs, so that all of the leafs in the stack are connected to another leaf in a pairwise arrangement. Multiple leafs connected by the approach result in a series electrical connection of the electrodes in the stack. When the volumes between the leafs are filled with a liquid or gel electrolyte, then the resulting cell is known as a “side-connected series cell”.

In further example embodiments, electrode leafs comprise of two separate, adjoining gas pockets, each having its associated porous electrode located on its outside (i.e. on the opposite side to the adjacent gas pocket). The resulting leaf, which may be flexible, then comprises of a layered arrangement having an electrode on its top, with one gas pocket below it, followed by a second, separate gas pocket below that, followed by a second electrode below it, on the bottom of the leaf. The gas pockets may each contain a gas-channel spacer within them to hold them up, and will typically each be equipped with a gas port. The two porous electrodes at the top and bottom of the leaf are then electrically connected to each other by, for example, metallic interconnections that pass through the two gas pockets, or that pass around the sides of the two gas pockets. The two gas pockets in each such leaf are sealed from each other, meaning that gas in one pocket is not able to pass into the adjoining pocket, and vice versa. Double-sided, double-gas pocketed leafs of this type are then stacked on top of each other with a liquid-permeable “flow-channel” spacer between them, to thereby create a multiple-leaf, series-connected “stack”. When the volumes between the leafs are filled with a liquid or gel electrolyte, then the resulting cell of this type is known as a “bipolar series cell”.

A key advantage that series-connected cells of this type have over comparable parallel-connected cells, such as the spiral-wound cells mentioned above, involves the way in which they are connected to their primary busbars.

The upper-most electrode of the upper-most leaf in each of the aforementioned stacks will typically be connected along its length to a primary busbar, which will typically take the form of a metallic bar that runs along one edge of the top of the stack. The lower-most electrode of the lower-most leaf will typically be separately connected along its length to a second primary busbar, which may take the form of a metallic bar that runs along one edge of the bottom of the stack. The two busbars will typically form the connection points (positive and negative poles) to which an external power supply will be connected. As noted above, because of the lower overall current and higher overall voltage of such a stack, each busbar will typically contain less metal and be smaller overall than a busbar in a comparable, parallel-connected stack of the same overall electrochemical active surface area at the same current density (such as a spiral-wound cell of the aforementioned type). Moreover, because the busbar are linear rods, they will typically also be simpler to connect to electrically using a means such as welding. There will typically not be a need to use complex techniques for busbar attachment, such as the aforementioned ‘Wedge Method’, ‘Bolted Wedge Method’, ‘Welded Wedge Method’, ‘Narrow or Wide Wedge Method’, ‘Powder Method’, ‘Sphere Method’, ‘Solder method’, ‘Continuous Wedge Method’, or ‘Spiral Method’.

In still further examples, series-connected leaf stacks may be wound into a spiral-wound cell. A “tricot” pack of porous flow-channel spacers may be constructed to accommodate a selected number of leafs, whose gas pocket/s are each equipped with a gas port, in a stack. The tricot pack and leafs are then wound about a central core element that has been adapted to connect the gas ports on each leaf to their relevant gas conduits within the core element. In the case where leafs comprising double-sided electrodes enclosing a single gas pocket are used, pairwise electrical connections of upper and lower electrodes on adjacent leafs are made on opposite sides of the leaf stack following the spiral winding, to thereby produce a “side-connected series cell” having a spiral-wound architecture. In the case where leafs comprising double-sided electrodes enclosing two adjacent gas pockets (with electrical interconnections between the upper and lower electrodes), the resulting assembly provides a “bipolar series cell” having a spiral-wound architecture.

These approaches provide for:
(1) An electrochemical cell for an electrochemical reaction, comprising:
   a stack of electrode leafs;
   separated from each other by intervening, electrically-insulating liquid-permeable spacers;
   wherein the individual leafs are connected to each other in a series electrical arrangement.
(2) An electrochemical cell for an electrochemical reaction, comprising:
   a stack of electrode leafs connected in electrical series; wherein:
   a primary busbar is electrically attached to the upper-most electrode in the upper-most leaf in the stack, and
   a separate primary busbar is electrically attached to the bottom-most electrode in the bottom-most leaf in the stack,
   wherein the busbar is of such size and such design as to provide for operation of the cell at high current density.

### FURTHER EXAMPLES

The following further examples provide a more detailed discussion of particular embodiments. The further examples are intended to be merely illustrative and not limiting to the scope of the present invention.

### Example 1

### Void Volumes and Their Placement

Preferably but not exclusively, a void volume(s) is provided by a porous structure that is not permeable to an electrolyte, e.g. a liquid electrolyte, but accommodates or allows passage of gas, that is the porous structure is liquid-impermeable and gas permeable. In the case of an aqueous liquid electrolyte, the void volume(s) is preferably but not exclusively provided by a porous hydrophobic structure, e.g. made of PTFE, such as a porous hydrophobic assembly, membrane or hollow fibre, or a collection of such structures, which remains unfilled with liquid electrolyte during the operation of the cell. In such cases, the void volume may be considered to be an “artificial bubble” or a “man-made bubble”. Preferably the “artificial bubble” or “man-made” bubble lies outside of the electrical conduction pathway of the cell, or occupies only a small cross-sectional area or footprint within the electrical conduction pathway.

In alternative preferred embodiments, a void volume can be provided by a natural bubble or bubbles that are statically or near-statically positioned outside of, or within a small cross-sectional area or footprint in the conduction pathway of the cell. For example, the static or near-static, natural bubble or bubbles may be contained, or mechanically trapped within an accommodating structure that is located outside of, or within a small cross-sectional area or footprint within the conduction pathway of the cell. In another example, the natural, static or near-static bubble or bubbles may simply be formed or located outside of, or within a small cross-sectional area or footprint in the conduction pathway of the cell.

In one embodiment, an electrochemical cell contains one or more void volumes that are so configured as to accept and accommodate migrating gas so as to thereby improve the efficiency of the cell.

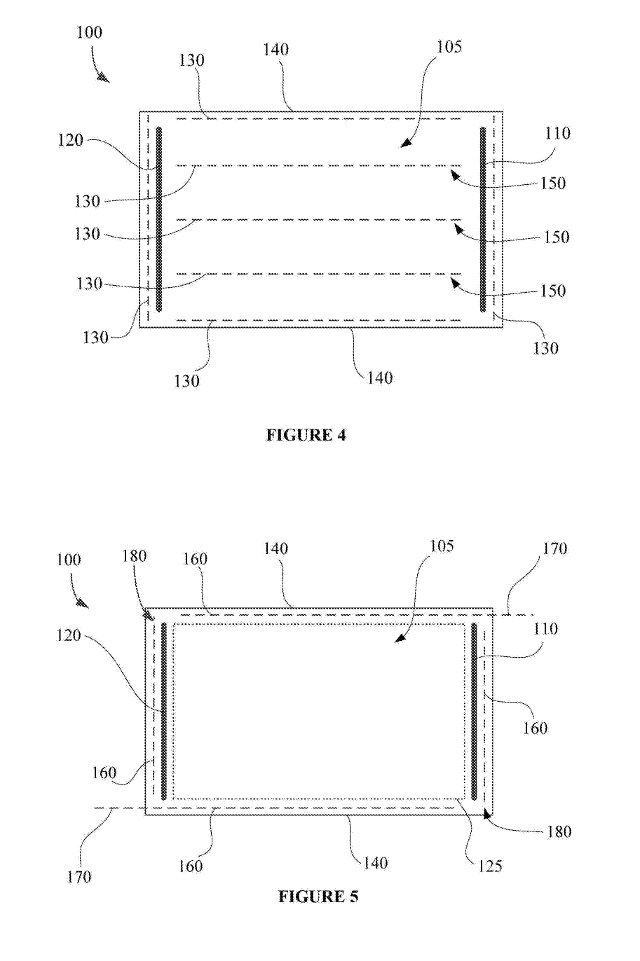

Referring to FIG. 4, for example, an electrochemical cell 100 with an aqueous liquid or gel electrolyte 105 between anode 110 and cathode 120 may include one or more sheets of membrane 130, for example short portions of a thin, highly hydrophobic sheet membrane, or hollow fibre membrane, that is isolated and not in gaseous contact or communication with the environment about membrane 130. Membrane 130 provides one or more void volumes. Isolated portions of a thin, highly hydrophobic sheet membrane, or hollow fibre membrane, can be placed so as to accept and accommodate gas that is slowly but inopportunely generated within the cell during operation. In addition to being isolated from the surroundings, the voids within the hydrophobic membranes may also be isolated from each other and, or they may be in gaseous contact with each other.

The membranes 130 can be located at or near position 140 provided by the edges or walls of the cell 100, that is, outside of, or at the periphery of, the electrical conduction pathway (e.g. conduction pathways are illustrated by area 125 in FIG. 5) which is between the electrodes, which are preferably gas-producing electrodes. Alternatively or additionally, the hydrophobic membranes 130 can be placed in, for example, a lengthwise location or position 150, which is parallel to or substantially parallel to, or along, the electrical conduction pathway, to thereby minimise the cross-sectional area or footprint of membranes 130 for reduced or minimal electrical resistance. Position or location 150 of membranes 130 can also be considered as perpendicular, or substantially perpendicular, to one or more of the gas-producing electrodes, i.e. perpendicular to anode 110 and/or perpendicular to cathode 120.

For example, suitable porous structures or membranes that provide the void volume(s) may accommodate gas that is slowly but inopportunely created within a battery during overcharging, including but not limited to a Ni metal hydride, lead acid, or lithium ion battery, where the uncontrolled formation of independent gas bubbles has the potential to damage the battery or degrade its performance. In such an application, the void volumes may, in effect, replace or partially replace the sacrificial materials that are routinely incorporated to suppress gas formation. The void volume(s) may further act as a “buffer tank” to hold amounts of gases that are formed prior to the reverse, recombination reaction that removes them during discharging.

In another example, the void volume(s) may accommodate gas formed during the operation of an electrophoretic or electroosmotic cell to thereby improve the operation of the cell. In further non-limiting examples, the void volume(s) may act to halt or minimise the incidence of bubble formation in electrochemical cells with solid-state or gel electrolytes. Preferably, there are substantially no bubbles of gas produced at the gas-producing electrodes.

In example forms, the one or more void volumes are: positioned within, partially within or adjacent to the electrolyte; and/or located at or adjacent to one or more of the gas-producing electrodes.

It is to be understood that, even in cases where a void volume(s) is in gaseous isolation from its environment within a liquid media, the void volume(s) can still be capable of accepting substantial quantities of gas. This may arise because a void volume(s) will necessarily and competitively accommodate migrating gas up to the point that the internal gas pressure within the void volume exceeds the so-called “bubble point” of the void volume. At that stage one or more bubbles will form in an uncontrolled manner at the interface between the void volume and the surrounding liquid media. Thus, the fact that a void volume(s) may be in gaseous isolation within a liquid or gel media does not prevent void volume(s) from accepting and accommodating even substantial quantities of gas.

In a second preferred embodiment, the membrane(s) providing void volume(s) does not merely accept and accommodate migrating gas, but additionally or instead forms a gaseous conduit that transports the migrated gas from/to another part of the cell, or into/out of the cell entirely. For example, the void volume(s) can act to allow unwanted gases formed within the electrolyte of the cell to escape from the cell.

Referring to FIG. 5, for example, membrane 160, providing one or more void volume(s), can transport gas from the electrolyte 105 present between the gas-producing electrodes 110, 120 to another portion 180 of the cell 100 that lies outside of, or substantially outside of the conduction pathway (e.g. conduction pathways are illustrated by area 125) of the cell 100, or to the outside 170 of the cell 100.

Thus, in examples there is provided an electrochemical cell 100 for producing a gas from an electrochemical reaction, comprising one or more void volumes 130, 160, gas-producing electrodes 110, 120, and an electrolyte 105 at least between gas-producing electrodes 110, 120. In operation an intermittent or fluctuating current is supplied to at least one of gas-producing electrodes 110, 120, and the gas is produced at one or both of gas-producing electrodes 110, 120 and is received by the one or more void volumes 130, 160.

For example, the membrane(s) 160 providing the void volume(s) can be placed so as to provide a pathway for gas that is slowly but inopportunely created within the electrolyte between the gas-producing electrodes. For example, in a battery during overcharging, including but not limited to a Ni metal hydride, lead acid, or lithium ion battery, where the uncontrolled formation of independent gas bubbles has the potential to damage the battery or degrade its performance. In such an application, the void volumes may, in effect, replace or partially replace the sacrificial materials that are routinely incorporated to suppress gas formation. The void volume(s) may transport the gas to a volume within the cell that acts as a “buffer tank” to hold amounts of gases that are formed prior to the reverse, recombination reaction that removes them during discharging.

In another example, the membrane(s) 160 providing the void volume(s) can transport gas from the electrolyte 105 between the gas-producing electrodes 110, 120 to another portion 180 of the cell 100 that lies outside of the electrical conduction pathway of the cell, or to the outside 170 of the cell. For example, during the operation of an electrophoretic or electroosmotic cell to thereby improve the operation of the cell. In further non-limiting examples, void volume(s) of this type may act to halt or minimise the incidence of bubble formation in electrochemical cells with solid-state or gel electrolytes.

In other examples, the void volume(s) can act to continuously remove dissolved gases within a liquid- or gel-electrolyte of an electrochemical cell between the gas-producing electrodes, to thereby improve the electrical conductivity and hence the electrical efficiency of the cell. That is, the void volume(s) can be used to continuously “de-gas” the electrolyte and vent dissolved gases to the air, so as to thereby improve the electrical conductivity of the electrolyte.

Thus, FIG. 4 and FIG. 5 provide example positions for one or more void volumes, e.g. a porous structure, a pre-existing bubble, gas region or gas pathway. In one example, the one or more void volumes, provided by example membranes 130, 160, can be positioned, at or near position 140, outside of the electrical conduction pathway between the gas-producing electrodes (i.e. anode 110 and cathode 120). Alternatively or additionally, the one or more void volumes, provided by example membranes 130, 160, can be positioned, at or near position 140, substantially outside of the electrical conduction pathway between the electrodes. Alternatively or additionally, the one or more void volumes, provided by example membranes 130, 160, can be positioned, at or near position 140 or outside position 170, partially outside of the electrical conduction pathway between electrodes. Alternatively or additionally, the one or more void volumes, provided by example membranes 130, 160, can be positioned, at or near position 140, peripheral to or adjacent to the electrical conduction pathway between electrodes. Alternatively or additionally, the one or more void volumes, provided by example membranes 130 can be positioned, at or near position 150, between the electrodes and within the electrical conduction pathway, but having a small cross-sectional area relative to the electrical conduction pathway between electrodes. Alternatively or additionally, the one or more void volumes, provided by example membranes 130 can be positioned, at or near position 150, between the electrodes and parallel to the electrical conduction pathway, so as to have a small cross-sectional area relative to the electrical conduction pathway between electrodes. Alternatively or additionally, the one or more void volumes, provided by example membranes 130 can be positioned, at or near position 150, between the electrodes and perpendicular to one or both of the electrodes, so as to have a small cross-sectional area relative to the electrical conduction pathway between electrodes. In further examples, the one or more void volumes, provided by example membranes 130, 160 can be positioned, at or near position 140 and/or position 150, to be within, partially within, adjacent to or near to a liquid electrolyte, or gel electrolyte of the cell. Alternatively or additionally, the one or more void volumes, provided by example membranes 130, 160, can be positioned, at, next to or adjacent to an electrode, and outside of the electrical conduction pathway between the electrodes, for example positioned substantially parallel to one or more of the electrodes and on the gas side of the one or more electrodes.

In other examples, the void volume(s) can act to competitively suppress dissolution of gas within an electrolyte, so as to thereby maximise the electrical conductivity of the electrolyte. In additional examples, the void volume(s) can act to carry a particular inert gas into the cell, so as to thereby saturate the electrolyte with a gas that is reactively inert and to thereby improve the overall efficiency of the cell.

Thus there is provided an electrochemical cell having an electrolyte between gas-producing electrodes of the electrochemical cell, wherein the electrolyte is a liquid-electrolyte or a gel-electrolyte. The electrochemical cell comprises one or more void volumes to receive a gas produced by the electrochemical cell, and wherein dissolution of the gas in the electrolyte is reduced or avoided by the one or more void volumes. Furthermore, bubbles of the gas are not produced at the gas-producing electrodes.

The one or more void volumes can be positioned within, partially within or adjacent to the electrolyte in example forms. In one example, the one or more void volumes facilitate migration of the gas to the one or more void volumes so that:
the Electrolyte Factor (EF) is increased/maximized;
the Power Density Factor (PF) is reduced/minimized; and the
Crossover (CO) is reduced/minimized.

In one example, the one or more void volumes transport gas from the electrolyte to another portion of the cell that lies outside of the conduction pathway of the cell. In another example, the one or more void volumes transport gas from the electrolyte to outside of the cell. In another example, the one or more void volumes transport an inert gas into the cell.

In another example, the one or more void volumes are provided by a porous structure that is permeable to the gas and impermeable to the electrolyte. In another example, the one or more void volumes are provided by a porous structure that is gas-permeable and liquid-impermeable. In another example, the one or more void volumes are provided by a porous hydrophobic structure which remains unfilled with electrolyte during operation of the cell.

In another example, the one or more void volumes are a pre-existing bubble, a gas region or a gas pathway. In another example, the one or more void volumes are provided by at least one natural bubble that is statically positioned by an accommodating structure.

In another example, the one or more void volumes are positioned outside of the electrical conduction pathway between the electrodes. In another example, the one or more void volumes are positioned partially outside of the electrical conduction pathway between the electrodes. In another example, the one or more void volumes are positioned peripheral to the electrical conduction pathway between the electrodes. In another example, the one or more void volumes are positioned between the electrodes and parallel to the electrical conduction pathway between the electrodes. In another example, the one or more void volumes are positioned between the electrodes and perpendicular to one or both of the electrodes.

In another example, the one or more void volumes are integrally formed as part of at least one electrode. In another example, the one or more void volumes are positioned at or adjacent to at least one electrode. In another example, the one or more void volumes at least partially form a gaseous side of a gas diffusion electrode.

In another example, at least one electrode of the electrochemical cell comprises a non-conductive gas permeable material that is substantially impermeable to the electrolyte and provided on a gas side of the at least one electrode, and a porous conductive material provided on an electrolyte side of the at least one electrode.

### Example 2

### Water Electrolysers and Unitized, Regenerative Fuel Cell-Electrolysers that are Not of the Preferred Embodiments. Their Operation Below the Thermoneutral Potential During Water Electrolysis

A Unitized, Regenerative (or Reversible) Fuel Cell (URFC) is an electrochemical cell with catalysts that are able to operate in two modes: (i) in fuel cell mode (which involves the production of electricity and heat, typically from hydrogen and oxygen), and (ii) in electrolyser mode (which involves the production of hydrogen and oxygen using electricity and heat). In the fuel cell mode, a H₂—O₂ URFC carries out the following reaction:

O₂+2H₂→2H₂O+electricity+heat E^{o}_{cell} 1.23 V (vs NHE) (1)

The positive sign for E_{cell} indicates that the forward reaction is thermodynamically favoured and occurs spontaneously, generating electricity and heat. In the reverse, electrolyser mode, a H₂—O₂ URFC facilitates the reaction:

H₂O+electricity+heat→O₂+2H₂ E^{o}_{cell} −1.23 V (vs NHE) (2)

The negative sign for E_{cell} indicates that the overall reaction is not thermodynamically favoured and must be driven by the application of an electrical current and heat.

In practice however, present-day commercial electrolysers (that are not of the preferred embodiments) do not require an external input of heat during operation. Instead, they generate net heat, often in large quantities, which must be removed with an active cooling system, namely, a “chiller” (as described in the scientific publication: J. O. Jensen, V. Bandur, N. J. Bjerrun, S. H. Jensen, S. Ebbesen, M. Mogensen, N. Trophoj, L. Yde, “Pre-Investigation of Water Electrolysis”, Publication PSO-F&U 2006-1-6287, RISO and the Danish Technical University, 2008).

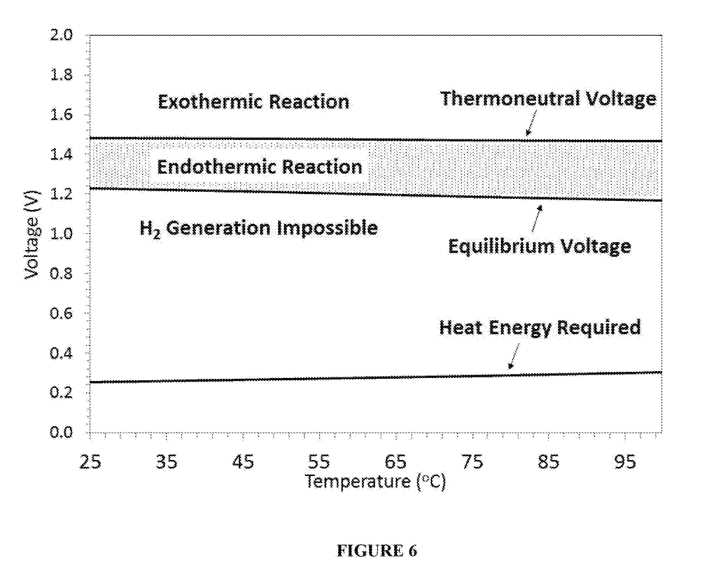

This arises because, at their operating temperature, present-day commercial electrolysers (that are not of the preferred embodiments) are invariably run well above the “thermoneutral” potential for water electrolysis (1.48 V), which is the voltage at which water electrolysis switches from being an overall endothermic to an exothermic reaction. As depicted in FIG. 6, water electrolysis is endothermic below 1.48 V, meaning that it produces insufficient heat and must extract heat from its surroundings, to thereby “run cold”. Above 1.48 V, water electrolysis is exothermic, meaning that it produces excess heat, causing the electrolyser to radiate heat to its surroundings and “run hot”. This occurs because hydrogen gas contains 33.3 kWh/kg of electrical energy and 6.1 kWh/kg of heat energy. The theoretical minimum potential needed to provide the 33.3 kWh/kg of electrical energy is the “equilibrium” voltage, which is 1.23 V at 25° C. A higher voltage—the thermoneutral voltage—is required to produce the additional 6.1 kWh/kg of heat energy. The former (33.3 kWh/kg) corresponds to the “Lower Heating Value” (or LHV) of hydrogen; the sum of the two (33.3+6.1=39.4 kWh/kg) corresponds to the “Higher Heating Value” (or HHV) of hydrogen.

While the above quantities are known, few catalysts, in fact, have the capacity to facilitate water electrolysis at or near to the thermoneutral voltage at room temperature, especially in alkaline systems.

It should be noted that catalytic materials for water-splitting are routinely compared to each other at low current densities (e.g. 10 mA/cm²) in order to minimize extraneous influences, such as electrical resistance in the driving circuits, ohmic resistance in the electrolyte, and mass transport effects.

In the following examples, example embodiment diaphragm-free alkaline electrolysers are described, employing expanded PTFE (ePTFE) membrane electrodes coated with various catalysts and catalyst combinations that operate below the thermoneutral potential during water electrolysis. The most active catalyst combination involved Pt on carbon black (HER catalytic material) and NiCo₂O₄ (OER catalytic material) that achieved 10 mA/cm² at 1.25 V in electrolyser mode after 2.5 h at 80° C. Replacement of a small amount of the NiCo₂O₄ with carbon black produced a unitized, regenerative hydrogen-oxygen fuel cell-electrolyser that, at 80° C. and 10 mA/cm², generated 0.87 V in fuel cell operation (74.4% energy efficiency, LHV) and consumed 1.27 V after 2 h operation in electrolyser mode (92.1% energy efficiency, LHV). The overall round-trip efficiency of the cell was 68.5%, assuming that heat generated during fuel cell operation was used to maintain the temperature of the cell during electrolyser operation.

### Example 3

### Efficient Operation of Example Embodiment Electrochemical Cells that Facilitate an Endothermic Electrochemical Reaction Using a Catalyst that Operates Below the Thermoneutral Voltage. Preferred Catalysts and Catalytic Materials

In a preferred embodiment, the void volume may be associated with an electrode. That is, the void volume may form the gaseous side of a gas diffusion electrode, where the gaseous side of the electrode lies outside of, or substantially outside of the conduction pathway of the cell between the electrodes, and where the gaseous side of the gas diffusion electrode facilitates the movement of gas into or out of the cell. The gas diffusion electrode may act to transport a gas generated rapidly and suddenly at the electrode out of the cell. Examples of such cells include an electrosynthetic or an electro-energy cell.

Example electrochemical cells as described herein, and including but not limited to cells of the types described in WO2013/185170, WO2015/013764, WO2015/013765, WO2015/013766, WO2015/013767, WO2015/085369, all of which are incorporated herein by reference, can be modified to operate at high current density as described in the Applicant's concurrent International Patent Application entitled “Electrochemical cell and components thereof capable of operating at high current density”, filed on 14 Dec. 2016, which is incorporated herein by reference.

In example embodiments, the electrochemical cell provides a means for facilitating endothermic electrochemical reactions in an energy efficient mariner.

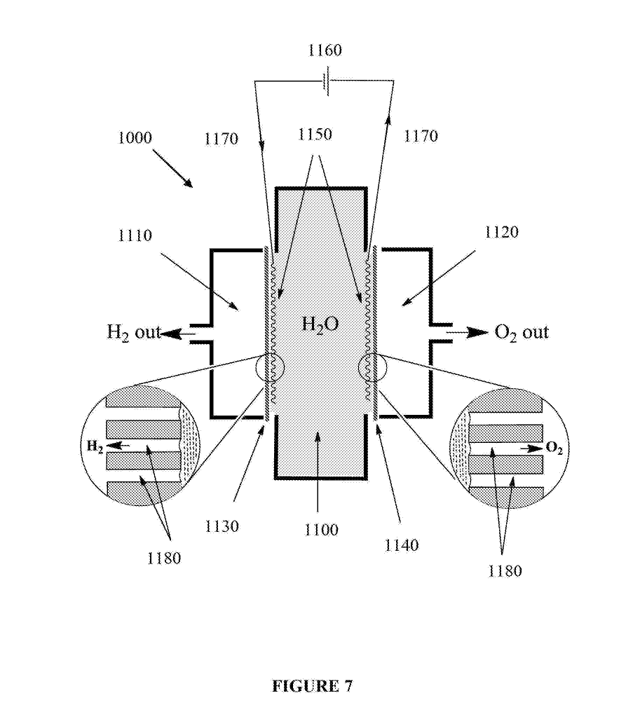

To illustrate operation of this type, consider FIG. 7, which schematically depicts an example embodiment for a water electrolyzer, containing two gas diffusion electrodes, being an anode and a cathode. The standard operating current for the electrolyzer is 10 mA (or expressed as a current density is 10 mA/cm²) and the standard operating temperature is 80° C. For illustrative purposes, the cell is an alkaline electrolyser, that is the cell facilitates electrochemical water-splitting, with half reactions as shown below, in alkaline solution, containing aqueous potassium hydroxide, aq. KOH, as electrolyte. (An acid or a neutral electrolyte could alternatively be used, with suitable catalysts).

Anode: 4OH⁻→O₂+2H₂O+4e⁻

Cathode: 2H₂O+2e⁻→H₂+2OH⁻ E_{cell}^{o} 1.23 V

The electrochemical cell 1000 in FIG. 7 comprises the following parts: a central water reservoir 1100 has a water-free hydrogen collection chamber 1110 on the left side and a water-free oxygen collection chamber 1120 on the right side. Between the water reservoir 1100 and the hydrogen collection chamber 1110 is a gas diffusion electrode 1130. Between the water reservoir 1100 and the oxygen collection chamber 1120 is a gas diffusion electrode 1140. On or close to the surface of the gas diffusion electrodes 1130 and 1140 is a conductive layer containing a suitable catalyst 1150 that has been applied to the anode and/or cathode. When an electrical direct current is applied to the conductive layers 1150 by the battery 1160, then electrons flow along the outer circuit 1170. The current causes water to be split into hydrogen at the gas diffusion electrode 1130 (the cathode) and oxygen at the gas diffusion electrode 1140 (the anode). Instead of forming bubbles at these surfaces, the oxygen and hydrogen passes through the hydrophobic pores 1180 of the gas diffusion electrodes into the oxygen and hydrogen gas collection chambers 1120 and 1110, respectively. Liquid water cannot pass through these pores since the hydrophobic surfaces of the pores of the gas diffusion electrode and the surface tension of the water prevents droplets of water from disengaging from the bulk of the water to thereby pass through the pores. Thus, the gas diffusion electrodes 1130 and 1140 act as a gas-permeable, water-impermeable barrier.

In a preferred example, the gas diffusion electrodes 1130 and 1140 had, as their substrates, polypropylene-backed Preveil™ expanded PTFE (ePTFE) membranes produced by General Electric Energy (average pore size of 0.2 μm, with bubble points in the range 1.0-1.2 bar and water entry pressures of >4 bar). Upon these substrates, conductive layers 1150, comprising catalysts and conductive Ni meshes, are deposited. The Ni meshes had 200 lines per inch and were supplied by the company eForming Inc.

In a preferred example, the hydrogen generating catalyst in 1150 at the cathode, comprises a mixture of nanoparticles of platinum deposited on nanoparticulate carbon black (10% Pt by weight) (e.g. as supplied by the company Premetek) mixed in with suitable carbon black (e.g. as supplied by Akzo-Nobel). The two components are then further mixed with PTFE (as supplied in a 5% dispersion in alcohol from Sigma-Aldrich), creating a slurry. The slurry is preferably, but not exclusively, coated, for example knife-coated, onto the electrode and conductor in a layer that, after drying, contains about 50% by weight PTFE, about 37.5% by weight of uncoated carbon black, and about 12.5% by weight of Pt-coated carbon black. The coverage by weight of platinum may be around 0.72 g Pt/m².

In a preferred example, the oxygen-generating catalyst in 1140 (at the anode) comprises nanoparticles of NiCo₂O₄ (e.g. as supplied by the company American Elements). The NiCo₂O₄ powder is then further mixed with PTFE (as supplied in a 5% dispersion in alcohol from Sigma-Aldrich), creating a slurry. The slurry is preferably, but not exclusively, coated, for example knife-coated, onto the electrode and conductor in a layer that, after drying, contains about 50% by weight PTFE. The coverage by weight of NiCo₂O₄ may be around 427 g NiCo₂O₄/m².

In an alternative preferred example, the oxygen-generating catalyst in 1140 (at the anode) comprises nanoparticles of NiCo₂O₄ (e.g. as supplied by the company American Elements) mixed in with suitable carbon black (e.g. as supplied by Akzo-Nobel). The NiCo₂O₄/carbon black powder is then further mixed with PTFE (as supplied in a 5% dispersion in alcohol from Sigma-Aldrich), creating a slurry. The slurry is preferably, but not exclusively, coated, for example knife-coated, onto the electrode and conductor in a layer that, after drying, contains about 50% by weight PTFE. The coverage by weight may be around 328 g NiCo₂O₄/m² and around 57 g carbon black/m².

In a further alternative preferred example, the oxygen-generating catalyst in 1140 (at the anode) was the same as the preferred hydrogen-generating catalyst described above. That is, it comprises a mixture of nanoparticles of platinum deposited on nanoparticulate carbon black (10% Pt by weight) (e.g. as supplied by the company Premetek) mixed in with suitable carbon black (e.g. as supplied by Akzo-Nobel). The two components are then further mixed with PTFE (as supplied in a 5% dispersion in alcohol from Sigma-Aldrich), creating a slurry. The slurry is preferably, but not exclusively, coated, for example knife-coated, onto the electrode and conductor in a layer that, after drying, contains about 50% by weight PTFE, about 37.5% by weight of uncoated carbon black, and about 12.5% by weight of Pt-coated carbon black. The coverage by weight of platinum may be around 0.72 g Pt/m².

The cell in FIG. 7 containing the above anode and cathode catalysts, was filled with 6 M KOH, maintained at 80° C., with an inter-electrode distance (ID) of 3 mm, and current density (CD) of 10 mA/cm² applied to the cell. These conditions equated to near-optimum conditions for the operation of a bubble-free, or substantially bubble-free water electrolysis cell, without an inter-electrode diaphragm, utilizing gas diffusion electrodes, as described in the Applicant's concurrent International Patent Application for “Methods of improving the efficiency of gas-liquid electrochemical cells”, filed on 14 Dec. 2016, which is incorporated herein by reference. That is,
i. the Electrolyte Factor (EF; in units of: Ls/Ωcm³ mol) was increased or maximised as much as reasonable; and
ii. the Power Density Factor (PF; in units of: mA²Ω/cm²) and the Crossover (CO; %), were reduced or minimized as much as reasonable, so that:
iii. the gas formed at the electrodes was:
   a) strongly induced to join the existing gas region of the gas diffusion electrodes by passing across the gas-liquid interface of the gas diffusion electrodes into their existing gaseous phase or region;
   b) Strongly dissuaded from: (I) dissolving in the liquid electrolyte and migrating away; or (II) forming a new, independent bubble.

The voltage of the electrochemical cell under these conditions was continuously measured.

When cells having one of the above combinations of catalysts were operated at 10 mA/cm² without any temperature control, starting at room temperature, the cell voltage went up from >1.40 V at the start of the experiment to >1.6 V after 1 hour. In that time, the cell became distinctly cold to the touch.

As the cell was clearly “self-cooling” and drawing heat from the environment (as expected for an endothermic reaction), the experiment was repeated with the cell immersed in a temperature-controlled water bath, set to maintain a temperature of 80° C.

Cells with Catalysts: Pt/Carbon Black (Cathode)—NiCo₂O₄ with and without Carbon Black (Anode)

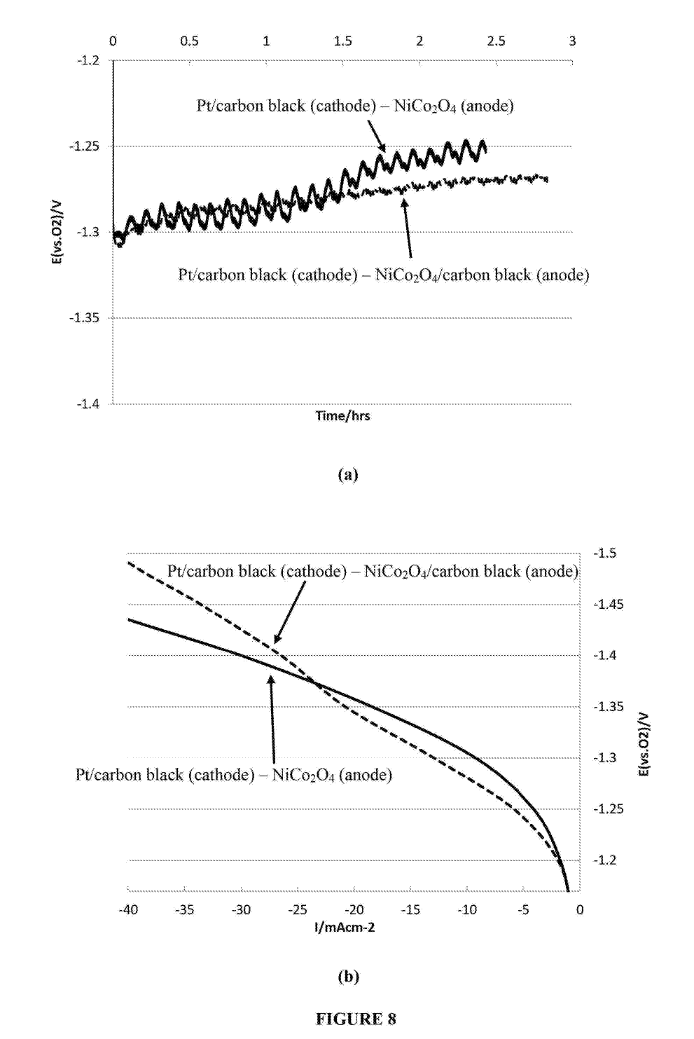

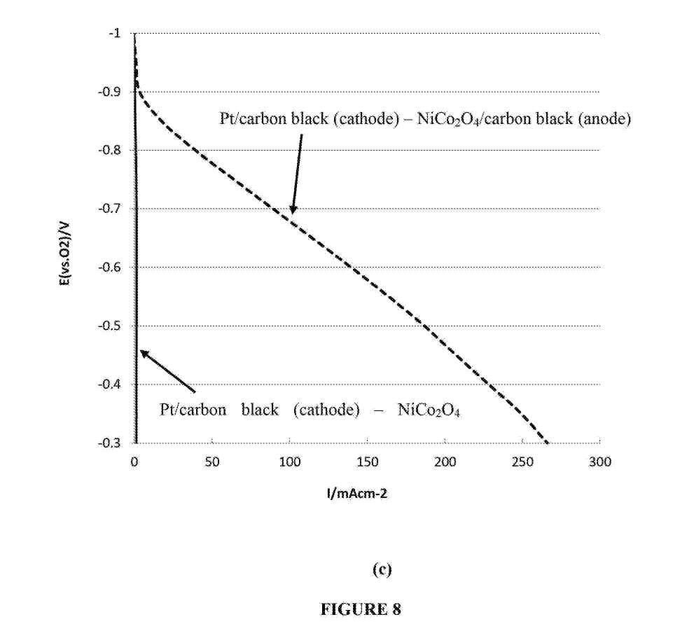

FIG. 8(a) depicts the voltage profile at 10 mA/cm² during the experiment for the cell with the following catalysts: (i) Pt/carbon black (cathode) and NiCo₂O₄ (anode), and (ii) Pt/carbon black (cathode) and NiCo₂O₄/carbon black (anode). To better demonstrate the effects at play, for the former case, the water bath was not thermally insulated or stirred so as to ensure quick equilibration of the temperature.

As can be seen in FIG. 8(a), for both of the above systems at 10 mA/cm², the electrochemical cell voltage initially commenced at ca. 1.3 V (which would be consistent with the decline in the cell voltage for water electrolysis to ca. 1.17 V at 80° C.). The voltage then declined to the 1.245-1.275 V region over 2.5 h of operation. The Pt/carbon black (cathode)—NiCo₂O₄ (anode) cell achieves an average of ca. 1.25 V after 2.5 h, while the Pt/carbon black (cathode) and NiCo₂O₄/carbon black (anode) cell achieves an average of ca. 1.27 V after 2.5 h. At the thermoneutral voltage of 1.47 V (at 80° C.), the cell generated ca. 48 mA/cm².

A notable feature of the plots in FIG. 8(a) is the fact that they regularly oscillate up and down. These fluctuations reflect the interplay between the electrochemical cell, which is cooling itself strongly, and the temperature controller, which switches on whenever the temperature falls below 80° C. The bottom of each cycle corresponds to the point at which the cell has cooled itself sufficiently for the heater-controller to have switched itself on. The top of each cycle corresponds to the point at which the heater-controller has heated the cell sufficiently and then switches itself off. The fluctuations were more extreme in the case of the Pt/carbon black (cathode)—NiCo₂O₄ (anode) because the bath water was not thermally insulated or stirred during operation, resulting in more aggressive heating and cooling actions.

FIG. 8(b) depicts the linear sweep voltammograms of the two cells at 80° C. after 2.5 h of operating at 10 mA/cm² at 80° C. As can be seen, the curves are almost identical, except for an inflection to lower relative activity at ca. 1.37 V by the Pt/carbon black (cathode)—NiCo₂O₄/carbon black (anode) cell. A similar inflection to lower relative activity by the Pt/carbon black (cathode)—NiCo₂O₄/carbon black (anode) cell occurred at the 1.25 h mark in FIG. 8(a). These inflections are likely due to corrosion of the carbon in the anode carbon black of the Pt/carbon black (cathode)—NiCo₂O₄/carbon black (anode) cell. Carbon corrosion of this type would normally be expected to degrade cell performance, which is seen above ca. 1.37 V in FIG. 8(b) and after ca. 1.25 h in FIG. 8(a). The data in FIGS. 8(a)-(b) therefore suggest that such carbon corrosion is not significant at a cell voltage below 1.37 V, for, at least the first 1.25 hours of operation.

FIG. 8(c) depicts the performance of the two systems as fuel cells. As can be seen, the Pt/carbon black (cathode)—NiCo₂O₄/carbon black (anode) cell displayed a linear sweep voltammogram that was highly characteristic of fuel cell behaviour, with 10 mA/cm² being generated at ca. 0.87 V. By contrast, the Pt/carbon black (cathode)—NiCo₂O₄ (anode) cell displayed no fuel cell activity whatsoever.

Thus, the cell with Pt on carbon black (HER catalytic material) and NiCo₂O₄ (OER catalytic material) achieved 10 mA/cm² at 1.25 V after 2.5 h as an electrolyser at 80° C. This equates to an efficiency relative to the higher heating value (HHV) of hydrogen of 118%.

The cell with Pt on carbon black (HER catalytic material) and NiCo₂O₄/carbon black (OER catalytic material) acted as a unitized, regenerative hydrogen-oxygen fuel cell-electrolyser at 80° C. In fuel cell mode it generated 10 mA/cm² at 0.87 V, which equates to 74.4% energy efficiency relative to the lower heating value, LHV, of hydrogen. In electrolyser mode it consumed 10 mA/cm² at 1.27 V after 2.5 h operation, which equates to an efficiency relative to the lower heating value, LHV, of hydrogen of 92.1% (or 116.5% efficiency relative to the higher heating value, HHV). The overall round-trip efficiency of the cell was 68.5%, assuming that heat generated during fuel cell operation was used to maintain the temperature of the cell during electrolyser operation.

### Example Distinguishing Features of the Cells:

To the best of the Applicant's knowledge, the above cells constitute, by some margin, the most efficient water electrolyser and unitized regenerative fuel cell—electrolyser ever developed.

As described in the Applicant's concurrent International Patent Application for “Methods of improving the efficiency of gas-liquid electrochemical cells”, filed on 14 Dec. 2016, which is incorporated herein by reference, cells of the present embodiments also produce extraordinarily pure gases directly off-the-stack at 10 mA/cm² (typically >99.9% pure hydrogen and >99.1% pure oxygen) despite the absence of any sort of diaphragm or ion-exchange membrane between the electrodes. The best alternative cells at present, namely PEM electrolyzers, are projected to generate substantially less pure gases off-the-stack at 10 mA/cm² (<99.5% pure hydrogen and <98.0% pure oxygen).

The unprecedented energy efficiency of the above cells can, accordingly, be ascribed to the combined effects of:
(i) avoiding the energy penalty of the bubble overpotential at each of the anode and the cathode during electrolysis due to the absence, or substantial absence of gas bubbles at these electrodes,
(ii) the optimized nature of the operation under bubble-free or substantially bubble-free conditions without an inter-electrode diaphragm present, including the exceedingly high ionic conductivity of the 6 M KOH electrolyte at 80° C. (i.e. the effect of a high ‘Electrolyte Factor’ EF, low ‘Power Density Factor’ PF, and low ‘Crossover’ CO), and
(iii) the intrinsic efficiency of the catalytic materials.
   Cells with Catalysts: Pt/Carbon Black (Cathode)—Pt/Carbon Black (Anode)

Given that carbon corrosion on the anode does not appear to be significant at cell voltages below 1.37 V, the performance of a cell having Pt on carbon black at both the anode and the cathode was also tested. That is, the cathode catalyst formulation described above, was used also on the anode in a symmetrical cell setup.

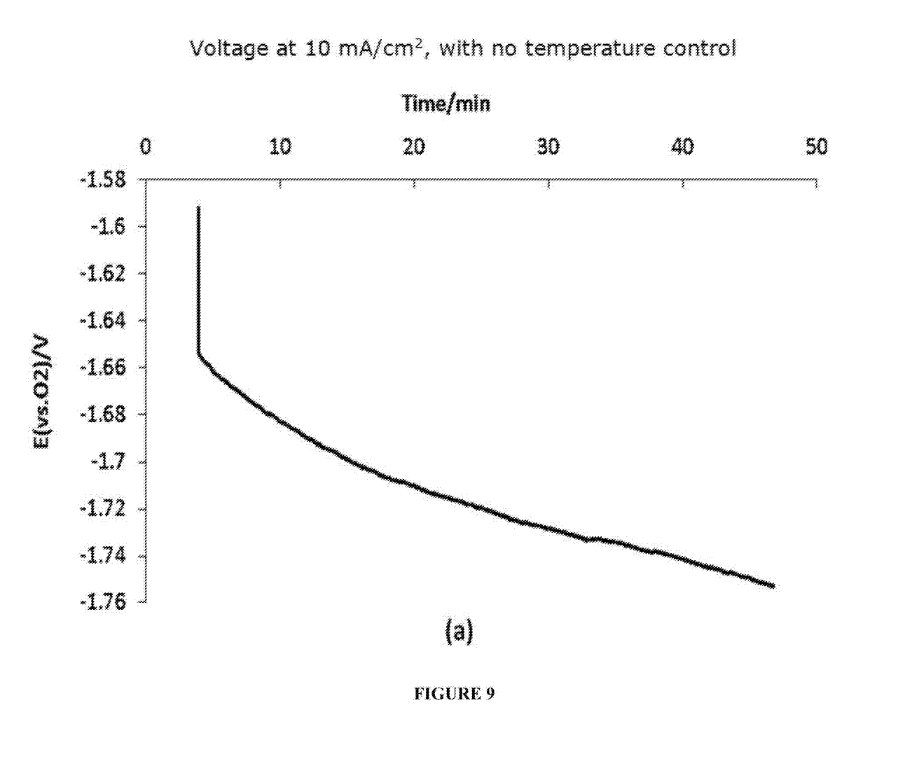

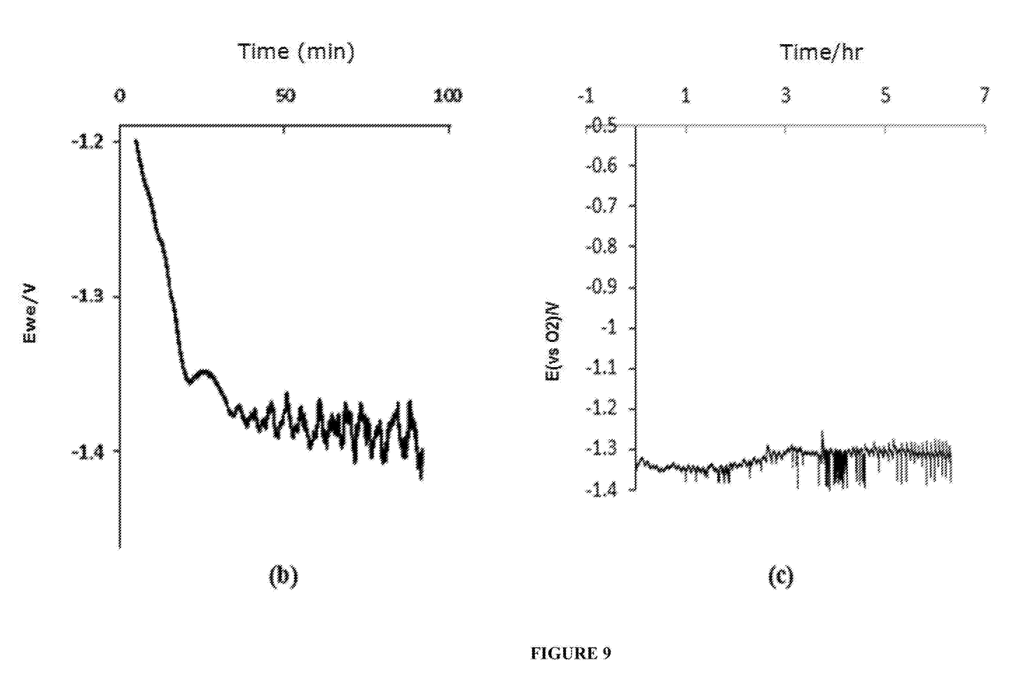

When operated without any temperature control, starting at room temperature, the cell voltage went from <1.6 V at the start of the experiment to ca. 1.75 V after 1 hour. During that time, the voltage displayed a continuous increase, consistent with active degradation of the anode catalyst due to corrosion of its carbon black. Clearly at these voltages the cell does not produce a steady and reliable performance. FIG. 9(a) depicts the voltage profile of the cell during the experiment.

At a constant temperature of 80° C. however, without thermal insulation or stirring of the temperature-controlled water bath (FIG. 9(b)), the cell voltage went to 1.35-1.40 V region with aggressive cooling of the temperature-controlled water bath in which it was immersed. At around 1.35 V, the temperature controller of the water bath turned the heating on in an attempt to arrest the temperature decline. The effect of the externally applied heating was to move the measured voltage lower. However, as soon as the external heating was turned off, the temperature decline created by the cell again commenced, causing the heater controller to repeatedly switch on, and, increasingly aggressively, attempt to stabilise the temperature of the water. The increasingly extreme fluctuations seen in the period of 25-100 minutes in FIG. 9(b) reflect the interplay between the (cooling) electrochemical cell and the (heating) temperature controller.

To obtain more steady data, the above experiment was then repeated at 80° C. in the same water bath, but this time the bath was stirred vigorously to ensure rapid temperature equilibration and also thermally insulated the bath by wrapping it in a layer of cotton wool. The voltage trace from this experiment is depicted in FIG. 9(c). As can be seen, a more steady trace at ca. 1.3 V was obtained for the first 3 hours; thereafter, for up to 7 hours, the voltage was steady at 1.32-1.33 V. The heater controller supplied heat almost continuously during the entire period.

### Other Example Distinguishing Features of the Above Cells:

The above examples demonstrate several unique features beyond those already discussed. Firstly, the examples demonstrate that the catalysts 1150 described above, when applied to at least one electrode, facilitated the water electrolysis reaction under the standard operating conditions of 10 mA/cm² current density and a temperature of 80° C., at an operational voltage of at least 1.35 V, which was well below the thermoneutral voltage of the reaction (1.47 V at 80° C.). As a result, the electrochemical cell absorbed heat from its surroundings and became cold. To maintain its temperature, resistive heating needed to be applied by the heater controller. Thus, heat was applied to the endothermic electrochemical reaction from a heater or a heating element. The heating element could he the cell itself or part of the cell (for example, when the cell was operated at ca. 48 mA/cm², its operating voltage was the thermoneutral voltage indicating that the cell itself maintained the operating temperature). To the best of the Applicant's knowledge, this is the first example of a catalyst, or more specifically an electrocatalyst, that has been shown to sustainably catalyse water electrolysis over many hours, for example more than one hour, more than 2 hours, more than 4 hours, or more than 6 hours, with a useful current density at an operational voltage below the thermoneutral voltage for the reaction. That is, the catalyst catalyses water electrolysis at an operational voltage below the thermoneutral voltage for water electrolysis. The catalyst absorbs heat at the applied current density.

Secondly, it should be noted that the heater controller (or the cell as a heater itself) applied only as much heat as was needed to maintain the operating temperature of the cell. The heater controller can control the amount of heat applied to the endothermic electrochemical reaction from a heater or a heating element, which could include the electrochemical cell or one or more components of the cell acting as a heater or heating element. To manage this efficiently, thermal insulation, for example thermally insulating cotton wool, was placed or wrapped around the cell. If the thermal insulation had blocked all net exchange of heat from the cell to the surroundings (i.e. if it had blocked all radiation of heat by the cell), then the cell would have operated at, effectively, 100% energy efficiency. In reality, some heat loss occurred through the thermal insulation and the overall energy efficiency of the cell was decreased by this lost heat. In other words, the less heat that was radiated out of the thermally insulating cotton wool that was wrapped around the cell, the closer the cell would have been to 100% energy efficiency. That is, the overall energy efficiency of the electrochemical cell is determined in part by the efficiency of its thermal insulation.

A third notable feature is that there was no active cooling (e.g. by a cooling system) needed for the cell, that is no cooling system is required. Thermal management occurred by active, electrically-induced resistive heating and not by active cooling. This stands in contrast to the usual situation for water electrolyzers. In conventional water electrolyzers not of the preferred type, electrically-induced resistive heating is undesirable and unwanted since the additional heat has to be removed and this has an energy penalty attached to it. In the present case however, electrically-induced resistive heating was desirable and, in fact, needed to maintain the electrochemical performance of the cell.

Fourthly, incidental cooling of the system, by radiation through the thermal insulation, for example thermally insulating cotton wool wrapping, was, in this example, unwanted because it led to instability in performance and a decline in overall energy efficiency of the cell. It was, indeed, for this reason that the cell had to be wrapped in a layer of thermally insulating cotton wool. This again stands in contrast to the usual situation for water electrolyzers. In conventional water electrolyzers incidental cooling is highly desirable since the problem is too much heat and incidental cooling helps alleviate that problem.

Thus, all of the usual energy and thermal management issues that exist in a conventional water electrolysis cell are not applicable in present embodiments. Thermal and energy management of the cell occurs by heating, not cooling, and any incidental cooling (e.g. air cooling) that may occur, is not advantageous but, instead, deleterious and to be avoided. The overall energy efficiency of the cell is then a function of the efficiency with which it can be heated and maintained at its operating temperature.

A key distinguishing feature of example embodiments is that the above reversal of issues is: (i) more easily managed than in a conventional cell, (ii) more cheaply managed than in a conventional cell, and (iii) most critically of all, substantially more likely to achieve higher overall energy efficiencies.

These examples also show an electrochemical cell and a method for operating the electrochemical cell, wherein the electrochemical cell comprises a gas-producing electrode, a counter electrode, and where the gas-producing electrode and the counter electrode are separated by the electrolyte. Also provided is one or more void volumes, in this case at or adjacent to the electrodes. The method comprises supplying the current to at least the gas-producing electrode, and producing a gas (H₂ or O₂) at the gas-producing electrode as a result of the endothermic electrochemical reaction. The gas is received by the one or more void volumes.

### Example 4

### Preferred Catalysts and Catalytic Materials that Facilitate Water Electrolysis Below the Thermoneutral Potential

A range of other catalyst systems were examined as oxygen electrode catalysts under similar conditions with the same hydrogen electrode catalyst, namely, 10% Pt/carbon black (0.72 g Pt/m²). Table 2 summarizes data obtained for selected examples of the most active of them.

TABLE 2
Voltage at 10 mA/cm² at 80° C. in electrolyser mode after
2-3 h of operation for various oxygen electrode catalysts, when
paired with a hydrogen electrode catalyst comprising
10% Pt/carbon black (0.72 g Pt/m²)

| | Voltage |
|---|---|
| | at 10 mA/cm² |
| Oxygen electrode catalyst (50% PTFE by weight) | in electrolyzer |
| (all with hydrogen electrode catalyst = | mode after 2-3 |
| 10% Pt/carbon black; 0.72 g Pt/m²) | hours of operation |
| Spinel NiCo₂O₄ (427 g/m²) | 1.25 V |
| Spinel NiCo₂O₄ (328 g/m²)/carbon black (57 g/m²) | 1.27 V |
| 10% Pt/carbon black (0.72 g Pt/m²) | 1.33 V |
| Perovskite La_{0.8}Sr_{0.2}MnO₃ (217 g/m²) | 1.38 V |
| IrO₂ (209 g/m²) | 1.43 V |
| Perovskite La_{0.6}Sr_{0.4}Co_{0.2}Fe_{0.8}O₃ (152 g/m²) | 1.46 V |
| MoS₂ (356 g/m²) | 1.46 V |
| Perovskite Ba_{0.5}Sr_{0.5}Co_{0.2}Fe_{0.8}O₃ (496 g/m²) | 1.48 V |

As can be seen from Table 2, a number of catalysts yield performance below the thermoneutral voltage in cells of the present embodiments at an operating temperature of 80° C., thereby confirming that the energy efficiency is related to the bubble-free or substantially bubble-free nature of the cell, the absence of an inter-electrode diaphragm or ion-exchange membrane, and the use of suitable conditions for the ‘Electrolyte Factor’ EF, ‘Power Density Factor’ PF, and ‘Crossover’ CO.

Preferred catalysts having utility as both or either of hydrogen electrode catalysts and oxygen electrode catalysts include one or more of the following preferred catalytic materials, or combinations thereof:
(i) Precious metals, either free or supported, including but not limited to Pt black, Pt supported on carbon materials (e.g. Pt on carbon black), Pt/Pd on carbon materials (e.g. Pt/Pd on carbon black), IrO₂, and RuO₂;
(ii) Nickel, including but not limited to: (a) nanoparticulate nickels, (b) sponge nickels (e.g. Raney nickel), and (c) nickel foams;
(iii) Nickel alloys, including but not limited to, NiMo, NiFe, NiAl, NiCo, NiCoMo;
(iv) Nickel oxides, oxyhydroxides, hydroxides, and combinations thereof, without limitation;
(v) Spinels, including but not limited to NiCo₂O₄, Co₃O₄, and LiCo₂O₄;
(vi) Perovskites, including but not limited to La_{0.8}Sr_{0.2}MnO₃, La_{0.6}Sr_{0.4}Co_{0.2}Fe_{0.8}O₃, and Ba_{0.5}Sr_{0.5}Co_{0.2}Fe_{0.8}O₃;
(vii) Iron, as well as iron compounds, including but not limited to nanoparticulate iron powders and the like;
(viii) Molybdenum compounds, including but not limited to MoS₂;
(ix) Cobalt, as well as cobalt compounds, including but not limited to nanoparticulate cobalt powders and the like; and
(x) Manganese, as well as manganese compounds, including but not limited to nanoparticulate manganese powders and the like.

### Example 5

### Efficient Thermal Management of an Electrochemical Cell

It will be understood by persons skilled in the art that example embodiment electrochemical cells as described herein present new challenges in respect of optimising energy efficiency and performance. The focus that exists for conventional electrochemical cells (not of the preferred embodiments), such as commercial water electrolysis cells, on emitting and radiating as much of the excess heat generated as possible is replaced by a conservation ethic in which excess heat is considered a valuable commodity that should be conserved, managed and/or harnessed within or by the electrochemical cell.

The way in which heat is electrically generated within electrochemical cells of present embodiments therefore becomes an important issue, as does the efficiency of the thermal insulation of the electrochemical cell, for example when placed around or about the electrochemical cell.

One method of regulating heat generation and loss in present electrochemical cells is to:
(1) determine the most reasonable thermal insulation that can be applied to the electrochemical cell;
(2) design the electrochemical cell so that its electrical current carrying components in contact with the electrolyte generate only as much heat as is required to supply the chemical reaction and to maintain the operating temperature given the thermal insulation present.

That is, one approach is to design the electrochemical cell and its thermal insulation such that the heat generated by the electrochemical cell during routine operation matches, at least to some extent, the consumption of heat by the reaction plus the loss of heat radiated to the surroundings through the thermal insulation.

All of these features can be readily and accurately modelled, meaning that it becomes possible to rationally design an electrochemical cell so as to achieve the greatest reasonable energy efficiency possible.

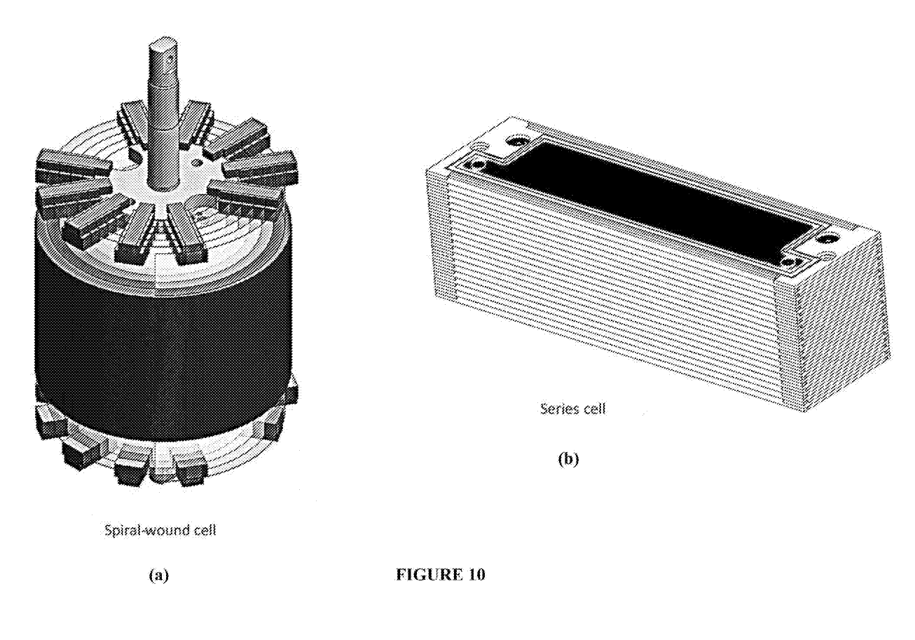

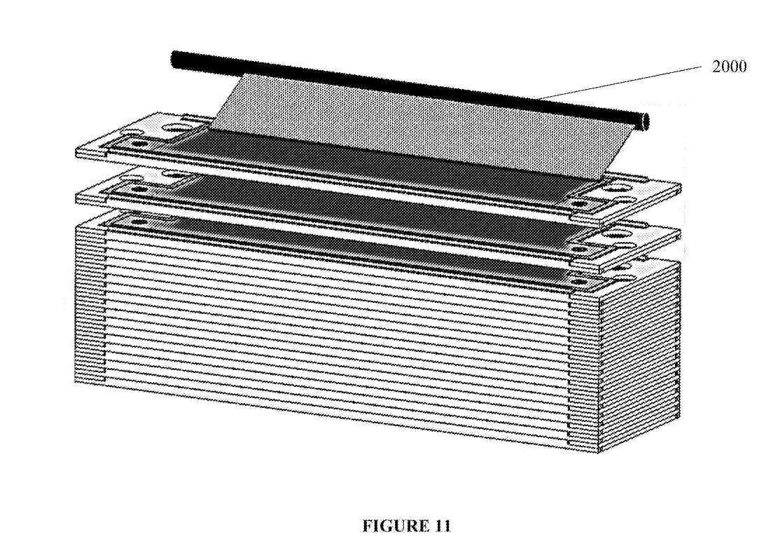

FIG. 10 illustrates example electrochemical cells in the form of (a) spiral-wound and (b) series (e.g. stacked) cells. There are various possible configurations of terminal busbars that can be used in such electrochemical cells. FIG. 11 illustrates an example design of a busbar for the series cell illustrated in FIG. 10(b).

Electrochemical cells of these types can be housed within sealed tubular chambers through which liquid electrolyte circulates. Types of thermal insulation are known for tubular or cylinder type hot water heaters. The Australian standard for the maximum heat loss by tubular residential hot water heaters containing water at 50° C. is 93.6 kJ/kg water/24 hours. Thermal insulation manufactured for such hot water heaters are readily available and inexpensive, and their thermal insulating properties are also well characterised. Such thermal insulation is also suitable for insulating present example electrochemical cells. Example thermal insulation can include fibreglass, mineral wool, cellulose, polyurethane foam, polystyrene (EPS), calcium silicate, cellular glass, elastomeric foam, phenolic foam, polyisocyanurate or polyiso, vermiculite, cotton wool, or combinations thereof.

A water electrolysis cell operating at 50° C., has a thermoneutral voltage of 1.48 V, while the voltages corresponding to the electrical energy and the heat energy needed to split water are 1.21 V and 0.27 V respectively.

If an electrochemical cell as described herein is therefore used as a water electrolyzer and the electrochemical cell and its tubular housing are wrapped in thermal insulation, for example of the type used in Australian hot water heaters, then the amount of heat that will be radiated through the thermal insulation when the electrochemical cell is maintained at 50° C. can be calculated.

If such a cell contains 66 kg of aqueous electrolyte, then such a cell will radiate through its thermal insulation, in one day:

$$66 ( kg ) \times 93.6 ( \frac{kj}{kg \cdot day} ) = 6 , 178 kJ \text{/} day ,$$

This equates to 1,720 Wh, or 1.72 kWh of radiated energy wasted each day.

If the operating current density of the cell is 10 mA/cm² and the size of each anode and cathode is 2 m long×0.3 m wide=0.6 m², then each cell in the stack will consume a total electrical current of:

$$10 ( \frac{mA}{cm 2} ) \times 10 , 000 ( \frac{cm 2}{m 2} ) \times 0.001 ( \frac{A}{mA} ) \times 0.6 {m}^{2} = 60 A$$

Given that 60 A will generate about 0.054 kg of hydrogen per day per cell and there are 20 cells in the stack, the entire series cell will generate a total of 1.08 kg of hydrogen per day.

The minimum theoretical energy required to produce 1 kg of hydrogen at the thermoneutral voltage is 39 kWh (equates to 1.48 V), which, at 50° C., comprises of 32 kWh (1.21 V) of electrical energy and 7 kWh (0.27 V) of heat energy. Thus, the minimum theoretical energy required by the cell in one day, to produce the 1.08 kg of hydrogen, will be:

1.08×39=42.12 kWh, of which:

1.21/1.48×42.12=34.44 kWh would be electrical energy and

0.27/1.48×42.12=7.68 kWh would be heat energy.

The total energy required each day by the cell, including the heat that would be radiated through the thermal insulation, would therefore be:

$$42.12 ( kWh ) Energy required for reaction + 1.72 ( kWh ) Energy wasted by radiation = \underline{43.84 kWh} Total Energy needed$$

Of this total energy,

34.44 kWh would be needed as electrical energy and

9.40 kWh would be needed as heat energy.

An optimum electrochemical cell can be designed to provide this energy mix over one day when operated at the current density of 10 mA/cm².

The catalyst produces heat at the applied current density. If the catalyst used in the cell was capable of generating the desired current density of 10 mA/cm² at 1.42 V at 50° C., then this applied operational voltage would comprise of 1.21 V of electrical energy and 0.21 V of heat energy. In other words, at the applied current density of 10 mA/cm², the catalyst alone would generate over 1 day:

1.21/1.48×42.12=34.44 kWh of electrical energy (=100% of the electrical energy required)

and

0.21/1.48×42.12=5.98 kWh of heat energy (=60% of the heat energy required)

Accordingly, to achieve optimum overall efficiency, the other electrical components in the electrochemical cell would have to be designed to provide the following amount of heat energy per day at 10 mA/cm²:

$$9.40 kWh Heat required - 5.98 kWh Heat produced by catalyst = 3.42 kWh Additional heat energy needed$$

This equates to resistive heating capacity of:

3.42 kWh/day/24 h/day=0.143 kW=143 W

In other words, the other electrical components in the electrochemical cell would ideally be designed to radiate 143 W of heat in total when operated at 10 mA/cm².

Those other electrical components in the electrochemical cell would then also experience a cumulative voltage drop in the cell of:

$$( \frac{3.42 kWh \text{/} day}{1.08 kg H 2 \text{/} day} ) \times ( \frac{0.27 V \times 1 kg H 2 \text{/} day}{7 kWh} ) = 0.12 V$$

To put this in another way: the electrochemical cell should be designed such that the electrochemical cell yields a current density of 10 mA/cm² when a total operational voltage is applied to it of 1.42 V+0.12 V=1.54 V. Of that total operational voltage, 1.42 V should be expended over the catalyst and the other 0.12 V cumulatively expended over all of the other electrical components that are in contact with the electrolyte. Those other components will then also generate the required 143 W of resistive heating.

Such a cell would provide the best reasonable balance between the heat required (by the reaction and by radiation through the thermal insulation) and the heat supplied by the electrochemical cell. The overall energy efficiency of the electrochemical cell would then be:

1.48 V/1.54 V×100=96% electrical and energy efficiency.

This is substantially better than the “stack” efficiencies of commercially available water electrolyzers at the present time.

### Example 6

### Practical Implementation of a Thermal Management System

Having developed an understanding of the above design parameters, it is now possible to rationally design a more efficient electrochemical cell. This could be done by modelling of the electrochemical cell, followed by empirical testing to iteratively approach the most ideal arrangement.

The resistance and heat generated by each electrical component in the electrochemical cell, such as, for example, the busbars, can be calculated using standard equations known in the art. These calculations typically employ the resistivity of the conducting material, corrected for temperature, and applied to the cross-sectional area of the conductor, at the current of interest.

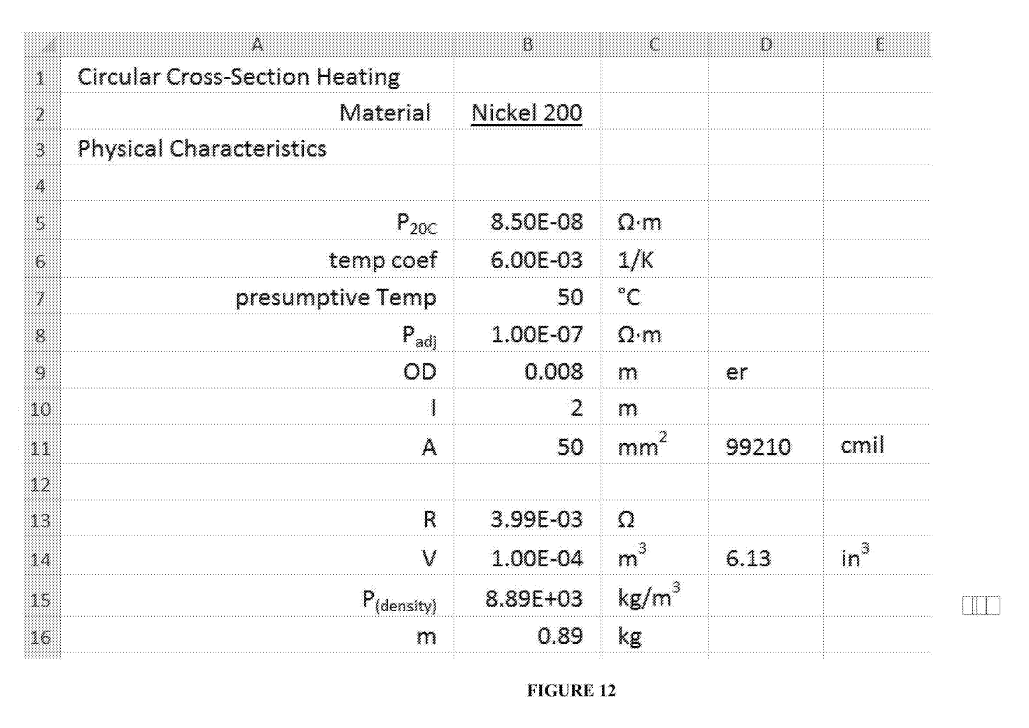

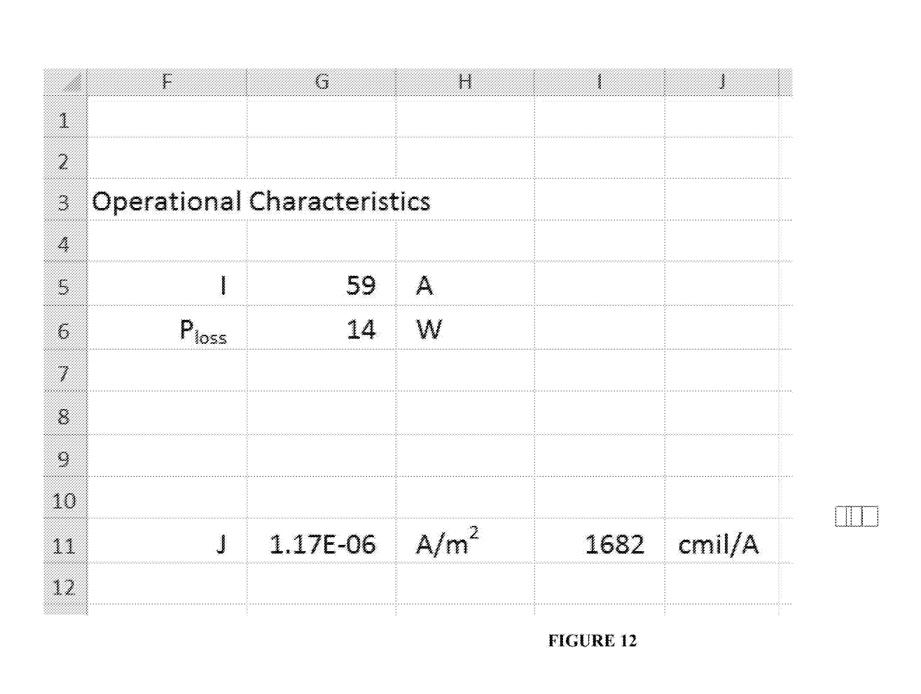

Thus, for example, the heat generated by the busbar 2000 depicted in FIG. 11 has been calculated. The calculation is shown in FIG. 12. Such modelling calculations also allow for the dimensions of the electrical part to be varied.

The heat produced by all of the electrical components, thus calculated, can then be summed to determine whether they cumulatively generate the amount of resistive heating required, which is 143 W for the above example. (It is to be understood that only the heat generated by components in contact with the electrolyte should be summed). If they do not, then the component dimensions may be adjusted until they do.

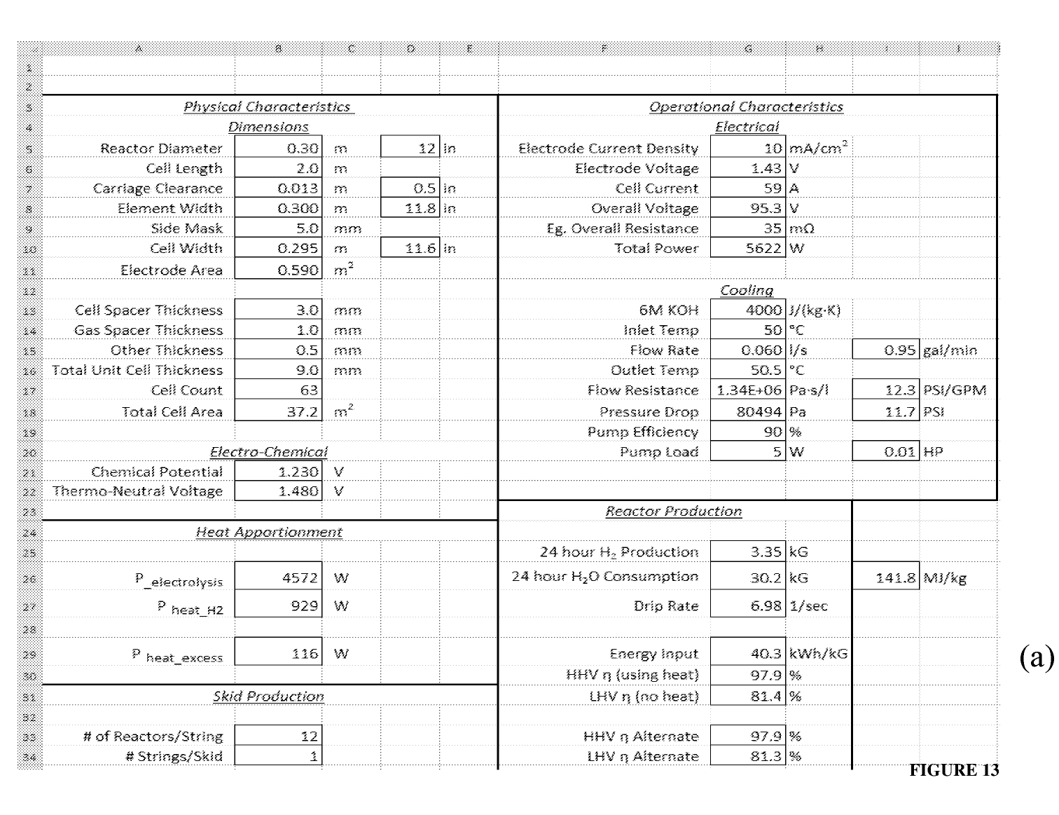

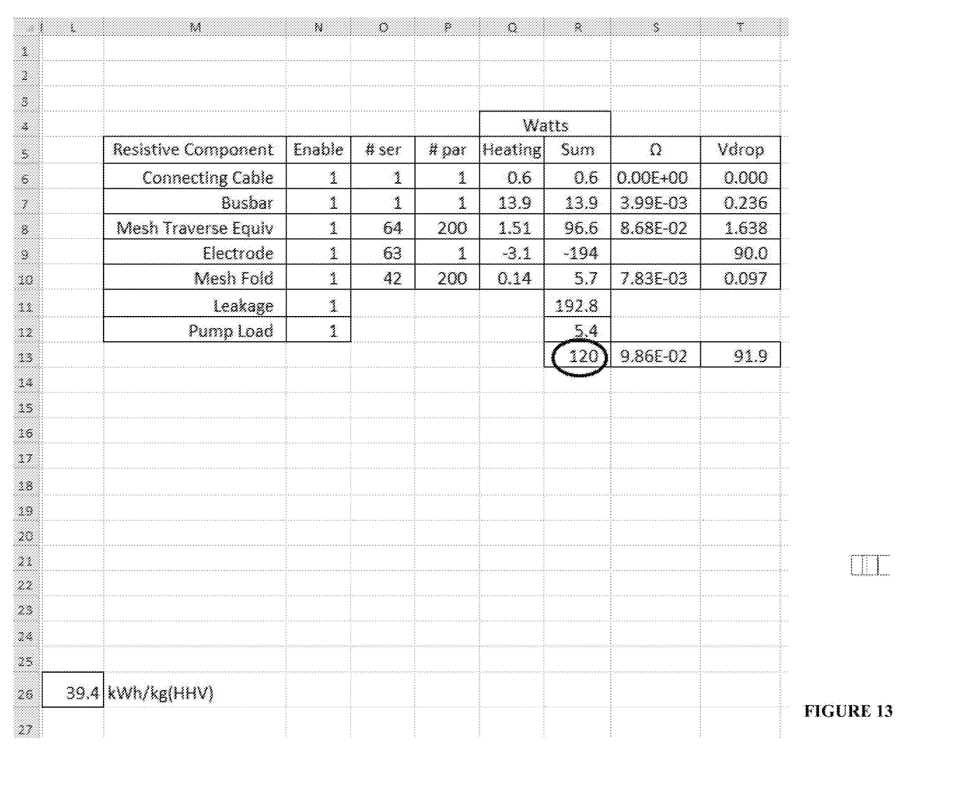

FIG. 13 shows modelling date which summarises the heat contributions by all of the electrical components in the example series cell depicted in FIG. 11. The overall efficiency has also been calculated and is shown in block R13. As can be seen, using the particular conducting materials and dimensions employed for the busbars and other electrical components, and running the cell at 10 mA/cm², generates only 120 W of heat, neglecting the heat produced by the catalyst and non-functional components. This is clearly too little heat. While such a cell would display a very high electrical efficiency of 97.9% (see block G29), it would run cold and not sustain the reaction over extended periods of time.

There are several options for dealing with such an eventuality, including the following:
(1) Include a separate electrical resistive heater in the system,
(2) Re-design the components so that they produce more heat at the designated current density,
(3) Operate the cell at a higher current density, resulting in a higher operating temperature, and/or
(4) Apply the current in a waveform that increases the heat produced.
   Options for Balancing the Heat Produced with the Heat Consumed

### Option 1: Include a Separate Resistive Heating Element in the Cell

The simplest option to correct the above situation would be to alter the circuit of the cell by including a separate heat controller element of the type described in an Example above. The heat controller element would be set to supply the required additional heat by electrical resistive heating (e.g. a heat producing resistor or a heat producing variable resistor). The heat controller element could also vary the amount of electrical resistive heating produced in a feedback loop with the thermometer, to thereby maintain the cell at its operating temperature. The problem with this approach is that it consumes additional electrical energy, reducing the overall energy efficiency of the cell. A better approach would be to use the cell itself as a heater, which will now be described.

Option 2: Re-Design the Components that Provide the Resistive Heating

A more fundamental option is to re-design the electrical components that produce the heat. An example in this respect is the busbar 2000 in FIG. 11. The heat generated by busbar 2000 at 10 mA/cm² and 50° C., may be increased by, for example, decreasing its cross-sectional area of the ring. Such a decrease would increase the electrical resistance of the ring, creating more heat. Incremental changes of this type may be applied to one or more of the electrical components, until the cumulative heat generated under operating conditions is as desired, being 143 W for the above example scenario (neglecting the heat produced by the catalyst and non-functional components). Such modifications can be easily made by using a modelling approach as depicted in FIGS. 12-13. While this approach is viable, it does require accurate modelling and, potentially, re-engineering. A simpler approach may be what could be termed “thermal self-regulation”, which is described next.

Option 3: (Iteratively) Adjust/Optimize the Applied Current (Density), which may Cause the Operating Temperature of the Cell to Change to a More Suitable Level (“Thermal Self-Regulation”)

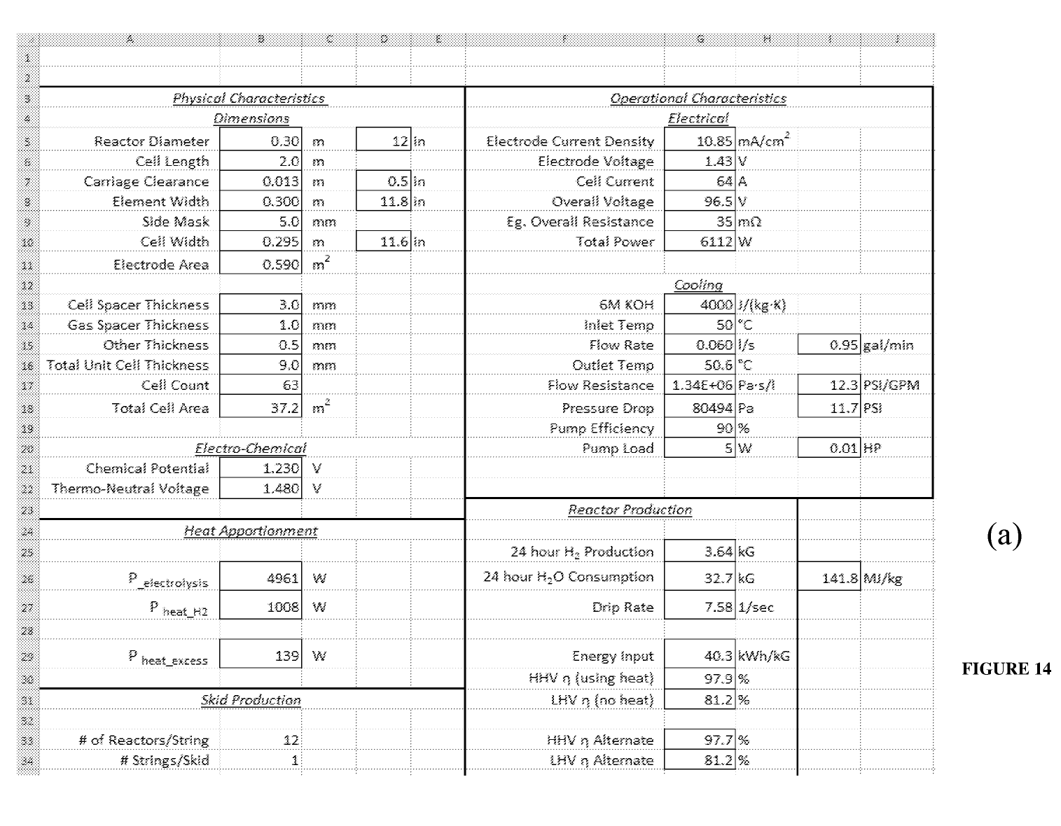

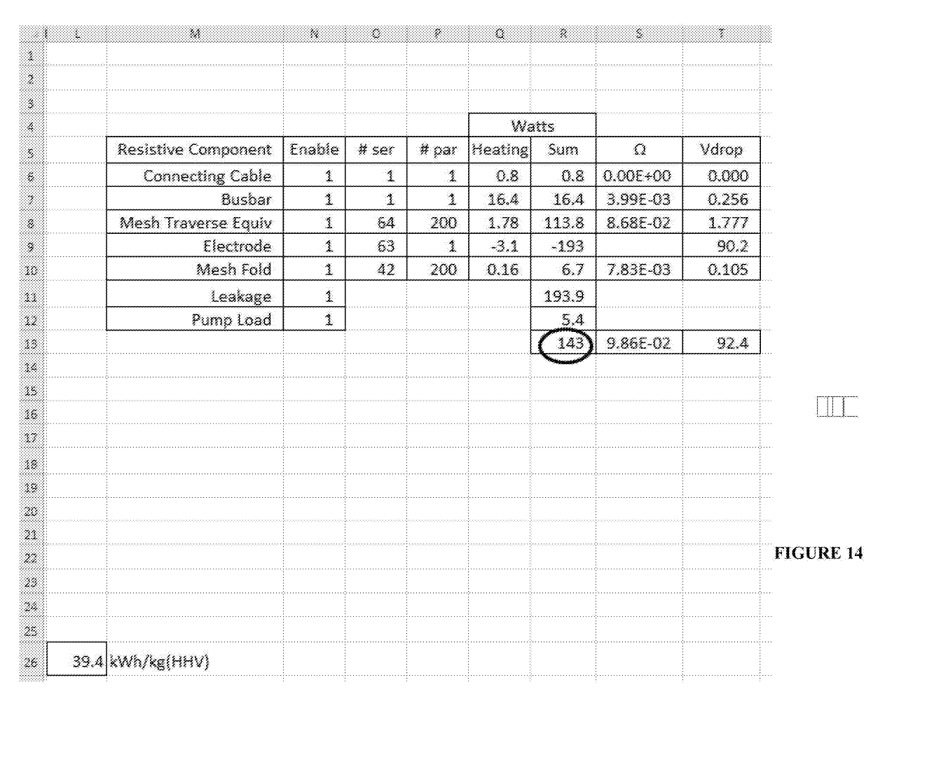

To illustrate this option consider FIG. 14 which shows the same modelling data as in FIG. 13, but calculated at a current density of 10.85 mA/cm². As can be seen, at this current density the total heat generated, neglecting the heat produced by the catalyst and non-functional components was calculated to be 143 W, which matches the amount that was originally determined to be required.

It should be noted however, that moving the system to an applied current density of 10.85 mA/cm² would also increase the operating voltage of the cell, having the effect of changing the theoretical breakdown of the electrical and heat energy required and potentially generating excess heat. This would cause the cell to heat itself up to a higher operating temperature. As the cell voltage for water electrolysis generally declines with increasing temperature, the cell would continue heating itself up until the voltage created by the applied current density fell to near, about, or below the thermoneutral voltage. At that point the temperature will stabilize and stop increasing. The cell would then have “found” its own optimum operating temperature under the new conditions—that is, the cell would have engaged in “thermal self-regulation”. Provided that the cell can withstand the new operating temperature without damage or impairment, this approach provides one of the best and simplest methods of balancing the heat generated by the cell with the heat required by the reaction.

Cells of the present embodiments that make use of PTFE-backed expanded PTFE membranes (ePTFE), 6 M KOH, and 30 bar operating pressures, are capable of operating at temperatures greater than 150° C. This is because PTFE-backed ePTFE is stable up to 300° C., while 6 M KOH at 30 bar pressure remains liquid and does not boil at >150° C. By contrast, conventional alkaline electrolyzers cannot operate above 110° C. because at that temperature their diaphragms (separators) (typically Zirfon Perl™) are irretrievably chemically degraded by the 6 M KOH electrolyte. Conventional PEM electrolyzers also cannot operate above 110° C. because their PEM membranes degrade and are irretrievably damaged at such temperatures. The ability to withstand very high operating temperatures without damage or impairment provides an important advantage of present example embodiment water electrolysis cells relative to existing, conventional water electrolyzers because it allows them to make use of “thermal self-regulation” of the type described above.

The principle behind “thermal self-regulation” is as follows: As the temperature of a cell goes up, its cell voltage at a fixed current density falls concomitantly. When a higher current density is applied, the cell voltage initially increases, causing the generation of excess heat. If the heat is retained within the cell, this causes the cell temperature to increase, which, in turn, causes the cell voltage to decline. The temperature of the cell will continue to increase until the cell voltage has declined to be at or near to the thermoneutral voltage (depending on the quality of the thermal insulation applied, and the proportion of heat lost through it). At that point, the cell temperature will stabilize and stop going up since the cell will stop generating excess heat. It will also not go down, meaning that a new operating temperature will have been established. During the entire process and thereafter, at the new operating temperature, the cell would be operating at as close to 100% energy efficiency as the thermal insulation will allow.

It should be noted that, at the new operating temperature, the theoretical breakdown of the electrical and heat energy required would also be changed. At an applied current density of 10.85 mA/cm², the system may then not require the 143 W produced in FIG. 14. That is, further iterations may be needed to accurately model the new situation. These would involve re-calculations of the electrical and heat energy required at the new operating temperature, followed by adjustments to the current density, until a good match was obtained between the theoretically needed electrical and heat energy required and the calculated production of such energy by the cell.

A danger in “thermal self-regulation” is that too much current density may be applied, so that the cell voltage cannot fall to the thermoneutral potential within the allowed temperature range. In that case, the cell will overheat, causing it to be damaged or impaired. For this reason, it may be important to have accurate modelling and empirical testing of the system before engaging in “thermal self-regulation” of an example cell.

For routine operation of the electrochemical cell in practice, it may therefore be necessary and convenient for the current density to be iteratively varied and controlled so as to thereby adjust for possible overheating and for variations between theory and practice. It may also be needed in cases where it is necessary to maintain the electrochemical cell at a constant or near constant operating temperature. That is, the applied current density can be varied so as to maintain the electrochemical cell at or about a suitable operating temperature. An automated feedback-control of the power supply with which to perform thermal management of the system in this way, may be applied. Such an automated process should allow for an almost perfect, or, at least, the best possible matching of the energy required by the system with the energy supplied to it. Such an automated system should be able to actively and automatically maintain the system at as close to 100% energy efficiency as permitted by the thermal insulation used.

### Option 4: Apply the Current in a Waveform

A final option that should be noted is based on the fact that the calculations for heating depicted in FIGS. 12-13 were determined on the assumption that a constant current density would be applied. However, by supplying or applying the current density in a waveform, rather than in a constant manner, the amount of heating may be increased. That is, the current density can be supplied as a non-constant value in a waveform.

For example, instead of supplying or applying 10 mA/cm² constantly, one could apply 20 mA/cm² for 1 s, followed by 0 mA/cm² for another 1 s, repeated indefinitely. In such a situation, the overall current density would still average 10 mA/cm² and the average current would still be 60 A. However, resistive heating increases with the square of the applied current; it does not increase linearly. During the periods that 20 mA/cm² was applied, the resistive heating would therefore be substantially more than double the resistive heating at 10 mA/cm². Consequently, the average resistive heating would be greater than that at a constant 10 mA/cm².

A variety of waveforms known in the art are available with which to optimize the resistive heating produced. For example, square-wave waveforms of current may be applied at various time intervals to thereby deliver the required heating. Other examples include a periodic waveform, a step waveform, or a sinusoidal waveform.

### Example 7

### Thermal Management Using a Catalyst that Does Not Operate Usefully Below the Thermoneutral Voltage at Ambient Temperature

It should be noted that present embodiments can also be applied to an electrochemical cell in which the catalyst used does not produce a substantial or a useful current below the thermoneutral voltage at ambient temperature.

For example, consider the series cell of the last example. The cell operates at a current density of 10 mA/cm² with a total current of 60 A, over 20 cells in the stack. The cell radiates 1.72 kWh of energy each day through its thermal insulation. The cell further generates 1.08 kg of hydrogen per day, meaning that it needs to be supplied with:

$$42.12 ( kWh ) Energy required for reaction + 1.72 ( kWh ) Energy wasted by radiation = \underline{43.84 kWh} Total Energy needed$$

Of this total energy,

34.44 kWh would be needed as electrical energy and

9.40 kWh would be needed as heat energy.

Now, however, consider the case where the catalyst used in the electrochemical cell is only capable of generating the desired current density of 10 mA/cm² at 1.52 V at 50° C. (and not at 1.42 V as in the previous example).

The first point to be made is that 1.52 V exceeds the thermoneutral voltage of 1.48 V, so that the catalyst does not produce a substantial or a useful current below the thermoneutral voltage.

Secondly, this 1.52 V would comprise of 1.21 V of electrical energy and 0.31 V of heat energy. In other words, at the applied current density of 10 mA/cm², the catalyst alone would generate over 1 day:

1.21/1.48×42.12=34.44 kWh of electrical energy (=100% of the electrical energy required)

and

0.31/1.48×42.12=8.82 kWh of heat energy (=94% of the heat energy required)

Accordingly, to achieve optimum overall efficiency, the other electrical components in the cell would have to be designed to provide the following amount of heat energy per day at 10 mA/cm²:

$$9.40 kWh Heat required - 8.82 kWh Heat produced by catalyst = 0.58 kWh Additional heat energy needed$$

This equates to resistive heating of:

0.58 kWh/day/24 h/day=0.024 kW=24 W

In other words, the other electrical components in the electrochemical cell would ideally be designed to radiate 24 W of heat in total when operated at 10 mA/cm².

Clearly, with the different catalyst, the cell generates too much heat. As in the previous example, there are several approaches to match the heat produced with the heat required. These include:
(1) Re-design the components so that they produce less heat at the designated current density,
(2) Operate the cell at a lower current density, or
(3) Adjust the thermal insulation so that the heat required is larger.
   Options for Balancing the Heat Produced with the Heat Consumed
   Option 1: Re-Design the Components that Provide the Resistive Heating

A fundamental option is to re-design the electrical components that produce the heat. An example in this respect is the busbar 2000 in FIG. 11. The heat generated by the busbar 2000 at 10 mA/cm² and 50° C., may be decreased by, for example, increasing the cross-sectional area of the ring. Such an increase would decrease the electrical resistance of the ring, creating less heat. Incremental changes of this type may be applied to one or more of the electrical components, until the cumulative heat generated under operating conditions is 24 W and not 67 W (neglecting the heat produced by the catalyst and non-functional components). Such modifications can be easily made when using a model of the type depicted in FIGS. 12-13.

### Option 2: Iteratively Adjust/Optimize the Applied Current (Utilize the Principles of ‘Thermal Self-Regulation’)

In this option the current density applied would be reduced until the total heat generated, neglecting the heat produced by the catalyst and non-functional components, was calculated to be 24 W, which matches the amount that was originally determined to be required.

It should be noted however, that moving the system to a lower current density would also have the effect of reducing the applied voltage and thereby changing the theoretical breakdown of the electrical and heat energy required. That is, the cell may move to a lower operating temperature using the principle of ‘thermal self-regulation’ described earlier. Provided that the cell can withstand the new operating temperature without damage or impairment, this approach provides one of the best and simplest methods of balancing the heat generated by the cell with the heat required by the reaction. In this case however, the cell will likely not achieve the highest possible energy efficiency.

At the lower current density mentioned above, the system may not require 24 W. That is, further iterations would be needed in the modelling, involving re-calculations of the electrical and heat energy required, followed by adjustments to the current density, until a good match was obtained between the theoretically needed electrical and heat energy required and the calculated production of such energy by the cell.

The same is true for routine operation of the cell in practice. It may be necessary and convenient for the current density to be varied, e.g. iteratively varied, and controlled so as to thereby adjust for variations between theory and practice and also to maintain the cell at a constant operating temperature.

This example indicates that, for the present invention, it is preferable but not essential to use catalysts capable of yielding suitable currents at or below the thermoneutral voltage at ambient temperature. The present invention may also be applied using catalysts that produce a substantial or a useful current at a voltage near to, but not below the thermoneutral voltage. In that case, it may be necessary to adjust the operating temperature of the cell lower in order to bring the heat put into the cell into balance with the heat required by the cell.

Option 3: Adjust the Thermal Insulation to Balance the Heat Required with the Heat Produced

If the heat produced by the catalyst is 8.82 kWh per day, at 10 mA/cm² and 50° C., and the cumulative heat generated under operating conditions by the electrical components is 67 W (=1.61 kWh), neglecting the heat produced by the catalyst and non-functional components, then one solution would be to adjust the thermal insulation such that the total energy needed is:

$$34.44 kWh Electrical energy Required + 8.82 kWh Heat produced by catalyst + 1.61 kWh Heat produced by components = \underline{44.87 kWh} Total Energy$$

This can be achieved by changing the heat radiated per day to the surroundings through the thermal insulation as follows:

$$\underline{44.87 kWh} Total Energy - 42.12 kWh Energy required for reaction = 2.72 kWh Energy radiated through thermal insulation$$

This equates to 2,720 Wh, which equates to 9,792 kJ of radiated energy each day. If such a cell contains 66 kg of aqueous electrolyte, then the thermal insulation must be specified to be:

9,792 kJ/day/66 kg=148.4 kJ/kg water/24 h

It will be appreciated that this option has limited utility in that it is relatively wasteful of energy. For progressively less efficient catalysts, this option will also soon become unviable since active cooling will be needed unless the catalyst is able to, at least, operate usefully near to the thermoneutral voltage at the ambient temperature.

Persons skilled in the art will recognize that beyond the illustrative example of water electrolysis, there exist a large number of endothermic electrochemical reactions that may be facilitated or managed using the techniques described herein.

Throughout this specification and the claims which follow, unless the context requires otherwise, the word “comprise”, and variations such as “comprises” or “comprising”, will be understood to imply the inclusion of a stated integer or step or group of integers or steps but not the exclusion of any other integer or step or group of integers or steps.

Optional embodiments may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that many modifications, changes, substitutions or alterations will be apparent to those skilled in the art without departing from the scope of the present invention.

1. A method for management of an electrochemical cell comprising electrodes and an electrolyte between the electrodes, the method comprising:
creating an operational voltage for the electrochemical cell that is below or about the thermoneutral voltage for an electrochemical reaction at an operating temperature; and
operating the electrochemical cell at the operational voltage and the operating temperature to produce the electrochemical reaction,
wherein a catalyst applied to at least one of the electrodes facilitates the electrochemical reaction at the operational voltage and the operating temperature.

2. The method of claim 1, wherein the operational voltage is below the thermoneutral voltage.

3. The method of claim 1, wherein the operational voltage is at or about the thermoneutral voltage.

4. The method of any one of claims 1 to 3, wherein the electrochemical reaction is an endothermic electrochemical reaction and heat is applied to the endothermic electrochemical reaction from a heater or a heating element.

5. The method of any one of claims 1 to 4, wherein the electrochemical reaction is an endothermic electrochemical reaction and heat is applied to the endothermic electrochemical reaction from one or more of: electrical resistive heating, upstream or downstream waste heat, non-related waste heat of a separate process, and/or ambient air.

6. The method of any one of claims 1 to 5, wherein there is no active cooling of the electrochemical cell.

7. The method of any one of claims 1 to 6, wherein thermal insulation encases the electrochemical cell.

8. The method of any one of claims 1 to 7, wherein the electrochemical cell is a water electrolyzer and the electrochemical reaction is water electrolysis.

9. The method of claim 8, wherein the catalyst facilitates electrocatalytic water electrolysis.

10. The method of any one of claims 1 to 9, wherein the catalyst is applied to both of the electrodes.

11. The method of claim 9, wherein the catalyst facilitates water electrolysis at the operational voltage that is below the thermoneutral voltage for water electrolysis.

12. The method of any one of claims 1 to 11, wherein the catalyst is selected from the group of: Precious metals, Pt black, Pt supported on carbon materials, Pt on carbon black, Pt/Pd on carbon materials, Pt/Pd on carbon black, IrO₂, RuO₂), and combinations thereof.

13. The method of any one of claims 1 to 11, wherein the catalyst is selected from the group of: Nickel, nanoparticulate nickels, sponge nickels, Raney nickel, nickel foams, Nickel alloys, NiMo, NiFe, NiAl, NiCo, NiCoMo, Nickel oxides, oxyhydroxides, hydroxides, and combinations thereof.

14. The method of any one of claims 1 to 11, wherein the catalyst is selected from the group of: Spinels, NiCo₂O₄, Co₃O₄, LiCo₂O₄, and combinations thereof.

15. The method of any one of claims 1 to 11, wherein the catalyst is selected from the group of: Perovskites, La_{0.8}Sr_{0.2}MnO₃, La_{0.6}Sr_{0.4}Co_{0.2}Fe_{0.8}O₃, Ba_{0.5}Sr_{0.5}Co_{0.2}Fe_{0.8}O₃, and combinations thereof.

16. The method of any one of claims 1 to 11, wherein the catalyst is selected from the group of: Iron, iron compounds, nanoparticulate iron powders, Molybdenum compounds, MoS₂, Cobalt, cobalt compounds, nanoparticulate cobalt powders, Manganese, manganese compounds, nanoparticulate manganese powders, and combinations thereof.

17. The method of any one of claims 1 to 16, wherein the catalyst, when dry, comprises:
about 5% to about 95% by weight of PTFE,
about 5% to about 95% by weight of the catalytic material(s).

18. The method of any one of claims 1 to 16, wherein the catalyst, when dry, comprises:
about 5% to about 90% by weight of PTFE,
about 5% to about 90% by weight of uncoated carbon black, and
about 5% to about 90% by weight of the catalytic material(s).

19. The method of any one of claims 1 to 18, wherein the catalyst produces heat at a current density.

20. The method of any one of claims 1 to 19, wherein a current density is varied to maintain the electrochemical cell at or about a constant operating temperature.

21. The method of claim 20, wherein the current density is supplied in a waveform.

22. The method of any one of claims 1 to 21, wherein the catalyst facilitates the electrochemical reaction at a low current density less than or equal to 50 mA/cm².

23. The method of claim 22, wherein the low current density is:
less than or equal to 40 mA/cm²,
less than or equal to 30 mA/cm²,
less than or equal to 25 mA/cm²,
less than or equal to 20 mA/cm²,
less than or equal to 18 mA/cm²,
less than or equal to 16 mA/cm²,
less than or equal to 14 mA/cm²,
less than or equal to 13 mA/cm²,
less than or equal to 10 mA/cm², or
less than or equal to 5 mA/cm².

24. The method of any one of claims 1 to 23, wherein the operating temperature of the electrochemical cell is greater than or equal to 20° C.

25. The method of claim 24, wherein the operating temperature of the electrochemical cell is:
greater than or equal to 30° C.,
greater than or equal to 40° C.,
greater than or equal to 50° C.,
greater than or equal to 60° C.,
greater than or equal to 70° C.,
greater than or equal to 80° C.,
greater than or equal to 100° C.,
greater than or equal to 150° C.,
greater than or equal to 200° C., or
greater than or equal to 400° C.

26. The method of any one of claims 1 to 25, wherein the electrical efficiency of the electrochemical cell is more than 70%.

27. The method of claim 26, wherein the electrical efficiency of the electrochemical cell is:
more than 75%,
more than 80%,
more than 85%,
more than 87%,
more than 90%,
more than 93%,
more than 95%,
more than 97%,
more than 99%. or
more than 99.9%.

28. The method of any one of claims 1 to 27, wherein there is no ion exchange membrane positioned between the electrodes.

29. The method of any one of claims 1 to 27, wherein there is no diaphragm positioned between the electrodes.

30. The method of any one of claims 1 to 29, wherein the electrolyte is a liquid electrolyte or a gel electrolyte.

31. The method of any one of claims 1 to 30, wherein at least one gas is produced from the electrochemical reaction and substantially no bubbles of the at least one gas are formed at either of the electrodes, or bubbles of the at least one gas are not formed at either of the electrodes.

32. An electrochemical cell comprising:
electrodes;
an electrolyte between the electrodes; and
a catalyst applied to at least one of the electrodes to facilitate an electrochemical reaction at an operational voltage of the electrochemical cell;
wherein the operational voltage is below or about the thermoneutral voltage for an electrochemical reaction.

33. The electrochemical cell of claim 32, wherein the operational voltage is below the thermoneutral voltage.

34. The electrochemical cell of claim 32, wherein the operational voltage is at or about the thermoneutral voltage.

35. The electrochemical cell of any one of claims 32 to 34, wherein the electrochemical cell is a water electrolyzes and the electrochemical reaction is water electrolysis.

36. The electrochemical cell of any one of claims 32 to 35, including a heater or a heating element to apply heat to the electrochemical reaction which is an endothermic electrochemical reaction.

37. The electrochemical cell of claim 36, wherein the heater or the heating element applies the heat from electrical resistive heating.

38. The electrochemical cell of claim 37, wherein the electrical resistive heating occurs at one or more electrical components in contact with the electrolyte.

39. The electrochemical cell of any one of claims 32 to 38, wherein there is no active cooling system.

40. The electrochemical cell of any one of claims 32 to 39, including thermal insulation encasing the electrochemical cell.

41. The electrochemical cell of any one of claims 32 to 40, wherein there is no ion exchange membrane positioned between the electrodes.

42. The electrochemical cell of any one of claims 32 to 41, wherein there is no diaphragm positioned between the electrodes.

43. The electrochemical cell of any one of claims 32 to 42, wherein the electrolyte is a liquid electrolyte or a gel electrolyte.

44. The electrochemical cell of any one of claims 32 to 43, wherein at least one gas is produced from the electrochemical reaction and substantially no bubbles of the at least one gas are formed at either of the electrodes, or bubbles of the at least one gas are not formed at either of the electrodes.

45. A catalyst for an electrochemical cell comprising electrodes and an electrolyte between the electrodes, the catalyst comprising a mixture of:
one or more catalytic materials selected from the group of:
Precious metals, Pt black, Pt supported on carbon materials, Pt on carbon black, Pt/Pd on carbon materials, Pt/Pd on carbon black, IrO₂, RuO₂, Nickel, nanoparticulate nickels, sponge nickels, Raney nickel, nickel foams, Nickel alloys, NiMo, NiFe, NiAl, NiCo, NiCoMo, Nickel oxides, oxyhydroxides, hydroxides, Spinels, NiCo₂O₄, Co₃O₄, LiCo₂O₄, Perovskites, La_{0.8}Sr_{0.2}MnO₃, La_{0.6}Sr_{0.4}Co_{0.2}Fe_{0.8}O₃, Ba_{0.5}Sr_{0.5}Co_{0.2}Fe_{0.8}O₃, Iron, iron compounds, nanoparticulate iron powders, Molybdenum compounds, MoS₂, Cobalt, cobalt compounds, nanoparticulate cobalt powders, Manganese, manganese compounds, and nanoparticulate manganese powders; and,
polytetrafluoroethylene (PTFE);
wherein the catalyst is able to be applied to at least one of the electrodes to facilitate an electrochemical reaction at an operational voltage of the electrochemical cell that is below or about the thermoneutral voltage for the electrochemical reaction.

46. The catalyst of claim 45, wherein the catalyst, when dry, comprises:
about 5% to about 95% by weight of the PTFE, and
about 5% to about 95% by weight of the one or more catalytic materials.

47. The catalyst of claim 45, wherein the catalyst, when dry, comprises:
about 5% to about 90% by weight of the PTFE,
about 5% to about 90% by weight of uncoated carbon black, and
about 5% to about 90% by weight of the one or more catalytic materials.

48. The catalyst of any one of claims 45 to 47, wherein the catalyst is applied to both of the electrodes.

49. The catalyst of any one of claims 45 to 48, wherein the catalyst facilitates water electrolysis at the operational voltage that is below the thermoneutral voltage for water electrolysis.
